(19) United States
(12) Patent Application Publication
(10) Pub. No.: US 2026/0099666 A1
(43) Pub. Date: Apr. 9, 2026

(54) Computer-Implemented Methods and Systems for Generative Document Revision

(71) Applicant: Quabbin Patent Holdings, Inc., Marlborough, MA (US)

(72) Inventor: Robert Plotkin, Manalapan, NJ (US)

(73) Assignee: Quabbin Patent Holdings, Inc., Marlborough, MA (US)

(21) Appl. No.: 19/358,648

(22) Filed: Oct. 15, 2025

Related U.S. Application Data
(63) Continuation-in-part of application No. 19/338,447, filed on Sep. 24, 2025.
(63) Continuation-in-part of application No. 19/054,800, filed on Feb. 15, 2025, now Pat. No. 12,554,924.
(63) Continuation-in-part of application No. 18/995,049, now Pat. No. 12,505,283.
(60) Provisional application No. 63/708,233, filed on Oct. 16, 2024.
(60) Provisional application No. 63/711,078, filed on Oct. 23, 2024.
(60) Provisional application No. 63/712,475, filed on Oct. 27, 2024.
(60) Provisional application No. 63/715,666, filed on Nov. 4, 2024.
(60) Provisional application No. 63/719,137, filed on Nov. 12, 2024.
(60) Provisional application No. 63/817,621, filed on Jun. 4, 2025.

(51) Int. Cl. G06F 40/166; G06F 40/40

(52) U.S. Cl. CPC G06F 40/166; G06F 40/40

(57) ABSTRACT

A computer-implemented system and method transform text within documents using a generative process that enables automated application of action definitions across multiple document elements while maintaining user control. For each element in a document, the system identifies an action definition and applies it to generate output by providing prompts to a large language model. The system manifests generated outputs to users for review and, upon approval, revises corresponding elements based on approved outputs. This enables efficient processing of multiple document elements while preserving precise user control over content updates. The system supports various levels of user involvement, from fully automated processing to interactive refinement, allowing users to review outputs before document updates while maintaining coherence and quality. The implementation integrates sophisticated text transformations seamlessly into document creation workflows through systematic identification and application of action definitions, combining the efficiency of automated generation with manual oversight control.

### CROSS-REFERENCE TO RELATED APPLICATIONS

This application:
[symbol] claims priority to U.S. Prov. App. No. 63/817,621, filed on Jun. 4, 2025, entitled “Computer-Implemented Methods and Systems for Recursive Generative Content Generation”; and
[symbol] claims priority to U.S. Prov. App. No. 63/719,137, filed on Nov. 12, 2024, entitled “Computer-Implemented Methods and Systems for Generative Document Revision”; and
[symbol] claims priority to U.S. Prov. App. No. 63/715,666, filed on Nov. 4, 2024, entitled “Computer-Implemented Methods and Systems for Generative Document Merge”; and
[symbol] claims priority to U.S. Prov. App. No. 63/712,475, filed on Oct. 27, 2024, entitled “Computer-Implemented Methods and Systems for Generative Text Drag”; all of which are incorporated by reference herein; and
[symbol] claims priority to U.S. Prov. App. No. 63/711,078, filed on Oct. 23, 2024, entitled “Computer-Implemented Methods and Systems for Generative Text Painter”; and
[symbol] claims priority to U.S. Prov. App. No. 63/708,233, filed on Oct. 16, 2024, entitled “Computer-Implemented Methods and Systems for Generative Cut and Paste”; all of which are incorporated by reference herein.

This application:

is a continuation-in-part of U.S. App. No. 19/338,447, filed on
Sep. 24, 2025, entitled “Computer-Implemented Methods and
Systems for Generative Document Merge”; which
is a continuation-in-part of U.S. App. No. 19/054,800, filed on Feb.
15, 2025, entitled “Computer-Implemented Methods and Systems for
Generative Text Painting”; which
is a continuation-in-part of PCT App. No. PCT/US24/50403, filed on
Oct. 9, 2024, entitled “Computer-Implemented Methods and
Systems for Dynamic Prompt Generation and Integration with Large
Language Models for Document Revision”; which
claims priority to U.S. Prov. App. No. 63/588,835, filed on Oct. 9,
2023, entitled “Computer-Implemented Methods and Systems for
Dynamic Prompt Generation and Integration with Large Language
Models for Document Revision”; all of which are incorporated by
reference herein.

This application:
[symbol] is a continuation-in-part of U.S. application Ser. No. 19/054,800, filed on Feb. 15, 2025, entitled “Computer-Implemented Methods and Systems for Generative Text Painting”; which
[symbol] claims priority to U.S. Prov. App. No. 63/719,137, filed on Nov. 12, 2024, entitled “Computer-Implemented Methods and Systems for Generative Document Revision”; and
[symbol] claims priority to U.S. Prov. App. No. 63/715,666, filed on Nov. 4, 2024, entitled “Computer-Implemented Methods and Systems for Generative Document Merge”; and
[symbol] claims priority to U.S. Prov. App. No. 63/712,475, filed on Oct. 27, 2024, entitled “Computer-Implemented Methods and Systems for Generative Text Drag”; and
[symbol] claims priority to U.S. Prov. App. No. 63/711,078, filed on Oct. 23, 2024, entitled “Computer-Implemented Methods and Systems for Generative Text Painter”; and
[symbol] claims priority to U.S. Prov. App. No. 63/708,233, filed on Oct. 16, 2024, entitled “Computer-Implemented Methods and Systems for Generative Cut and Paste”; all of which are incorporated by reference herein.

### BACKGROUND

In an age where technology intertwines with every facet of our lives, the domain of writing is no exception. Traditional pen-and-paper narratives are being augmented and, in some instances, replaced by digital counterparts. With a surge in innovation, various apps have emerged, promising to ease the writing process and enrich the quality of content. But, as with all innovations, while they offer unprecedented advantages, they also come with their own set of challenges.

Modern writing tools encompass a vast spectrum—from basic word processors that mimic the age-old process of manual writing, to advanced AI-driven platforms that can draft entire documents based on a few keywords. These AI platforms, often taking the form of chatbots built on large language models (LLMs), promise to deliver content that is both relevant and coherent, simulating the nuances of human writing. However, their approach often follows a one-size-fits-all methodology, which can miss capturing the unique voice and intent of the individual writer.

While the thrill of getting an entire draft from a chatbot sounds enticing, it often throws writers into a passive role, distancing them from their original vision. Revisions, a cornerstone of the writing process, turn into a cumbersome ordeal, either making writers rewrite vast portions of AI-generated content or revert to demanding a complete rewrite from the bot. Furthermore, chatbots typically follow an “append-only” structure, which limits the dynamic editing and interactive capabilities that writers often seek.

As a result of these constraints, writers find themselves at a crossroads. On one hand, they have access to powerful AI tools that can significantly enhance productivity and inspiration. On the other, they risk losing the personal touch, authenticity, and intricate control over their craft. The available platforms, while useful, tend to box writers into specific workflows, stifling the fluidity and flexibility that the art of writing often demands.

With this backdrop, it becomes evident that while we have made leaps in integrating technology with writing, there is a tangible gap between what is available and what is truly desired and needed.

### SUMMARY

A computer-implemented system and method transform text within documents using a process that enables automated application of action definitions across multiple document elements while maintaining user control. For each element in a document, the system identifies an action definition and applies it to generate output.

The system manifests the generated output to the user for review. Upon user approval of particular outputs, the system revises the corresponding elements based on those outputs. This enables efficient processing of multiple document elements while preserving precise user control over content updates.

The system supports various levels of user involvement in the revision process, from fully automated processing to interactive refinement of generated content. Users can review generated outputs before they are applied to the document, enabling informed decisions about content updates while maintaining document coherence and quality.

The method integrates sophisticated text transformations seamlessly into document creation workflows through a systematic process of identifying applicable action definitions, generating transformed content, and obtaining user approval before implementing revisions. This approach combines the efficiency of automated content generation with the control of manual oversight.

Features include the ability to process multiple document elements systematically, manifest generated content for user review, and selectively apply approved transformations. The system maintains document structure and formatting while enabling complex content transformations through user-configurable action definitions and interactive approval workflows.

The implementation supports both automated and interactive refinement paths, allowing organizations to balance efficiency with the need for precise control over document content and quality. This flexibility enables the system to adapt to different use cases, from high-volume automated document generation to carefully crafted, individually refined documents.

### BRIEF DESCRIPTION OF THE DRAWINGS

FIG. 1 is a dataflow diagram of a system for generating text based on a selected document, text, and action definition, and for updating the selected document based on the generated text according to one embodiment of the present invention.

FIG. 2 is a flowchart of a method performed by the system of FIG. 1 according to one embodiment of the present invention.

FIG. 3 is a dataflow diagram of a system for implementing a generative cut and paste feature according to one embodiment of the present invention.

FIG. 4 is a flowchart of a method performed by the system of FIG. 3 according to one embodiment of the present invention.

FIG. 5 is a dataflow diagram of a system for implementing various painting features according to one embodiment of the present invention.

FIG. 6 is a flowchart of a method performed by the system of FIG. 5 according to one embodiment of the present invention.

FIG. 7 is a dataflow diagram of a system for implementing a document merge feature according to one embodiment of the present invention.

FIG. 8 is a flowchart of a method performed by the system of FIG. 7 according to one embodiment of the present invention.

FIG. 9 is a dataflow diagram of a system for implementing an automated document revision feature according to one embodiment of the present invention.

FIG. 10 is a flowchart of a method performed by the system of FIG. 9 according to one embodiment of the present invention.

### DETAILED DESCRIPTION

Computer-implemented methods and systems interface with a language model (e.g., a Large Language Model (LLM)) to assist in document revision. The methods and systems allow text to be selected within a document and an action definition to be selected from an action definition library. The text and/or the action definition may be selected using a graphical user interface (GUI). An action defined by the selected action definition is applied to the selected text to generate text. For example, the selected action definition may include a prompt, and the prompt may be combined with the selected text to generate a combined prompt. The combined prompt may be provided as an input to the LLM, which may generate the generated text. The generated text may be integrated into the document.

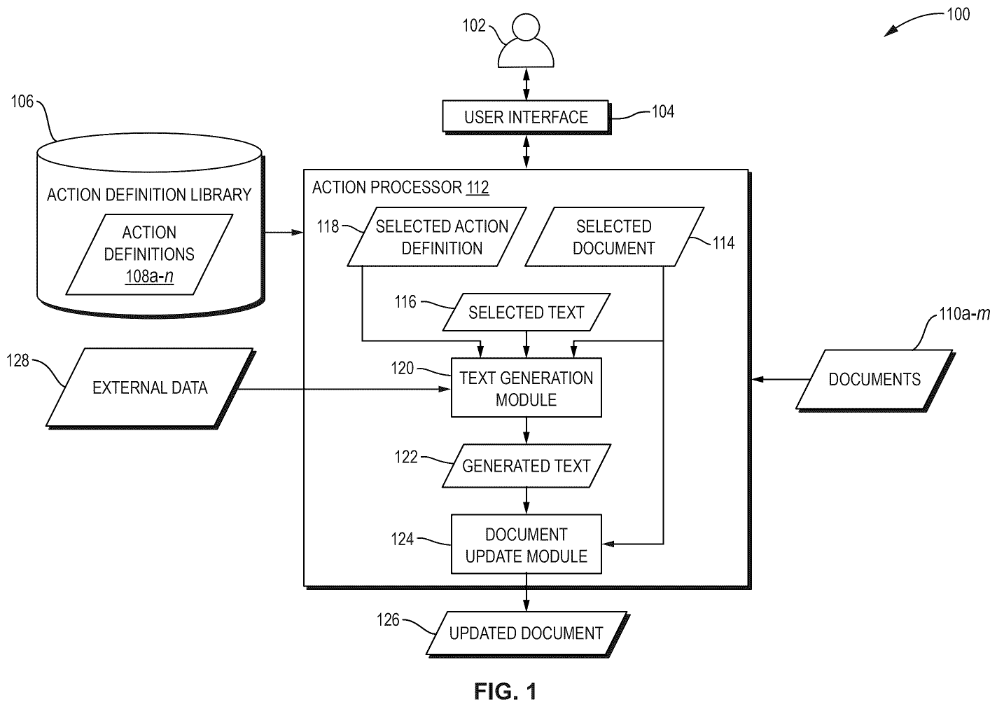

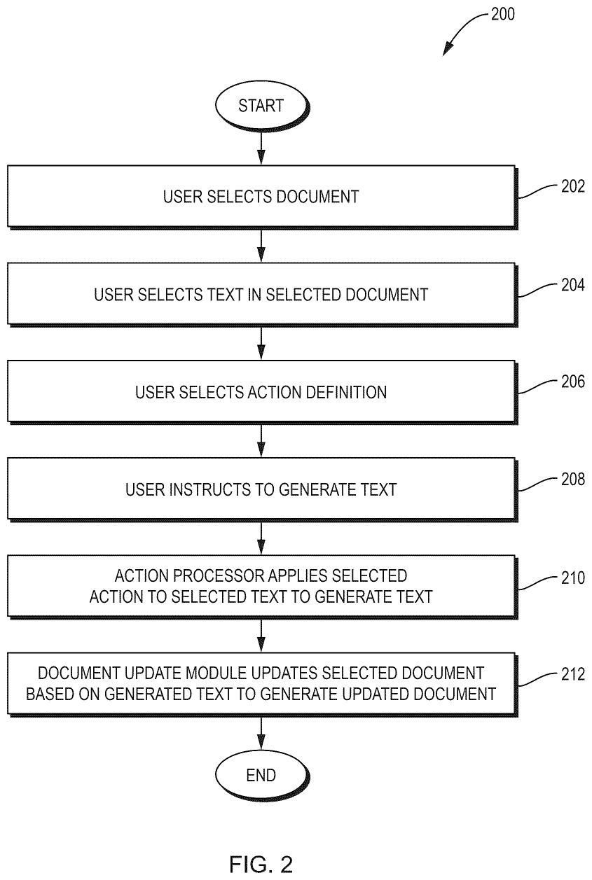

Referring to FIG. 1, a dataflow diagram is shown of a system 100 for generating text based on a selected document, text, and action definition, and for updating the selected document based on the generated text according to one embodiment of the present invention. Referring to FIG. 2, a flowchart is shown of a method 200 performed by the system 100 of FIG. 1 according to one embodiment of the present invention.

The system 100 includes a user 102, who may, for example, be a human user, a software program, a device (e.g., a computer), or any combination thereof. For example, in some embodiments, the user 102 is a human user. Although only the single user 102 is shown in FIG. 1, the system 100 may include any number of users, each of whom may perform any of the functions disclosed herein in connection with the user 102. For example, the functions disclosed herein in connection with the user 102 may be performed by multiple users, such as in the case in which one user performs some of the functions disclosed herein in connection with the user 102 and another user performs other functions disclosed herein in connection with the user 102.

The system 100 also includes a user interface 104, which receives input from the user 102 and provides output to the user 102. The user interface 104 may, for example, include a textual interface (which may, for example, receive textual input from the user 102 and/or provide textual output to the user 102), a graphical user interface (GUI), a voice input interface, a haptic interface, an Application Program Interface (API), or any combination thereof. Although only the single user interface 104 is shown in FIG. 1, the system 100 may include multiple user interfaces, in which case some of the functions disclosed herein in connection with the user interface 104 may be performed by one user interface, and other functions disclosed herein in connection with the user interface 104 may be performed by another user interface.

Although the disclosure herein provides certain examples throughout of inputs that may be received from the user 102 via the user interface 104, such examples are merely provided as illustrations and do not constitute limitations of the present invention. It should be understood for example, that any particular example of an input from the user 102 that is in a particular mode (e.g., text input or interaction with a graphical element in a GUI) may alternatively be implemented by an input from the user 102 in a different mode (e.g., voice).

Because the user 102 may be non-human (e.g., software or a device), the user interface 104 may receive input from, and provide output to, a non-human user. As this implies, the user interface 104 is not limited to interfaces, such as graphical user interfaces, that are conventionally referred to as “user” interfaces. For example, if the user 102 is a computer program, the user interface 104 may provide receive input from and provide output to such a computer program using an interface, such as an API, that is not conventionally referred to as a user interface, and that may not even manifest any output to a human user or that is perceptible directly by a human user.

The term “manifest,” as used herein, refers to generating any output to the user 102 via the user interface 104 in any form based on any data, such as any of the data shown in FIG. 1. The result of manifesting any particular data is referred to herein as a “manifestation” of that data. Manifesting data may include, for example, generating visual (e.g., textual, image, and/or video) output, audio output, and/or haptic output, in any combination. Therefore, any reference herein to generating output to the user 102 via the user interface 104 should be understood to include manifesting that output in any way, even if such a reference refers only to a particular kind of manifesting/manifestation (e.g., “displaying” or “showing” the output to the user 102).

The system 100 includes a plurality of documents 110a-m. Although the system 100 may include only a single document, the plurality of documents 110a-m is shown and described herein for the sake of generality. It should be understood, however, that features disclosed herein may be applied to a single document, rather than to the plurality of documents 110a-m.

The term “document” as used herein refers to any data structure that includes text. For example, a document may include, but is not limited to:
Text within social media interfaces, such as post composition windows, comment/reply interfaces, and profile editors
Text entry fields in communication platforms, including email composition interfaces, messaging applications, and collaboration tools
Web-based content creation interfaces, such as content management systems, blog editors, online forms, and wiki page editors
Text fields within professional and productivity tools, including documentation interfaces, project management tools, and code editor comment sections
Mobile application text interfaces, such as note-taking applications, mobile browser input areas, and form entry fields

These examples illustrate some of the many contexts in which the systems and methods disclosed herein may be applied, though the term “document” is not limited to these examples. As described above, a document may be or be part of a file in a file system, a record, a database table, or a database. A document may include data in addition to text, such as audio and/or visual data.

The user interface 104 may take various forms appropriate to the particular text-based interface being used. For example, when implemented within a social media platform, the user interface 104 may integrate with the platform's existing text composition window. When implemented within a messaging application, the user interface 104 may be integrated directly into the message composition field. These implementations leverage the system's ability to provide textual interfaces, graphical user interfaces, voice input interfaces, haptic interfaces, Application Program Interfaces (APIs), or any combination thereof, as appropriate to the specific use case.

This flexible approach to implementation enables embodiments of the present invention to be adapted to a wide variety of text-based environments and use cases. For instance, in a social media platform, the system might integrate directly with the platform's post composition interface. In a messaging application, the system may integrate with the message composition field. In a web-based email client, the system may be implemented as a browser extension. In a mobile note-taking app, the system may leverage the device's native text input capabilities. These examples demonstrate how the system's flexible architecture supports deployment across diverse text-based interfaces while maintaining the core capabilities described herein.

The system 100 also includes an action processor 112. As will be described in more detail below, the action processor 112 may perform a variety of functions. Although the action processor 112 is shown as a single module in FIG. 1, this is merely an example and does not constitute a limitation of the present invention. More generally, any of the functions disclosed herein as being performed by the action processor 112 may be performed by any one or more modules in any combination, which may include, for example, one or more software applications. As merely one example, selection of text within a document by the action processor 112 may be performed by one software application or module (e.g., a word processing application), while generation of text by the action processor 112 may be performed by another software application or module (e.g., a plugin to the word processing application). As this example illustrates, some functions performed by the action processor 112 may be performed by or in cooperation with one or more conventional components (e.g., a conventional word processing application), while other functions performed by the action processor 112 may be performed by one or more non-conventional components that have been implemented in accordance with the disclosure herein.

The user 102 selects a particular document (referred to herein as the selected document 114) within the plurality of documents 110a-m (FIG. 2, operation 202). For example, the user 102 may provide document selection input to the action processor 112 via the user interface 104, in response to which the action processor 112 may select the selected document 114 from among the plurality of documents 110a-m. The user 102 may select the selected document 114 in any of a variety of ways, such as by opening the selected document 114 in any known manner (e.g., double-clicking on an icon representing the selected document 114 in a GUI) or by selecting a window displaying the selected document 114 in a GUI. Although the selected document 114 is shown as a distinct element in FIG. 1, the selected document 114 may be implemented using a pointer, reference, or other data that identifies the selected document 114 within the plurality of documents 110a-m or which otherwise enables the action processor 112 to perform the functions disclosed herein in connection with the selected document 114.

Operation 202 is optional in the method 200. For example, operation 202 may be omitted if there is only one document in the system 100, if the action processor 112 itself has already selected a document, or if the selected document 114 is implicit or automatically-selectable by the action processor 112 without the user 102's input. Furthermore, even if operation 202 is performed, it may, for example, be performed once to select the selected document 114, and then not be performed again during subsequent instances of the method 200, in which case the original selected document 114 may be used during each such instance without being re-selected.

The user 102 selects text (referred to herein as the selected text 116) within the selected document 114 (FIG. 2, operation 204). For example, the user 102 may provide text selection input to the action processor 112 via the user interface 104, in response to which the action processor 112 may select the selected text 116 within the selected document 114. The user 102 may select the selected text 116 in any of a variety of ways, such as by selecting the selected text 116 in any known manner (e.g., dragging across the selected text 116 within a manifestation of the selected document 114 in a GUI) or by typing or speaking some or all of the selected text 116. The selected text 116 may or may not be in the selected document 114 before the user 102 selects the selected text 116. As an example of the latter, the selected document 114 may not contain the selected text 116, and the user 102 may “select” the selected text 116 by inputting (e.g., typing or speaking) the selected text 116, such as by inputting the selected text 116 into the selected document 114 or elsewhere (e.g., into a text field that does not cause the selected text 116 to be added to the selected document 114).

The user 102 may select the selected text 116 in a variety of other ways, such as by uploading a file containing the selected text 116, selecting a file containing the selected text 116, pasting the selected text 116 from a clipboard, or sending a message (e.g., a text message or an email message) containing the selected text 116.

Although the selected text 116 is shown as a distinct element in FIG. 1, the selected text 116 may be implemented using a pointer, reference, or other data that identifies the selected text 116 within the selected document 114 or which otherwise enables the action processor 112 to perform the functions disclosed herein in connection with the selected text 116. For example, the selected text 116 may be implemented using any known techniques for representing selected text within a document in a word processing application or other text editing application.

The selected text 116 may consist of less than all of the text in the selected document 114. As some examples, the selected text 116 may consist of a single character in the selected document 114 (which may include multiple characters), a single word in the selected document 114 (which may include multiple words), a single sentence in the selected document 114 (which may include multiple sentences), or a single paragraph in the selected document 114 (which may include multiple paragraphs). As another example, the selected text 116 may include all of the text in the selected document 114. In any of these cases, the selected text 116 may include or consist of a single contiguous block of text in the selected document 114.

The selected text 116 may include or consist of a plurality of non-contiguous blocks of text (also referred to herein as “text selections”) in the selected document 114, where each such text selection is contiguous within the selected document 114. For example, if the selected document 114 includes contiguous text blocks A, B, and C (i.e., if the selected document 114 includes text block A, followed immediately by text block B, followed immediately by text block C), then the selected text 116 may include text block A and text block C, but not text block B. The selected text 116 may implement such non-contiguous text selections using, for example, any known method for doing so. Similarly, the system 100 may enable the user 102 to select such non-contiguous text selections within the selected text 116 using, for example, any known method for doing so, such as by enabling the user to drag across a first such text selection in a manifestation of the selected document 114 in a GUI and then to drag across a second such text selection in the manifestation of the selected document 114 in the GUI while holding a predetermined key (e.g., CTRL or SHIFT).

The system 100 includes an action definition library 106, which may include one or a plurality of action definitions 108a-n.

The user 102 selects a particular action definition (referred to herein as the selected action definition 118) within the plurality of action definitions 108a-n (FIG. 2, operation 206). For example, the user 102 may provide action definition selection input to the action processor 112 via the user interface 104, in response to which the action processor 112 may select the selected action definition 118 from among the plurality of action definitions 108a-n. The user 102 may select the selected action definition 118 in any of a variety of ways, such as by selecting the selected action definition 118 from a manifested list of some or all of the action definitions 108a-n in any known manner (e.g., clicking or double-clicking on an icon representing the selected action definition 118 in a GUI) or by typing some or all of a label (e.g., short name) associated with the selected action definition 118. Although the selected action definition 118 is shown as a distinct element in FIG. 1, the selected action definition 118 may be implemented using a pointer, reference, or other data that identifies the selected action definition 118 within the plurality of action definitions 108a-n or which otherwise enables the action processor 112 to perform the functions disclosed herein in connection with the selected action definition 118.

As one particular example, the user 102 may select a manifestation of the selected text 116, and the action processor 112 may manifest a list of some or all of the plurality of action definitions 108a-n, such as in the form of a contextual menu. The action processor 112 may, for example, manifest such a list directly in response to the user 102's selection of the selected text 116, or in response to some additional input (e.g., right-clicking on the selected manifestation of the selected text 116) received from the user 102. The user 102 may then select one of the plurality of action definitions 108a-n from the list in any of the ways disclosed herein, thereby selecting the selected action definition 118. In response to that selection, or in response to some additional input from the user 102, the action processor 112 may perform operation 210. More generally, the action processor 112 may perform operation 210 in connection with any kind of selected text 116 disclosed herein.

In some embodiments, operation 206 may be performed once to select the selected action definition 118, and then not performed again during subsequent instances of the method 200, in which case the original selected action definition 118 may be used during each such instance without being re-selected.

The action definitions 108a-n may not take a form that is amenable to being manifested in ways that are conducive to being understood easily or quickly by users, especially users who are not technically sophisticated. For example, as will be described in more detail below, the action definitions 108a-n may include scripts and/or LLM prompts. Embodiments may facilitate user input for selecting the selected action definition 118 in operation 206 in any of a variety of ways. For example, the action processor 112 may manifest, for each of some or all of the action definitions 108a-n, a corresponding action definition label (also referred to herein as an “action definition short name” or merely as a “short name”) which contains less information than the corresponding action definition itself. For example, an action definition that includes an LLM prompt having 500 characters may have a short name that contains fewer characters (e.g., “Summarize” or “Rephrase”). The action processor 112 may, in operation 206, manifest only the short name of each manifested action definition and not the entire action definition. As an example, the action processor 112 may manifest a list (e.g., a menu or set of buttons) containing a plurality of short names corresponding to some or all of the action definitions 108a-n, such as “Summarize|Rephrase|Expand”. As this example illustrates, different ones of the action definitions 108a-n may have different short names.

The user 102 may select the selected action definition 118 in operation 206 by providing input, via the user interface 104, to the action processor 112, which specifies the selected action definition 118. Such input may take any of a variety of forms. For example, the user 102 may provide that input by selecting the selected action definition 118 from a set of manifestations (e.g., short names) representing some or all of the action definitions 108a-n. For example, if the action processor 112 has manifested a plurality of manifestations of some or all of the action definitions 108a-n (e.g., in the form of a menu or a plurality of buttons), the user 102 may provide the input selecting the selected action definition 118 by selecting (e.g., clicking on, tapping on, or speaking a short name of) one of the plurality of manifestations which corresponds to the selected action definition 118.

In some embodiments, the user 102 may provide input selecting the selected action definition 118 in operation 206 even if the action processor 112 has not manifested any manifestations of the plurality of action definitions 108a-n. For example, the user 102 may select the selected text 116 and then provide input selecting the selected action definition 118 even if the action processor 112 has not manifested any manifestations of the plurality of action definitions 108a-n, such as by speaking or typing input that selects the selected action definition 118 (e.g., a short name of the selected action definition 118).

The user 102 instructs the action processor 112 to generate text that is referred to herein as the generated text 122 (FIG. 2, operation 208). The user 102 may provide this instruction by providing input, via the user interface 104, to the action processor 112, which instructs the action processor 112 to generate the generated text 122. Such input may take any of a variety of forms, such as speaking a voice command, typing a textual command, or providing any kind of input in connection with a GUI element, such as pressing a button or selecting a menu item.

In some embodiments, operation 208 may be omitted or combined with operation 206. For example, the action processor 112 may interpret the user 102's selection of the selected text 116 and/or the user 102's selection of the selected action definition 118 as an instruction to generate the generated text 122, or may otherwise generate the generated text 122 in response to the user 102's selection of the selected text 116 and/or the selected action definition 118, as a result of which the user 102 may not provide any distinct input instructing the action processor 112 to generate the generated text 122. For example, in response to the user 102 selecting the selected text 116 and selecting a short name of one of the action definitions 108a-n, the action processor 112 may generate the generated text 122 (operation 208) without receiving any additional input from the user 102 representing an instruction to generate the generated text 122.

In some embodiments, operation 208 may be performed once to receive an instruction from the user 102 to generate the generated text 122, and then not be performed again during subsequent instances of the method 200. For example, if the selected document 114 and the selected action definition 118 have been selected, the user 102 may provide input, via the user interface 104, to the action processor 112, instructing the action processor 112 to enter an “action mode.” While in the action mode, the action processor 112 may, in response to any text in the selected document 114 being selected as an instance of the selected text 116, perform an action represented by the selected action definition 118 on that instance of the selected text 116 to generate a corresponding instance of the generated text 122, without the user 102 providing an instruction to generate each such instance of the generated text 122. Such an action mode enables the user to select the selected document 114 and selected action definition 118 once, and then to apply an action represented by the selected action definition 118 to a plurality of instances of the selected text 116 in the selected document 114 quickly and easily, without having to select the selected action definition 118 each time and without having to issue an instruction to perform an action represented by the selected action definition 118 each time.

Although certain operations are shown in a particular order in the method 200 of FIG. 2, this order is merely an example and does not constitute a limitation of the present invention. Operations in the method 200 may be performed in other orders. As some examples:
[symbol] The user 102 may select the selected text 116 (operation 204) after selecting the selected action definition 118 (operation 206).
[symbol] The user 102 may select the selected action definition 118 before selecting the selected [symbol] text 116 (operation 204).
[symbol] The user 102 may select the selected action definition 118 before selecting the selected document 114 (operation 202).

The system 100 includes a text generation module 120, which applies an action defined by the selected action definition 118 (referred to herein as the “selected action” or a “corresponding action” of the selected action definition 118) to the selected text 116 to generate the generated text 122 (FIG. 2, operation 210). The generated text 122 may include at least some text that is not in the selected text 116. For example, none of the text in the generated text 122 may be in the selected text 116. As another example, the generated text 122 may include some text that is in the selected text 116 and some text that is not in the selected text 116. For example, if the selected text 116 includes text A followed immediately by text B, the generated text 122 may include text A followed immediately by text C, where text B differs from text C. As another example, if the selected text 116 includes text A followed immediately by text B, the generated text 122 may include text C followed immediately by text B, where text A differs from text C. The generated text 122 may include (e.g., consist of) text that is not in the selected document 114.

The system 100 may also include a variety of external data 128. The external data may be external in the sense that it is not contained in the documents 110a-m or in the selected document 114. The external data 128 may, however, be contained within the action processor 112 and/or be outside the action processor 112. The external data 128 may, for example, include data stored in any combination of the following: one or more data structures, files, records, databases, and/or websites. The external data 128 may include static data and/or dynamically-generated data, such as data that is generated dynamically in response to a request from the system 100 (e.g., the action processor 112).

The text generation module 120 may receive some or all of the external data 128 as input and apply the action corresponding to the selected action definition 118 to both the selected text 116 and to some or all of the external data 128. For example, as described in more detail below, the text generation module 120 may modify and/or generate a prompt based on the external data 128, such as by including some or all of the external data 128 in the prompt (e.g., by using some or all of the external data 128 as a value for one or more tokens in the prompt). As another example, the text generation module 120 may include some or all of the external data 128 in the generated text 122, whether or not the text generation module 120 includes that data in a prompt that is used to generate the generated text 122. As an example, the text generation module 120 may use a prompt (which does not include any of the external data 128) to generate the generated text 122 and then update the generated text 122 based on some or all of the external data 128, such as by including some or all of the external data 128 in the generated text 122.

The system 100 may utilize Retrieval Augmented Generation (RAG) to enhance its ability to generate and process text. RAG is a technique that combines the power of large language models with the ability to retrieve and incorporate relevant information from external sources. For example, when creating a prompt based on the selected text 116 and the selected action definition 118, the text generation module 120 may use RAG to retrieve relevant information from the documents 110a-m and/or external data 128. The text generation module 120 may incorporate such retrieved information incorporated into the prompt to provide additional context or guidance to the language model.

As another example, when processing the output generated by the text generation module 120 (e.g., the generated text 122), the text generation module 120 may use RAG to fact-check, augment, and/or refine such output based on information retrieved from trusted sources. The results of such processing may be used to modify the generated text 122 before providing the generated text 122 as output to the user 102. As yet another example, the document update module 124 updates the selected document 114 based on the generated text 122, the document update module 124 may use RAG to ensure consistency with other parts of the document or to incorporate relevant information from related documents.

RAG is merely one example of a variety of techniques that the system 100 may use to improve the output of language models, such as for the purpose of making the generated text 122 as relevant to the user 102 as possible. These techniques aim to customize and enhance the operation of language models to better suit the specific needs of the user 102 and the context of the document being edited. Some examples of such techniques include:
Fine-tuning: The system 100 may use fine-tuned language models that have been further trained on domain-specific data or the user 102's own writing style. The system 100 itself may perform such fine-tuning.
Few-shot learning: By providing the language model with a few relevant examples within the prompt, the system 100 can guide the model to generate more appropriate and contextually relevant text.
LARA (Light and Anti-overfitting Retraining Approach): The system 100 may employ LARA to fine-tune language models in a way that reduces overfitting and maintains the model's general knowledge while adapting it to specific tasks or domains. This can help produce more reliable and contextually appropriate generated text 122.
Prompt engineering: The system 100 may employ advanced prompt engineering techniques, such as chain-of-thought prompting or self-consistency, to elicit more coherent and relevant responses from the language model.
Ensemble methods: The system 100 may combine outputs from multiple language models or multiple runs of the same model to produce more robust and diverse generated text 122.
Context windowing: For longer documents, the system 100 may use sliding context windows to provide the language model with the most relevant surrounding text, ensuring that the generated text 122 maintains coherence with the broader document.

These techniques, either individually or in combination, may be applied by the text generation module 120 and the system 100 more generally to enhance the relevance and quality of the generated text 122. The specific techniques used may depend on factors such as the selected action definition 118, the nature of the selected document 114, and user preferences.

The system 100 includes a document update module 124, which updates the selected document 114 based on the generated text 122 to generate an updated document 126 (FIG. 2, operation 212). The document update module 124 may perform operation 212 in any of a variety of ways. For example, the document update module 124 may perform operation 212 by:
[symbol] replacing the selected text 116 in the selected document 114 with the generated text 122;
[symbol] modifying the selected text 116 in the selected document 114 based on the generated text 122; or
[symbol] adding the generated text 122 to the selected document 114, without modifying the selected text 116 in the selected document 114.

As the above implies, as a result of operation 212, the updated document 126 may include some or all of the generated text 122, even if the selected document 114 did not include the generated text 122.

The system 100 may enable the user 102 to select the update mode of the document update module 124 from among a plurality of update modes (e.g., from the “replace,” “modify,” and “add” modes described above). This feature allows the user 102 to choose how the generated text 122 will be integrated into the selected document 114.

To implement such a user-selectable document update mode, the system 100 may receive document update mode selection input from the user 102, e.g., via the user interface 104. As one example, the system 100 may manifest output, via the user interface 104, representing a plurality of available document update modes, and the user 102 may provide document update mode selection input selection one of the available document update modes (the “selected document update mode”). At any later time, the document update module 124 may perform operation 212 using the selected document update mode.

As another example, the action definitions 108a-n in the action definition library 106 may include a parameter specifying the default update mode for each action definition. The user 102 may be able to override this default setting when selecting an action definition. In any case, when the document update module 124 performs operation 212, the document update module 124 may identify the update mode (e.g., the default update mode or user-overridden update mode) associated with the selected action and perform operation 212 using the identified update mode. As yet another example, the system 100 may include a global setting that determines the default update mode, which the user 102 can override, such as by using a settings menu in the user interface 104. In any case, when the document update module 124 performs operation 212, the document update module 124 may identify the system-wide update mode (e.g., the default system-wide update mode or user-overridden system-wide update mode) and perform operation 212 using the identified update mode.

The document update module 124 may perform operation 212 directly or indirectly on the selected document 114 in any of a variety of ways. For example, the document update module 124 may directly update the selected document 114 in any of the ways disclosed herein to generate the updated document 126, which may be an updated version of the selected document 114, such as in embodiments in which the user 102 edits the selected document 114 in a software application via the user interface 104, and in which the document update module 124 has direct access to the selected document 114. Alternatively, for example, the document update module 124 may provide output (not shown), which specifies modifications to be made to the selected document 114, to another component (not shown), such as a text editing application (e.g., word processing application), which has direct access to the selected document 114, in which case that other component (e.g., text editing application) may update the selected document 114 in the manner specified by the output from the document update module 124 to generate the updated document 126.

Although the updated document 126 is shown distinctly from the selected document 114 in FIG. 1 for ease of illustration, the updated document 126 may be an updated version of the selected document 114, such that no document separate from the selected document 114 is generated by operation 212. Alternatively, for example, operation 212 may generate the updated document 126 as a document that is distinct from the selected document 114, such that, as a result of operation 212, the selected document 114 and the updated document 126 both exist simultaneously (e.g., as distinct documents in a file system), and the selected document 114 may remain unchanged by operation 212.

Regardless of how operation 212 is performed, once the updated document 126 has been generated, the user interface 104 may generate manifest some or all of the updated document 126, thereby generating a manifestation of the updated document 126, which may be provided to the user 102 via the user interface 104. For example, the user interface 104 may manifest (e.g., display) some or all of a portion of the updated document 126 containing the generated text 122 to the user 102.

As mentioned above, operation 212 may include inserting some or all of the generated text 122 into the selected document 114. More generally, the action processor 112 may identify a location (referred to herein as “the selected output location”), whether in the selected document 114 or in another one of the documents 110a-m, and insert the generated text 122 at the selected output location, or otherwise update the selected document 114 at the selected output location based on the generated text 122. The action processor 112 may identify the selected output location in any of a variety of ways, such as automatically or by receiving input from the user 102 via the user interface 104, which specifies the selected output location.

The action processor 112 may receive such input from the user 102 specifying the selected output location in any of a variety of ways. For example, the user 102 may specify the selected output location, such as by clicking or tapping on a manifestation of the selected output location (e.g., in a manifestation of the selected document 114 or another one of the documents 110a-m). The user 102 may provide input specifying the selected output location at any of a variety of times, such as before operation 202; after operation 202 and before operation 204; after operation 204 and before operation 206; after operation 206 and before operation 208; after operation 208 and before operation 210; or after operation 210 and before operation 212. As a particular example, the action processor 112 may perform operation 210 to generate the generated text 122 and then receive input from the user 102 specifying the selected output location. The action processor 112 may, for example, manifest a preview of the updated document 126 to the user 102, showing how the updated document 126 would appear if it were updated based on the user 102's selected output location, and enable the user 102 to accept or reject that version of the updated document 126. If the user 102 rejects that version of the updated document 126, the system 100 may enable the user 102 to select an alternative selected output location, in response to which the action processor 112 may manifest a preview of the updated document 126 to the user 102 based on the alternative selected output location and repeat the process just described. This process may repeated any number of times until the user 102 accepts an output location, at which point the latest version of the updated document 126 is output by the action processor 112 in operation 212.

The selected output location may, but need not be, within the selected document 114 or within any of the documents 110a-m. As another example, the selected output location may be in a new document/window/panel, in which case the action processor 112 may, as part of or after operation 212, generate a new document/window/panel and insert the generated text 122 into the new document/window/panel, which is an example of the updated document 126.

In some embodiments, the document update module 124 uses a language model (e.g., a large language model (LLM)) in the performance of operation 212. For example, each of some or all of the action definitions 108a-n may include, refer to, or otherwise specify one or more corresponding prompts suitable for being provided as input to a language model. Different ones of the action definitions 108a-n may include, refer to, or otherwise specify different corresponding prompts. For any particular action definition, the prompt(s) that the particular action definition includes, refers to, or otherwise specifies is referred to herein as the particular action definition's “corresponding prompt” (even if there are a plurality of such prompts). The selected action definition 118 may have a particular corresponding prompt. Applying the selected action definition 118 to the selected text 116 may include, for example, providing the selected action definition 118's corresponding prompt as an input to a language model to generate some or all of the generated text 122, or otherwise to generate output which the action processor 112 processes to generate some or all of the generated text 122 (whether or not the generated text 122 includes any of the output of the language model).

Before providing input to a language model, the action processor 112 may, for example, generate a prompt based on the selected action definition 118 and the selected text 116 (and, optionally, the selected document 114 and/or the external data 128). Although more examples of how the action processor 112 may generate such a prompt will be described in more detail below, the action processor 112 may, for example, generate a prompt (referred to herein as a “combined prompt”) which includes both some or all of the selected action definition 118's corresponding prompt and some or all of the selected text 116, such as by concatenating the selected action definition 118's corresponding prompt with some or all of the selected text 116. As a particular example, the combined prompt may include or consist of the selected action definition 118's corresponding prompt followed immediately by the selected text 116, or the selected text 116 followed immediately by the selected action definition 118's corresponding prompt. The action processor 112 may provide such a combined prompt to a language model to generate output (e.g., the generated text 122) in any of the ways disclosed herein.

More generally, the action processor 112 may perform any of a variety of actions to generate the combined prompt based on the select action definition 118's corresponding prompt and (optionally) additional data, such as any one or more of the selected text 116, the selected document 114, the documents 110a-m, or the external data 128. As described in more detail below, the actions that the action processor 112 performs to generate the combined prompt may include one or more actions other than “combining” the selected action definition 118's corresponding prompt. As a result, although the resulting prompt is referred to herein as the “combined prompt,” this prompt may also be understood as a “processed prompt” or “final prompt,” meaning that it results from processing the selected action definition 118's corresponding prompt and (optionally) additional data, whether or not such processing is characterizable as “combining” the selected action definition 118's corresponding prompt with other information. Merely one example of such processing is to use a trained model, such as an LLM, to generate the combined prompt based on the selected action definition 118's corresponding prompt and (optionally) additional data.

As implied by the description herein, embodiments of the system 100 may enable the user 102 to cause the action processor 112 to provide the combined prompt to the language model without the user 102 typing or otherwise inputting the combined prompt (or at least the entirety of the combined prompt) to the action processor 112. The action processor 112 may not even manifest the combined prompt (or at least the entirety of the combined prompt) to the user 102. For example, the user 102 may select the selected text 116 and select a short name of the selected action definition 118, which may contain only a small amount of text (e.g., “Summarize”), without inputting (e.g., typing or speaking) the corresponding prompt of the selected action definition 118 (which may contain a large amount of text that is not manifested by the action processor 112 to the user 102), and thereby cause the action processor 112 to: (1) generate a combined prompt based on the corresponding prompt of the selected action definition 118 and the selected text 116; (2) provide the combined prompt as input to a language model to generate output (e.g., the generated text 122); and (3) generate the updated document 126 based on output (e.g., the generated text 122) generated by the language model. Such a process enables the user 102 to leverage the power of a language model to generate the generated text 122, and to generate the updated document 126 based on the generated text 122, without having to manually create or input a prompt to the language model based on the selected text 116, and without having to manually update the selected document 114 based on the output of the language model. Instead, the action processor 112 may perform these operations automatically, thereby not only saving the user 102 manual time and effort, but also increasing the processing efficiency of the system 100 as a whole by enabling it to generate the generated text 122 and to generate the updated document 126 in fewer operations, and more quickly, than would be possible using a conventional chatbot-based approach.

Any language model referred to herein may be of any type disclosed herein. Any language model referred to herein may be contained within the system 100 (e.g., within the action processor 112) or be external to the system 100 (e.g., external to the action processor 112), in which case the system 100 (e.g., the action processor 112) may provide input to and receive output from the language model using a suitable interface, such as an API.

Although the disclosure herein may refer to “a language model,” it should be understood that embodiments of the present invention may use a plurality of language models. As a result, any disclosure herein of performing multiple operations using a language model (e.g., generating a first instance of the generated text 122 using a language model and generating a second instance of the generated text 122 using a language model) should be understood to include either using the same language model to perform those multiple operations or to using different language models to perform those multiple operations. Embodiments of the present invention may select a particular language model to perform any operation disclosed herein in any suitable manner, such as automatically or based on input from the user 102 which selects a particular language model for use.

Any language model disclosed herein may (unless otherwise specified) include one or more language models, such as any one or more of the following, in any combination:
a unigram language model;
an n-gram language model;
an exponential language model;
a generative language model;
an autoregressive language model; and
a neural network language model.

Any language model disclosed may, unless otherwise specified, include at least 1 billion parameters, at least 10 billion parameters, at least 100 billion parameters, at least 500 billion parameters, at least 1 trillion parameters, at least 5 trillion parameters, at least 25 trillion parameters, at least 50 trillion parameters, or at least 100 trillion parameters.

Any language model disclosed herein may, unless otherwise specified, have a size of a least 1 gigabyte, at least 10 gigabytes, at least 100 gigabytes, at least 500 gigabytes, at least 1 terabyte, at least 10 terabytes, at least 100 terabytes, or at least 1 petabyte.

Any language model disclosed herein may, for example, include one or more of each of the types of language models above, unless otherwise specified. As a particular example, any language model disclosed herein may, unless otherwise specified, be or include any one or more of the following language models, in any combination:
[symbol] Any language model in the GPT-n series of language models (such as any language model in the GPT-1, GPT-2, GPT-3, or GPT-4 families) available from OpenAl Incorporated of San Francisco, California;
[symbol] any version of the Language Model for Dialogue Applications (LaMDA), Generalist Language Model (GLaM), Pathways Language Model (PaLM), or Gemini, available from Google LLC of Mountain View, California;
[symbol] any version of the Gopher language model, available from DeepMind Technologies of London, United Kingdom;
[symbol] any version of the Turing-NLG (Turing Natural Language Generation) language model, available from Microsoft Corporation of Redmond, Washington;
[symbol] any version of the Megatron Language Model (Megatron-LM), available from Nvidia Corporation of Santa Clara, California; and
[symbol] any version of the Large Language Model Meta AI (LLaMA), available from Meta Platforms, Inc. of Menlo Park, California.

The action definitions 108a-n may take any of a variety of forms, some of which will now be described. Different ones of the action definitions 108a-n may be of different types. In other words, the types of action definitions 108a-n disclosed herein may be mixed and matched within the action definition library 106. Any particular embodiment of the present invention may implement some or all of the action definition types disclosed herein. Types of action definitions 108a-n may include, for example, any one or more of the following, in which the examples of prompts and user interfaces are merely examples and do not constitute limitations of embodiments disclosed herein:
Simple Text Prompts:
   Description: These are plain text prompts with no dynamic content (e.g., tokens or scripts). Examples are: “Expand on the following text:”, “Summarize the following text:”, and “Rewrite the following text to be understandable by a five year-old:”.
   UI/UX Approach: Each simple text prompt may, for example, be displayed as a corresponding UI element (e.g., list item or button) with a distinct label, such as the corresponding action definition's short name. Clicking such a UI element causes the corresponding action definition to be selected as the selected action definition 118.
      Selection: Single-click.
      Viewing: Hovering over the UI element may display a tooltip with details (e.g., a description of the corresponding prompt and/or the full text of the corresponding prompt).
      Editing: Right-click or a small adjacent “edit” icon opens a simple text box, which enables the user 102 to edit the corresponding prompt and then save the edits.
Tokenized Prompts:
   Description: Prompts that contain placeholders (tokens) that can be dynamically replaced with content from any of a variety of sources, such as the selected text 116, the selected document 114, the documents 110a-m, input from the user 102 via the user interface 104, and/or external data 128.
   UI/UX Approach: Displayed similarly to simple text prompts, but with indications (e.g., colored/italicized) to suggest dynamic content.
      Selection: Single-click.
      Viewing: Tokens highlighted or underlined. Hovering over them shows a tooltip with details.
      Editing: Clicking on the token allows the user to select an alternative or input their own.
Alternative Take Prompts (an example of “compound prompts”):
   Description: Multiple prompts, bundled in one prompt, representing alternatives for producing varied outputs. Each prompt within an alternative take prompt is an example of what is referred to herein as a “component prompt.” Each component prompt within an alternative take prompt may be of any of the prompt types disclosed herein (e.g., simple, tokenized, compound, or scripted). When the action processor 112 executes an alternative take prompt, the action processor 112 performs operation 210 once for each of some or all of the alternative take prompt's component prompts in connection with the selected text 116, thereby generating a plurality of instances of the generated text 122 (one for each of some or all of the alternative take prompt's component prompts). The action processor 112 then enables the user 102 to select one or more of the plurality of instances of the generated text 122, in response to which the action processor 112 performs operation 212 on each instance of the generated text 122 selected by the user 102.
   UI/UX Approach: Displayed as a dropdown or expandable list.
      Selection: Clicking the compound prompt reveals components.
      Viewing: Expandable sections allow users to see each alternative.
      Editing: Users can add, remove, or modify each component prompt.
Chained Prompts (an example of “compound prompts”):
   Description: Multiple prompts, bundled in one prompt, which are sequenced to execute in a specific order. Each prompt within a chained prompt is an example of a component prompt. Each component prompt within a chained prompt may be of any of the prompt types disclosed herein (e.g., simple, tokenized, compound, or scripted). When the action processor 112 executes a chained prompt, the action processor 112 performs operation 210 on the first of the chained prompt's component prompts in connection with the selected text 116, thereby generating a first instance of the generated text 122. The action processor 112 then performs operation 210 again, but uses the first instance of the generated text 122 to play the role of the selected text 116, thereby generating a second instance of the generated text 122. In other words, the action processor 112 uses the output of one instance of operation 210 as an input to the next instance of operation 210. This continues for all of the chained prompt's component prompts in order, at which point the most recent instance of the generated text 122 is used as the generated text 122 in operation 212.
   UI/UX Approach: Displayed as a list with visual indications of the sequence (numbers/arrows).
      Selection: Single-click to apply the sequence.
      Viewing: Steps could be expandable or displayed with details on hover.
      Editing: Drag-and-drop for rearranging. Individual step editing similar to simpler prompt types.
Scripted Prompts:
   Description: Prompts, written in a scripting language, which may contain any one or more of the following, in any combination: prompts of any of the types disclosed herein, conditions, loops, and multifaceted logic. A scripted prompt may include at least one instruction to apply a corresponding action of the selected action definition 118 to the selected text 116, and may include: any number of instructions that perform actions other than the corresponding action of the selected action definition 118; and any number of instructions that perform actions that do not apply to the selected text 116. More generally, a scripted prompt may include instructions for performing any arbitrary action, whether or not related to the selected document 114, the selected text 116, or the selected action definition 118. As this implies, if the selected action definition 118 includes or otherwise specifies a scripted prompt, then operation 210 may include executing the script in that scripted prompt. As this implies, operation 210 is not limited to providing a prompt as input to a language model, but may include executing a script, which may include performing operations other than providing a prompt as input to a language model and operations other than performing inferencing using a language model.
   UI/UX Approach: These may, for example, be represented with unique icons or visuals to distinguish their complexity.
      Selection: Single-click, but with warnings or confirmations due to their complexity.
      Viewing: A dedicated “view mode” that expands the script in a readable, perhaps even flowchart-like format.
      Editing: A specialized script editor, potentially with hints, autofill, or predefined logic blocks to assist less technically inclined users.

What is described herein as an “alternative take prompt” may be implemented in any of a variety of ways. For example, a plurality of component prompts may be stored within a single action definition, in which case the action processor 112 may perform operation 210 once for each of some or all of the plurality of stored component prompts. As another example, the system 100 may enable the user 102 to select a plurality of component prompts using any of the techniques disclosed herein for selecting the selected action definition 118. The action processor 112 may perform operation 210 once for each of the plurality of component prompts selected by the user 102, whether or not those component prompts are stored within an action definition or the action definition library 106. Such an “on the fly” or “one time use” alternative take prompt may provide the user 102 with convenience and flexibility in executing alternative take prompts without the need to define and store such prompts in the action definition library 106 in advance.

An alternative take prompt may be implemented by executing even a single instance of the selected action definition 118, in any of the ways disclosed herein, a plurality of times to produce a plurality of instances of the generated text 122. Such instances of the generated text 122 may differ from each other because, for example, of the stochastic nature of LLMs and other models that may be used by the text generation module 120 to perform operation 210. As this example illustrates, an alternative take prompt may, but need not, include a plurality of prompts in order to achieve the effect of alternative takes.

The system 100 may handle the multiple outputs generated by an alternative take prompt in at least two different ways. As another example, the system 100 may provide all of the outputs to the user 102 for review via the user interface 104. The user 102 may then select one or more of these outputs, and the system 100 may use the selected output(s) to update the selected document 114 in operation 212. This approach allows for maximum user control and decision-making in the document revision process.

Alternatively, for example, the text generation module 120 may process the plurality of outputs generated using an alternative take prompt internally to produce a single instance of the generated text 122. The text generation module 120 may employ various methods to process multiple outputs internally, such as any one or more of the following:
[symbol] Concatenation: The text generation module 120 may combine all outputs sequentially to create a single, comprehensive instance of the generated text 122.
[symbol] Best Output Selection: The text generation module 120 may use one or more predefined criteria or machine learning algorithms to evaluate and select the “best” output among the alternatives. This may, for example, be based on factors such as relevance, coherence, or alignment with the user 102's writing style.
[symbol] Synthesis: The text generation module 120 may analyze the multiple outputs and create a new, synthesized text that incorporates the most relevant and/or high-quality elements from each alternative.
[symbol] Voting or Consensus: If the alternative take prompt generates similar ideas across multiple outputs, the text generation module 120 may identify common themes or phrases and construct a single output based on the most frequently occurring elements.

Any of the methods described above for generating a single instance of the generated text 122 based on multiple outputs of an alternative take prompt may, for example, include using a language model (e.g., an LLM) to generate that single instance of the generated text 122.

The method for handling multiple outputs of an alternative take prompt may, for example, be configured as a system-wide setting, specified within individual action definitions, or selected by the user 102 on a case-by-case basis through the user interface 104. This flexibility allows the system 100 to adapt to different user preferences and document revision scenarios, maintaining a balance between automated efficiency and user control.

As the types of prompts disclosed above illustrate, the text generation module 120 may act as a function which takes the selected text 116 as an input to the function, and which evaluates the function on the selected text 116 to generate the generated text 122. Such a function may have, as inputs, not only the selected text 116 but also one or more other inputs, such as any of the other values disclosed herein. For example, the selected text 116 may include or consist of a plurality of non-contiguous text selections in the selected document 114. Each of those non-contiguous text selections may be inputs to a single functions that is evaluated by the text generation module 120 to generate the generated text 122. As a particular example, if a tokenized prompt includes two tokens, then a first of the text selections in the selected text 116 may serve as the value for a first one of the two tokens in the tokenized prompt, and a second one of the text selections in the selected text 116 may serve as the value for a second one of the two tokens in the tokenized prompts. The text generation module 120 may generate the generated text 122 based on the resulting tokenized prompt (with the first and second text selections substituted into it).

As used herein, the term “prompt” includes not only prompts that are suitable to be provided to a language model, but more generally to any kind of action definition described herein, whether or not such an action definition includes or consists of content (e.g., text) that is suitable for being provided to a language model. For example, as used herein, the term “prompt” includes not only literal text prompts that are suitable to be provided directly to a language model, but more generally encompasses any form or representation of an action definition that can be used to generate output from a language model or other text generation system. This includes, but is not limited to:
Vector representations or embeddings derived from or representing prompts
Transformed or processed versions of prompts
Numerical or mathematical representations of prompts
Compressed or encoded forms of prompts
Any intermediate representations generated during processing
Any combination of the above forms

Embodiments of the present invention may, for example, transform prompts into any such alternative representations before using them to generate output. Such transformations may occur at any stage of processing, whether during action definition creation, storage, or execution. The system may store and use prompts in their original form, in transformed forms, or both.

This broad definition of prompts aligns with the system's support for sophisticated processing approaches, including multi-stage transformations, hybrid processing combining language model and non-language model stages, and various technical implementations across distributed systems. The system may process prompts using any combination of: traditional language model interactions, vector/embedding-based processing, fine-tuned model approaches, few-shot learning techniques, ensemble methods, context-aware processing, and/or any other suitable technical approach for generating output based on prompts in any form.

As mentioned above, a tokenized prompt may include one or more tokens. Similarly, a compound prompt or scripted prompt may include one or more tokens. Any particular prompt may include one or more tokens of any type(s), in any combination. Examples of token types include the following:
[symbol] Selected Text Token:
   Represents the selected text 116.
   An example of a prompt that includes a selected text token is: “Summarize the following text: {selected_text}.”
[symbol] Contextual Tokens:
   Pulls from a broader context within or related to the selected document 114, such as the paragraph before/after the selected text, a specified portion (e.g., sentence, paragraph, or section) of the selected document 114, a specified feature (e.g., title) of the selected document 114, or specified metadata (e.g., creation date, last modified date, owner) of the selected document 114.
   An example of a prompt that includes a contextual token is: “Considering the following: {previous_paragraph}, elaborate on {selected_text}.”
[symbol] Date & Time Tokens:
   Automatically fetches a date and/or time, such as the current date and/or time.
   An example of a prompt that includes a date and time token is: “In the context of {selected_text}, what have been its impacts until {today}?”
[symbol] User Profile Tokens:
   Refers to user's stored information, such as name, preferences, or writing style.
   An example of a prompt that includes a user profile token is: “Rephrase {selected_text} in the following writing style: {user_writingstyle}.”
[symbol] Document Metadata Tokens:
   Refers to metadata of the selected document 114 and or the documents 110a-m, such as document title, author, or word count. Such metadata may, for example, include any metadata that may be defined, generated, and accessed via a Document Object Model (DOM) or similar structure(s) that represent document data and metadata in an accessible and modifiable form.
   An example of a prompt that includes a document metadata token is: “Incorporate {selected_text} into the theme of {document_title}.”
[symbol] Genre/Style Tokens:
   Offers a tone or style shift based on genres such as humor, academic, journalistic, or romance.
   An example of a prompt that includes a user genre/style token is: “Rewrite {selected_text} in a {genre} tone.”
[symbol] Reference Tokens:
   For cases where users want to correlate selected text with external references or sources.
   An example of a prompt that includes a reference token is: “Compare {selected_text} with known literature on {reference_topic}.”
[symbol] Numeric Tokens:
   For representing specific numbers or numerical ranges.
   An example of a prompt that includes a numeric token is: “Summarize {selected text} in no more than {max_words} words.”
[symbol] Language Tokens:
   For representing identifiers of particular languages.
   An example of a prompt that includes a language token is: “Translate {selected_text} into {specified_language}.”
[symbol] Location Tokens:
   Refers to specific locations or regions, potentially useful for location-based content.
   An example of a prompt that includes a location token is: “Adapt {selected_text} for an audience in {specified_location}.
[symbol] Historical/Temporal Tokens:
   For referencing specific historical periods or future predictions.
   An example of a prompt that includes a historical/temporal token is: “How might {selected_text} have been written in the {specified_era}?”
[symbol] Feedback Loop Tokens:
   A token that allows users to refer to previous outputs or iterations in the current session/chat/iteration of the method 200.
   An example of a prompt that includes a feedback loop token is: “Considering my last request, refine {selected_text}.
[symbol] Emotion Tokens:
   Adjusts content based on specified emotions or feelings.
   An example of a prompt that includes an emotion token is: “Describe {selected_text} in a {mood} mood.”

As the above examples of token types imply, embodiments of the present invention may employ any of a wide variety of token types. A token may appear at any location within a prompt. For example, a token may appear after an instance of plain text in the prompt, before an instance of plain text in the prompt, or between two instances of plain text in the prompt. As another example, two tokens may appear contiguously within a prompt. As these examples indicate, a prompt may include plain text and tokens in sequences such as “<token> <plaintext>”, “<plaintext> <token>”, “<token> <plaintext> <token>”, “<plaintext> <token> <plaintext>”, “<token> <token>”, or “<plaintext> <token> <token>”, merely as examples. The user 102 may use any of the techniques disclosed herein to insert one or more tokens at any desired location(s) within a prompt. These features of tokens are applicable not only to the “tokenized prompt” action definition type disclosed herein, but to any type of action definition that is capable of including one or more tokens.

When performing operation 210, the action processor 112 may, for each token in the prompt to be provided as input to the language model, obtain a value for that token and replace the token with the obtained value in the prompt. The action processor 112 may then provide the resulting resolved prompt (which is an example of a “combined prompt” as that term is used herein) to the language model in operation 210.

In addition to simple tokens that are replaced with a single value, the system 100 may support tokens with multiple replaceable parameters. These multi-parameter tokens allow for more complex and flexible token replacement within prompts. A multi-parameter token may take the following general form:
{token_name(param1, param2, . . . , paramN)} where “token_name” is the identifier for the token, and “param1” through “paramN” are individual parameters that can each be replaced with their own values.

For example, a date range token might look like this:
{date_range(start_date, end_date, format)}

When processing such a token, the text generation module 120 may replace each parameter with its corresponding value. The action processor 112 may obtain values for each parameter using any of the methods described for single-value tokens, including automatic retrieval, user input, or derivation from other data sources.

The action processor 112 may obtain such token values in any of a variety of ways. For example, the action processor 112 may obtain a value of any particular token automatically, such as by using any of a variety of known techniques. For example, certain tokens, such as the user's preferred genre, may be stored in a variable of a data structure, from which the action processor 112 may retrieve the token's value automatically. As another example, certain tokens, such as a token representing the current date, may have values that the action processor 112 may obtain by executing a function associated with the token. As another example, the action processor 112 may generate a token's value using a trained model, such as a large language model (LLM). The model used to generate a token's value may be the same as or different from the model used by the text generation module 120 to generate the generated text 122. Once the action processor 112 has obtained or generated the token's value, it may substitute the token with the resulting value.

As yet another example, certain tokens may be designated as having a “manual input” property, while other tokens may be designated as having an “automatic input” property. A single prompt may include both one or more “manual input” tokens and one or more “automatic input” tokens. When the action processor 112 encounters a token that has the manual input property in operation 210, the action processor 112 may elicit input from the user 102, such as by displaying a popup window or dialog box requesting a value for the token from the user 102. In response, the user 102 may provide input representing or otherwise specifying such a value in any manner (such as by typing, speaking, or selecting such a value from a list). The action processor 112 may then use the value received from the user 102 as the value for the token, or may derive a value for the token from the value received from the user 102, and may then use that value in any of the ways disclosed herein in connection with operation 210.

Assigning properties such as “manual input” and “automatic input” to tokens is merely one way to implement the system 100 and is not a limitation of the present invention. Alternatively, for example, the action processor 112 may, at the time of performing operation 210, ask the user 102 to indicate, for each token in the prompt to be provided to the language model, whether the value for that token should be obtained automatically by the action processor 112 or be input manually by the user 102, in response to which the action processor 112 may obtain each token value in accordance with the user's indications.

As yet another example, however the action processor 112 generates the prompt to be provided to the language model, including obtaining initial values for any tokens within that prompt, the action processor 112 may manifest the prompt to the user 102 via the user interface 104, thereby providing the user 102 with an overridable preview of that prompt, which is referred to herein as an “initial prompt.” The user 102 may then provide, via the user interface 104, any of a variety of input to revise the initial prompt and thereby generate a final prompt, such as by revising token values in the initial prompt and/or revising non-token text in the initial prompt. The action processor 112 may then provide the final prompt to the language model within operation 210.

Prompts of the various kinds disclosed herein may be created to perform a wide range of functions. Some particular, non-limiting examples of use cases for tokenized prompts include:
Rewrite Sentence as a Question:
   Tokenized Prompt: “Rewrite the following sentence as a question: {sentence}”
   Use Case: This is particularly useful when writers are framing research questions or looking to introduce more interactive or engaging language in their writing. It can help transform declarative statements into questions for effect.
Summarize Paragraph:
   Tokenized Prompt: “Summarize the following paragraph: {paragraph}”
   Use Case: Useful for condensing information, this prompt would benefit academic writers, journalists, or anyone who needs to distill long pieces of text into shorter versions without losing essential meaning.
Generate Title:
   Tokenized Prompt: “Create a title for the following blog post: {first_sentence_of_post}”
   Use Case: Bloggers or content creators could use this to come up with catchy, relevant titles for their articles based on the opening sentence or thesis.
Compare and Contrast:
   Tokenized Prompt: “Compare and contrast {entity1} with {entity2}”
   Use Case: Students writing essays or analysts preparing reports can use this prompt to generate comprehensive compare-and-contrast analyses. It could help structure arguments or evaluations in an organized manner.
Thesaurus Substitute:
   Tokenized Prompt: “Provide synonyms for the following word: {word}”
   Use Case: For any writer looking to diversify vocabulary in their text, this prompt can offer alternate word choices to replace repetitive or simplistic terms.
Generate Conclusion:
   Tokenized Prompt: “Based on the following arguments, generate a conclusion: {arguments_list}”
   Use Case: Academic writers or report writers who have outlined their primary points can use this to generate a compelling conclusion that ties all arguments together.
Elaborate Idea:
   Tokenized Prompt: “Elaborate on the following idea: {idea}”
   Use Case: Writers who have a basic concept or notion can use this prompt to flesh out more details, perspectives, or examples to better express and expand upon their initial thought.
Suggest Next Steps:
   Tokenized Prompt: “What are the next steps after {action}?”
   Use Case: Helpful in both project planning and narrative construction, this prompt can guide the writer through logical sequels or action points.

Some particular, non-limiting examples of use cases for tokenized prompts having multiple tokens include:
[symbol] Context-Aware Style Suggestions:
   Multi-Token Prompt: “Based on {genre} and {audience}, suggest an appropriate writing style.”
   Use Case: Writers who are creating a story that spans multiple genres or addresses multiple audiences may need nuanced advice on how to modulate their style. For example, a young adult sci-fi novel would have a different tone than an academic sci-fi analysis.
[symbol] Dialog Consistency Check:
   Multi-Token Prompt: “Check if character {character_name} in scene {scene_number} maintains a consistent tone and language.”
   Use Case: Consistency is key in storytelling. This prompt can help ensure that a character's dialogue remains consistent across different scenes, aiding in character development and narrative coherence.
[symbol] Revision Helper:
   Multi-Token Prompt: “Revise this {paragraph/sentence} to match a {formal/informal} tone, limit to {word_count} words, and incorporate {keyword}.”
   Use Case: This prompt can be a lifesaver during revisions, helping writers efficiently refine their text based on several constraints.
[symbol] Structured Brainstorming:
   Multi-Token Prompt: “Generate {x}ideas for plot points involving {character_name} in a {setting}.”
   Use Case: Writers often need to brainstorm multiple elements simultaneously. This prompt could help them generate plot points specifically focused on a character and a setting.
[symbol] Summary and Expansion:
   Multi-Token Prompt: “If the paragraph is shorter than {min_word_count}, expand it. If it's longer than {max_word_count}, summarize it.”
   Use Case: Different writing projects have different length requirements. This prompt helps writers lengthen or condense their work as needed.
[symbol] Visual Elements Incorporation
   Multi-Token Prompt: “Based on {theme} and {mood}, suggest some visual elements to include.”
   Use Case: Some writers like to incorporate visuals like pictures, graphs, or doodles. This prompt helps them identify what types of visual aids would best suit their work's theme and mood.

Some particular, non-limiting examples of uses of prompts that include conditional statements include:
Genre-Based Style Suggestions:
   Conditional Prompt: “If the genre is {genre}, suggest a writing style.”
   Use Case: This prompt would help writers adapt their language and tone to fit different genres, such as academic, fiction, or journalistic styles.
Audience-Based Language:
   Conditional Prompt: “If the audience is {audience_type}, adapt the following sentence: {sentence}”
   Use Case: Tailoring the language based on the audience (e.g., general public, experts, children) can help make the content more engaging and appropriate.
Length-Based Summary:
   Conditional Prompt: “If the paragraph is longer than {word_count}, summarize it.”
   Use Case: This prompt would automatically trigger a summary for longer paragraphs, aiding in brevity and readability.
Tense Correction:
   Conditional Prompt: “If the tense in the sentence is {tense}, correct it to {desired_tense}.”
   Use Case: Useful for writers who need to maintain consistent tense throughout their document, especially academic or formal writing.
Emotional Tone Suggestions:
   Conditional Prompt: “If the tone is {current_tone}, suggest a way to make it {desired_tone}.”
   Use Case: This can be especially useful for writers who need to adapt the emotional tone of their message, such as switching from a casual tone to a more formal one, or vice versa.
Verbosity Reduction:
   Conditional Prompt: “If the sentence has more than {word_count}words, simplify it.”
   Use Case: For academic or technical writers who may tend to be verbose, this prompt can help simplify sentences to improve readability.
Context-Based Character Actions:
   Conditional Prompt: “If the setting is {setting}, suggest an action for the character {character_name}.”
   Use Case: For fiction writers, this can help in generating context-appropriate actions or dialogues for characters, adding to story depth.
Citation Reminder:
   Conditional Prompt: “If a fact or statistic is mentioned, suggest adding a citation.”
   Use Case: Useful for academic and research writers to ensure that all factual statements are properly cited, maintaining the document's credibility.

Some particular, non-limiting examples of uses of prompts that include loops include the following. Some of these examples leverage the non-deterministic nature of at least some language models, which is expected to result in generating different outputs by applying the same language model multiple times to the same input. Although each example prompt below is phrased as a single, non-looped, statement, it should be assumed that a suitable prompt could be written with a loop syntax (e.g., using a “for” or “do while” construction, including a loop termination criterion) to form a prompt that defines a loop over the example prompt:
[symbol] Idea Generation Loop:
   Looped Prompt: “Generate a plot idea based on the genre {genre}.”
   Use Case: Writers often struggle with coming up with unique and engaging plot ideas. This looped prompt could generate multiple plot ideas within a specific genre, allowing the writer to choose the most compelling one.
[symbol] Dialogue Refinement Loop:
   Looped Prompt: “Improve this line of dialogue: {dialogue_line}.”
   Use Case: Dialogue can make or break a story. A looped prompt that iteratively refines dialogue could help writers achieve more natural and engaging exchanges between characters.
[symbol] Thesaurus Loop:
   Looped Prompt: “Find synonyms for the word {word}.”
   Use Case: When a writer overuses a particular word, it can make the work monotonous. This loop could provide a list of suitable synonyms for a repetitive word, enhancing the writer's vocabulary and the quality of the writing.
[symbol] Sentence Complexity Loop:
   Looped Prompt: “Rewrite this sentence to make it more complex: {sentence}.”
   Use Case: Some writing, such as academic papers, requires a more complex sentence structure. Looping this prompt can take a simple sentence and make it more nuanced, adding depth to the paper.
[symbol] Feedback Loop:
   Looped Prompt: “Provide constructive feedback on this paragraph: {paragraph}.”
   Use Case: Writers need to revise and improve constantly. A loop that provides ongoing feedback can give insights into the strengths and weaknesses of a piece, allowing for iterative improvements.

Some particular, non-limiting examples of uses of chained prompts include:
Research Assistant Chain:
   Chained Prompts:
      [symbol] “Search for articles related to {topic}.”
      [symbol] “Summarize the top 3 articles.”
      [symbol] “Provide citation formats for these articles in {citation_style}.”
   Use Case: This would be highly useful for academic writers or journalists who are required to back their points with credible sources. It automates the process from finding sources to summarizing them and even formatting citations.
Character Development Chain:
   Chained Prompts:
      [symbol] “Generate a basic character profile for {character_name}.”
      [symbol] “Suggest three key moments in the character's backstory.”
      [symbol] “Write a dialogue scene that reveals one of these key moments.”
   Use Case: Fiction writers could utilize this chain to create well-rounded characters and integrate them seamlessly into the narrative.
Editing and Refinement Chain:
   Chained Prompts:
      [symbol] “Identify passive voice in this {paragraph}.”
      [symbol] “Rewrite sentences in active voice.”
      [symbol] “Check for readability and suggest improvements.”
   Use Case: Many writers struggle with editing, particularly when it comes to style and readability. This chained prompt sequence could make the editing process more systematic and effective.
Blog Post Creation Chain:
   Chained Prompts:
      [symbol] “Generate a list of trending topics in {niche}.”
      [symbol] “Suggest 3 blog post titles for one chosen topic.”
      [symbol] “Create an outline for the chosen blog post.”
   Use Case: Bloggers or content marketers could use this chain to streamline the initial stages of content creation, from topic selection to outlining.
Screenplay Structuring Chain
   Chained Prompts:
      [symbol] “Break down the screenplay into three acts.”
      [symbol] “List key scenes for each act.”
      [symbol] “Outline a dialogue sequence for one key scene.”
   Use Case: Screenwriters often have to balance complex narratives within the confines of screenplay structure. This chain could guide them through the process, ensuring that key elements are included in each act.

Some particular, non-limiting examples of use cases for scripted prompts include:
[symbol] Automated Formatting:
   Scenario: A writer is preparing a technical manual with specific formatting requirements.
   Scripting Use: A script could auto-format the document by adjusting headings, inserting table of contents, organizing footnotes, or managing citations, all based on the writer's predefined or selected specifications.
[symbol] Data Integration & Visualization:
   Scenario: A writer is composing a market research report and wants to integrate live financial data.
   Scripting Use: A script could fetch live market data and integrate it into the document, potentially even producing charts or graphs on the fly.
[symbol] Content Personalization:
   Scenario: A content creator wants to send personalized emails or newsletters to their subscribers.
   Scripting Use: A script could adjust the content based on subscriber information, personalizing greetings, recommendations, or other content pieces.
[symbol] Language Translation:
   Scenario: A novelist wants to provide a sample translation of their work for international publishers.
   Scripting Use: With integration to a translation API, a script could auto-translate sections or the entirety of the document to a selected language.
[symbol] Automated Summary and Metadata Generation:
   Scenario: A researcher is uploading several of their papers to a repository and needs summaries and metadata for each.
   Scripting Use: A script could auto-generate concise summaries, keyword lists, or other metadata based on the content of each paper.
[symbol] Interactive Elements for Digital Publishing:
   Scenario: A writer is creating an interactive e-book or digital guide.
   Scripting Use: Scripts could embed interactive elements like quizzes, animations, or clickable maps directly within the document.
[symbol] Document Security:
   Scenario: A business professional is preparing a sensitive report and wants to ensure it's encrypted or watermarked.
   Scripting Use: The app could execute a script that encrypts the document, adds a watermark, or integrates other security measures.
[symbol] Document Analytics:
   Scenario: A writer wants insights into how readers engage with their digital document.
   Scripting Use: Embedded scripts can track reading time, most engaged sections, or even feedback submissions from readers.
[symbol] Real-time Collaboration Tools:
   Scenario: Multiple authors are collaborating on a shared document.
   Scripting Use: A script could highlight recent changes, show who is currently viewing or editing the document, or even enable a chat feature within the app.
[symbol] Grammar & Style Enhancement:
   Scenario: A writer is looking for advanced grammar and style checks beyond the basic ones.
   Scripting Use: Integration with advanced linguistic tools or APIs could provide deeper insights, suggestions, and corrections.

Some particular, non-limiting examples of uses of scripted prompts include:
Character Development Script:
   Scripted Prompt: “If {character_age} is less than 18, suggest ‘childhood trauma’. Else, suggest ‘adult experiences’.”
   Use Case: This script could help writers deepen their character development by providing age-appropriate backstory ideas.
Setting Generation Script:
   Scripted Prompt: “If {genre} is ‘fantasy’, generate a medieval setting. If {genre} is ‘sci-fi’, generate a futuristic city.”
   Use Case: This can help writers quickly generate settings that are appropriate to their story's genre, saving time on research and brainstorming.
Conflict Resolution Script:
   Scripted Prompt: “If {conflict_type} is ‘man vs man’, suggest a duel. If {conflict_type} is ‘man vs nature’, suggest a natural disaster.”
   Use Case: Determining how a conflict resolves in a story can be challenging. This script provides suggestions based on the type of conflict, helping to move the story forward.
Emotional Arc Script:
   Scripted Prompt: “If {character_emotion} starts at ‘happy’, chart an arc that leads to ‘sadness’, then ‘redemption’.”
   Use Case: Emotional arcs are crucial for engaging readers. This script could help plan out a character's emotional journey throughout a story.
Editing and Proofreading Script:
   Scripted Prompt: “Scan {text} for common grammar mistakes. If found, suggest corrections.”
   Use Case: This can be a final check for writers to ensure their work is grammatically sound before publishing or submission.

The action definition library 106 may or may not be fixed. The system 100 may, for example, enable the user 102 to add, modify, and/or delete action definitions 108a-n within the action definition library 106 in any of a variety of ways.

For example, in the case of simple text prompts, the system 100 may enable the user 102 to add, modify, and delete one or more of the action definitions 108a-n by, for example, using a text editor-style interface to add, modify, and delete the text of such prompts and associated metadata, such as descriptions and short names of such prompts. Once the user 102 has added or modified one of the action definitions 108a-n, such an action definition may be used by the system 100 in any of the ways disclosed herein.

The system 100 may enable the user 102 to add, modify, and delete tokenized prompts within the action definition library 106 in any of the ways disclosed herein in connection with simplified text prompts. In addition, the system 100 may facilitate adding, modifying, and deleting tokens within tokenized prompts in the action definition library 106 in any of a variety of ways, such as in any manner that is known from systems for performing such functions using tokens, e.g., in software Integrated Development Environments (IDEs) and source code editors. Merely as one example, the system 100 may manifest to the user 102 a list of available tokens and enable the user 102 to select any of those tokens for inclusion in the action definition currently being edited by the user 102, in response to which the system 100 may insert the selected token into that action definition, e.g., at the current cursor location/insertion point within that action definition. As another example, the system 100 may provide an auto-complete feature that manifests suggested auto-completions for tokens to the user 102 as the user 102 is editing an action definition, in response to which the user 102 may accept an auto-completion by performing a particular action (e.g., hitting the Tab or Enter key), in response to which the system 100 may insert the accepted token into the action definition at the current cursor location/insertion point within that action definition. As the definition of tokenized prompts implies, the prompt editor may enable the user 102 to insert a token at any position within a prompt, such as immediately before non-tokenized (e.g., plain) text and/or immediately after non-tokenized (e.g., plain) text.

The system 100 may enable the user 102 to add, modify, and delete compound prompts (e.g., chained prompts and/or alternative take prompts) within the action definition library 106 in any of the ways disclosed herein in connection with simplified text prompts and tokenized prompts. In addition, the system 100 may facilitate adding, modifying, and deleting compound prompts in any of a variety of ways. For example, the action definition of a compound prompt may include both the compound prompt's component prompts and metadata/settings that define how the compound prompt will be executed in operation 210, and the system 100 may enable the user 102 to add, modify, and delete both the compound prompt's component prompts and such metadata/settings. Some examples of user interface elements that the system 100 may implement to facilitate editing of compound prompts include the following:
[symbol] Visual Flow Diagrams: The system 100 may use flow diagrams or visual nodes to represent the compound prompt structure. Chained prompts may be visualized as linked nodes in a linear manner, while alternative take prompts may branch out from a common node.
[symbol] Toggle Modes: When creating or editing a compound prompt, the system 100 may enable the user 102 to toggle between “Chaining Mode” and “Alternative Take Mode,” which will adjust the UI to guide the user 102 in setting up the compound prompt's component prompts according to the user's preferred execution style.
[symbol] Drag and Drop Interactivity: The system 100 may enable the user 102 to craft compound prompts by dragging individual component prompts into a workspace. Depending on the arrangement or connectors used, the system 100 may recognize the desired execution style.
[symbol] Descriptive Tooltips: Hovering over a compound prompt in the action definition library 106 may cause the system 100 to show tooltips or brief descriptions of the compound prompt's behavior, making it clear to the user 102 whether the prompt is set up for chaining, alternative takes, or both.

The system 100 may enable the user 102 to add, modify, and delete scripted prompts within the action definition library 106 in any of the ways disclosed herein in connection with simple text prompts, tokenized prompts, and compound prompts. In addition, the system 100 may facilitate adding, modifying, and deleting scripted prompts in any of a variety of ways. For example, the system 100 may provide the user 102 with a script editor having any of the features of a conventional script editor, source code editor, and/or IDE, in combination with any of the features disclosed above in connection with simplified text prompts, tokenized prompts, and compound prompts, to add, modify, and delete action definitions 108a-n in the action definition library 106.

Such scripts may be written using an existing scripting language, using a custom-designed scripting language, or any combination thereof. Non-limiting examples of such languages include JavaScript, Python, Ruby, Lua, TypeScript, Bash, Perl, and PowerShell. The term “scripting language” is used broadly herein to include both languages that are commonly referred to as “scripting languages” and languages that are commonly referred to as “programming languages.” Such a scripting language may, for example, include the use of variables and other data structures, function definitions and function calls, conditional statements, loops, and any other constructs known within scripting languages.

The system 100 may enable the user 102 to utilize the prompt editor feature to add, edit, or delete action definitions at any time relative to the performance of other actions disclosed herein. This flexibility enables a dynamic and iterative process of creating, applying, and refining action definitions.

For example, the user 102 may use the prompt editor to create a new action definition and then, at a later time, apply the created action definition to selected text using the techniques disclosed herein. Subsequently, the user 102 may return to the prompt editor to revise the previously created action definition. At a later time, the user 102 may apply this revised action definition to other selected text within the same document or a different document.

The user 102 is not limited to applying only the action definitions they have personally created or edited. The user 102 may select and apply any action definition available in the action definition library 106 to selected text, regardless of whether the user 102 created that particular action definition.

Furthermore, the system 100 may enable the user 102 to manually edit the text of the selected document 114 at any time, providing complete flexibility in the document creation and revision process. For example, the user 102 may manually edit the text of the selected document 114 before creating or editing an action definition, after creating or editing an action definition, before applying an action definition to the selected text 116, and/or after applying an action definition to the selected text 116. This flexibility allows the user 102 to seamlessly integrate manual editing with the automated assistance provided by the action definitions 108a-n, creating a highly customizable and efficient document revision process.

Although not shown in FIG. 1, the system 100 may store and use any of a variety of settings that may be used within the system 100 and method 200. Furthermore, system 100 may manifest any such settings to the user 102 via the user interface 104 and enable the user 102 to modify any such settings by providing input to the system 100 via the user interface 104, in response to which the system 100 may modify the settings as indicated by the user 102. Some examples of such settings include:
Language model Parameters Configuration: The user 102 may modify settings related to one or more language models used by the system 100. This may include, for example, settings such as the language model's response length, temperature (which affects the randomness of the model's responses), and other parameters that influence the behavior and output of the language model.
Chat Context Selection: The user 102 may have the option to determine how context is managed during interactions with the language model, such as:
   No History: Every prompt is executed without any prior chat history. This ensures each interaction is standalone and not influenced by prior inputs.
   Ongoing History: An ongoing chat context is maintained. This means that consecutive prompt executions can be influenced by previous interactions, allowing for more context-aware responses from the language model.
Prompt Contextualization: The user 102 may configure how prompts are enriched with context during execution:
   Prompt & Selected Text: The language model executes prompts based solely on the content of the prompt itself and any text selected by the user.
   Additional Context: Users may add further context to prompts, either by incorporating more portions of the document or by including text from other sources. This may include, for example, any one or more of the following:
      [symbol] Manually provided context by the user.
      [symbol] Context from external data 128, such as one or more databases, files, or web resources.

Some embodiments of the present invention include features related to “track changes” and commenting features found in word processors and text editors. Such features are collectively referred to herein as the “generative track changes” feature, merely for ease of reference and without limitation. In general, by applying one or more of the system 100's action definitions, text generation, and context-aware processing to tracked changes and comments, the track changes feature transforms the typically passive and cumbersome revision process into an intelligent, automated workflow. For example, the system 100 may analyze comment threads, suggest and implement improvements to tracked changes, and/or provide automated explanations of modifications while maintaining document coherence and quality. This approach significantly reduces the cognitive burden on users while preserving their control over the revision process, enabling more efficient and effective document collaboration.

The system 100 may enable automated analysis and implementation of comment threads. For example, when processing one or more comments within a document, the action processor 112 may identify one or more applicable action definitions based on the comment content and context. The text generation module 120 may then apply the identified action definition(s) to generate one or more specific revision suggestions that address the intent of the comments while maintaining document coherence.

For example, the system 100 may analyze a comment thread within a document to identify one or more appropriate revisions for implementing the comment(s) in the comment thread. For example, when processing a comment thread containing one or more comments from one or more users, the action processor 112 may provide a specialized prompt to a language model to identify specific revisions that should be made. For example, the prompt may instruct the language model to analyze the comment thread and identify one or more appropriate modifications to the associated document content.

Based on the output of the language model, the system 100 may identify one or more applicable action definitions from the action definition library 106 that may be used to implement the identified revision(s). The text generation module 120 may then apply the identified action definition(s) to the document text associated with the comment thread using any of the processing techniques disclosed herein.

For each comment or comment thread, the system 100 may analyze the surrounding document context to identify (e.g., generate) one or more appropriate transformations. This context-aware processing ensures that generated revisions integrate seamlessly with existing content while preserving document structure and formatting. The system 100 may process multiple document elements simultaneously, enabling efficient handling of complex comment threads that span different sections.

The system 100 may support both automated and interactive refinement paths, enabling users to review generated changes before implementation. Through real-time preview capabilities and/or side-by-side comparisons, users can evaluate potential improvements and make informed decisions about content updates. When a user approves a suggestion, the document update module 124 may implement the refined change(s) while preserving document coherence and quality. This approach combines the efficiency of automated content generation with the control of manual oversight.

The system 100 may leverage any of the external data 128 to enhance comment analysis and revision generation. Using a distributed processing architecture, computationally intensive operations may be performed on dedicated servers while maintaining responsive performance. The state-based revision management approach enables efficient tracking of suggested changes while preserving the original document content.

The system 100 may provide capabilities for refining tracked changes through its text generation and processing architecture. When processing tracked changes within a document, the text generation module 120 may apply a selected action definition to improve the integration and quality of modifications. This may enable complex transformations while preserving document structure, formatting, and overall coherence.

The action processor 112 may support multi-stage refinement of tracked changes through sequential processing steps. Initial transformations may be further enhanced through subsequent action definitions, enabling compound improvements that build upon previous refinements. This sequential approach allows for sophisticated content transformations while maintaining precise control over document updates.

The system 100 may enable automated generation of explanations for tracked changes through its text generation capabilities. For example, the text generation module 120 may apply selected action definitions to analyze modifications and generate clear explanations that provide context for the changes. This automated documentation helps users understand the rationale and impact of tracked changes while maintaining document coherence.

When processing tracked changes, the system 100 may consider document-wide context and relationships between different content elements. The action processor 112 may analyze both the modified content and surrounding document context (e.g., one or more surrounding words, paragraphs, and/or sections) to generate contextually appropriate explanations. This context-aware processing ensures that generated explanations accurately reflect how changes integrate with and affect the broader document.

The system 100 may support flexible explanation generation through both automated and interactive workflows. For example, the system 100 may enable the user 102 to review generated explanations and request refinements through the user interface 104. Through state-based revision management, the system 100 may maintain clear relationships between tracked changes and their corresponding explanations.

Embodiments of the present invention have a variety of advantages, such as the following.

In the traditional writing process, every thought is developed and every word is written manually by the writer. This process, while deeply personal, can be slow and often lead to writer's block. Embodiments of the present invention preserve the essence and benefits of manual writing while bypassing the occasional blockades. Embodiments of the present invention use the action definition library 106 (e.g., language model prompts) for brainstorming, refining, and elaborating on the writer's text without replacing the human touch.

Although certain AI-based writing tools exist, such as those that use LLMs to draft entire documents, the resultant piece may not fully capture the writer's voice or intent. Post-creation, the writer often must manually revise word-by-word, which can be cumbersome. In contrast, instead of a one-size-fits-all approach, embodiments of the present invention enable the writer to seamlessly blend his or her own words with AI-generated content. The writer is empowered to decide where to obtain assistance from the system 100 and to what extent, ensuring the final piece resonates with the writer's unique voice.

Although chatbot-based AI tools, such as ChatGPT, may be used to assist writers in generating written works, such tools are useful primarily for creating an entire draft of such works. If the writer then wants to revise a chatbot-generated work, the writer must either revise the entire work manually, or request that the chatbot generate an entire new draft of the work. Chatbots do not, in other words, facilitate editing of works. In contrast, embodiments of the present invention provide writers with granular control over the revision process, enabling them to modify specific sections without overhauling the entire piece, allowing for efficient iterations that take maximum advantage of language models and other computer automation, while preserving the core of the writer's content. In this way, embodiments of the present invention combine the best of computer-automated writing with manual human writing.

Although some LLM-based writing apps, such as Jasper, provide limited features that enable writers to leverage LLMs to revise a draft document, such apps are limited to providing a fixed set of opaque revision commands, such as “summarize,” “shorten,” “lengthen,” and “rephrase.” Such apps do not enable the user to see how such commands operate, to modify those commands, or to add commands of their own. In contrast, embodiments of the present invention enable users to customize prompts to reflect the writer's own writing preferences and style.

In short, embodiments of the present invention do not dictate the writer's writing process. Instead, they collaborate with the writer, enabling the writer to write, refine, expand, and restructure documents using whatever mixture of human writing and computer-automated writing and revising the writer prefers, including computer-automated writing and revising defined by the writer.

Although the advantages mentioned above focus primarily on the benefits to the writer, embodiments of the present invention also include a variety of technical innovations that have a variety of technical benefits. For example, embodiments of the present invention are able to merge user-selected text (e.g., the selected text 116) with pre-defined action definitions 108a-n (e.g., prompts), which represents a particular way of implementing prompt optimization that represents a technical advancement over existing techniques for generating prompts that do not incorporate user-selected text. Furthermore, by enabling the user 102 to create and modify action definitions (e.g., prompts) in the action definition library 106, to store those action definitions for future use, and to select those stored action definitions for use in connection with the user-selected text 116, embodiments of the present invention enable the generated text 122 to be generated more efficiently than existing solutions that do not enable pre-stored components of a prompt to be selected (e.g., without typing them manually) and then combined with user-selected text (e.g., without requiring such text to be typed manually).

The ability of embodiments of the present invention to enable the user 102 to select multiple non-contiguous selections of text within the selected document 114 provides a variety of advantages. For example, embodiments of the present invention may apply a multi-token prompt to such multi-selections to generate a combined prompt that is based on some or all of the multiple selections. This enables embodiments of the present invention to generate prompts and to perform operations, e.g., using language models (e.g., LLMs), that would either not be possible using existing systems, or that could not be performed as efficiently using existing systems. For example, by enabling multiple non-contiguous text selections to be used to generate the generated text 122 (e.g., by generating a single prompt that incorporates all of the multiple non-contiguous text selections), embodiments of the present invention allow for more intricate interactions with a language model than existing systems by facilitating compound queries or task to be performed using the multiple non-contiguous text selections, such as comparing, contrasting, or merging the multiple non-contiguous text selections and/or concepts represented by those multiple non-contiguous text selections. In contrast, systems that are limited to using contiguous text selections are limited to performing simpler operations on the selected text only, such as rephrasing, summarizing, or expanding the selected text.

As another example, by enabling the user 102 to select multiple non-contiguous text blocks, the system 100 enables richer context to be provided to a language model, thereby enabling the language model to generate more informed and nuanced outputs. In contrast, operations performed on single contiguous text selections tend to lack such broader context, thereby leading to outputs that may not fully capture the intended essence.

As yet another example, by enabling the user 102 to select multiple non-contiguous text blocks, the system 100 may execute complex tasks in a single step (e.g., by providing a single prompt to a language model to generate a single output), rather than performing multiple steps (e.g., by sequentially providing multiple prompts to the language model to generate multiple outputs). As a result, embodiments of the present invention provide an increase in processing efficiency compared to systems that can only be applied to single contiguous text selections.

The ability of embodiments of the present invention to generate, store, modify, and execute compound prompts (e.g., chained prompts and/or alternative take prompts) provides a variety of advantages. For example, the ability to execute compound prompts (e.g., to provide a compound prompt as an input to a language model to generate the generated text 122) enables the system 100 to perform multi-stage content processing. For instance, using a chained prompt, the system 100 may first simplify a complex paragraph (using Component Prompt A in a chained prompt) and then summarize the simplified version (with Component Prompt B in the chained prompt), thereby ensuring the essence is captured in a concise manner. Because the system 100 may execute both component prompts of the chained prompted automatically in sequence, the system 100 enables such sequential processing to be performed more efficiently and effectively than systems that require the user 102 to manually instruct such systems to execute each such component prompt manually.

The ability to apply multiple component prompts within an alternative take compound prompt to generate alternative outputs from the same text selection provides a variety of benefits. For writers, this ability may assist in content brainstorming, assisting in decision-making about plot development, evaluation of multiple hypotheses, and crafting a message for multiple audiences. This feature also provides technical benefits, such as providing the ability to generate a larger amount of text based on the same input as conventional systems that lack the ability to process alternative take prompts automatically.

Yet another technical feature of embodiments of the present invention is that it may be implemented using an event-based design that can perform any of a variety of functions disclosed herein at any time, particularly in response to input received from the user 102 via the user interface 104 at any time. For example, the user 102 may provide first input via the user interface 104 (e.g., input which selects a first instance of the selected action definition 118 and a first instance of the selected text 116), in response to which the action processor 112 may execute a first instance of the method 200 to generate a first instance of the generated text 122. At any subsequent time, the user 102 may provide second input via the user interface 104 (e.g., input which selects a second instance of the selected action definition 118 and a second instance of the selected text 116), in response to which the action processor 112 may execute a second instance of the method 200 to generate a second instance of the generated text 122. Even within such scenarios, the system 100 may receive individual inputs from the user 102, such as inputs selecting the first instance of the selected action definition 118 and the first instance of the selected text 116, at any time, and take action in response to such inputs whenever they are received.

Such event-based processing may be implemented, for example, using object-oriented programming (OOP) techniques in connection with a GUI. As is well-known, the rise of GUIs in the history of software development represented a significant shift in software design paradigms. Earlier software, designed for terminal-style interfaces, operated in a more linear fashion, waiting for a single text-based input from the user. However, the advent of GUIs introduced a far more interactive and dynamic user experience, where multiple types of inputs could be triggered at any time. Event-based OOP emerged as an effective way to design software that could respond flexibly to these multi-faceted, asynchronous user inputs.

Today's chatbot-based writing tools, and writing tools which first receive input from a user and then produce a draft based on the user's input, have the limitations of the terminal-style interfaces of previous generations of software. In contrast, embodiments of the present invention may replace such limitations with the benefits of software that uses an OOP-based GUI, and apply such benefits to the context and generating and editing text. In particular, embodiments of the present invention may respond flexibly to multi-faceted, asynchronous inputs from the user 102.

For example, in an event-based OOP design, and in embodiments of the present invention, actions such as selecting text or choosing a prompt may be treated as events. When these events occur, specific event handlers may be triggered to execute corresponding actions, such as invoking a language model to apply a prompt. This architecture allows for real-time, dynamic interaction between the user 102 and the system 100. Given that the writing process preferred by most human writers is not linear, an event-based design allows the user 102 to make asynchronous revisions to the selected document 114. This enables the user 102 to be free to edit any part of the selected document 114 at any time, in any order, according to their creative flow.

As the above explanation illustrates, embodiments of the present invention differ from existing software applications for providing writing assistance by facilitating the process of revising the selected document 114 based on both human input and computer-generated output, rather than focusing only on the process of generating an initial draft of the selected document 114 automatically. In particular, by enabling the user 102 to apply user-definable action definitions (e.g., prompts) to user-selectable text within the selected document 114, while also enabling the user 102 to manually edit the selected document 114, and to flexibly intersperse such automatic user-configurable revisions with manual edits, embodiments of the present invention provide the user 102 with a combination of the power of computer-automated text generation and revision with the control of manual user text generation and revision, all where and when specified by the user 102, at any level of granularity within the selected document 114.

For example, consider a sequence of events in which:
[symbol] the user 102 manually writes an initial draft of the selected document 114;
[symbol] the user 102 then selects a first sentence within the selected document 114 as a first instance of the selected text 116 and applies a first one of the action definitions 108a-n to the first sentence to generate a first instance of the generated text 122, in response to which the document update module 124 replaces the first sentence with the first instance of the generated text 122 in the selected document 114;
[symbol] the user 102 then manually adds a new paragraph to the selected document 114;
[symbol] the user 102 then selects a second sentence within the selected document 114 (e.g., within the manually-added new paragraph) as a second instance of the selected text 116 and applies a second one of the action definitions 108a-n to the second sentence to generate a second instance of the generated text 122, in response to which the document update module 124 replaces the second sentence with the second instance of the generated text 122 in the selected document 114; and
[symbol] the user 102 then manually revises the second instance of the generated text 122 in the selected document 114.

As the above example illustrates, the user 102 may use embodiments of the system 100 to flexibly add and revise text manually in the selected document 114 and to apply selected (and user-configurable) action definitions from the action definition library 106 to arbitrarily-selected text within the selected document 114, in any sequence and combination, including interspersing manual additions/revisions to the selected document 114 with automatic additions/revisions to the selected document 114 in any combination. This enables the user 102 to take maximum advantage of the benefits of the action processor 112's ability to generate and revise text automatically within the selected document 114, without sacrificing any ability to manually add to and revise text within the selected document 114, and without limiting the use of the action processor 112 merely to generating entire new drafts of the selected document 114 or to performing predefined and non-user-configurable actions on selected text within the selected document 114.

Most efforts on improving the ability of language models, especially LLMs, to assist in the writing process, both in academia and in commercial products, focus on achieving improvements in prompt engineering for the purpose of developing individual prompts that are better able to generate an entire draft of a document. The premise of such efforts is that the goal is to achieve a single prompt that can be used to assist a writer in producing an entire draft of a document. Such efforts fail to recognize both that many writers, especially professional writers of long-form content, prefer or require a writing process that includes making multiple revisions of the document being written, not a single draft produced from whole cloth. Furthermore, it is not even known whether it will be possible to produce written documents that are desired and needed by both writers and audiences solely through improvements in prompt engineering. What is known is that, based on the current state of the art in prompt engineering, the best output currently generated using individual prompts often lack depth, context, and the nuance required in advanced or professional writing tasks, especially when long-form content is needed. Furthermore, the content produced using the current best prompts lack the writer's unique voice, which can only be achieved by the writer manually editing the output generating using such prompts.

Furthermore, writers, especially those engaged in long-term projects like novels and screenplays, often do not have a fully formed set of their own goals at the outset. This makes it impossible to encapsulate all of the writer's requirements in a single prompt. The writing process itself is iterative and the writer's goals may change or become clearer as the draft progresses. A writer may only recognize what needs to be revised or what their true goals are after writing or seeing a draft. A single prompt approach does not offer the flexibility to adapt to these post-draft realizations, making a solely prompt-driven writing process too rigid for the needs of the professional or otherwise sophisticated writer. For this and other reasons, professional writers value and require the ability to revise small portions of their work, making a tool that offers nuanced editing features more aligned with their needs. This contrasts sharply with a model where all the goals have to be stated up front.

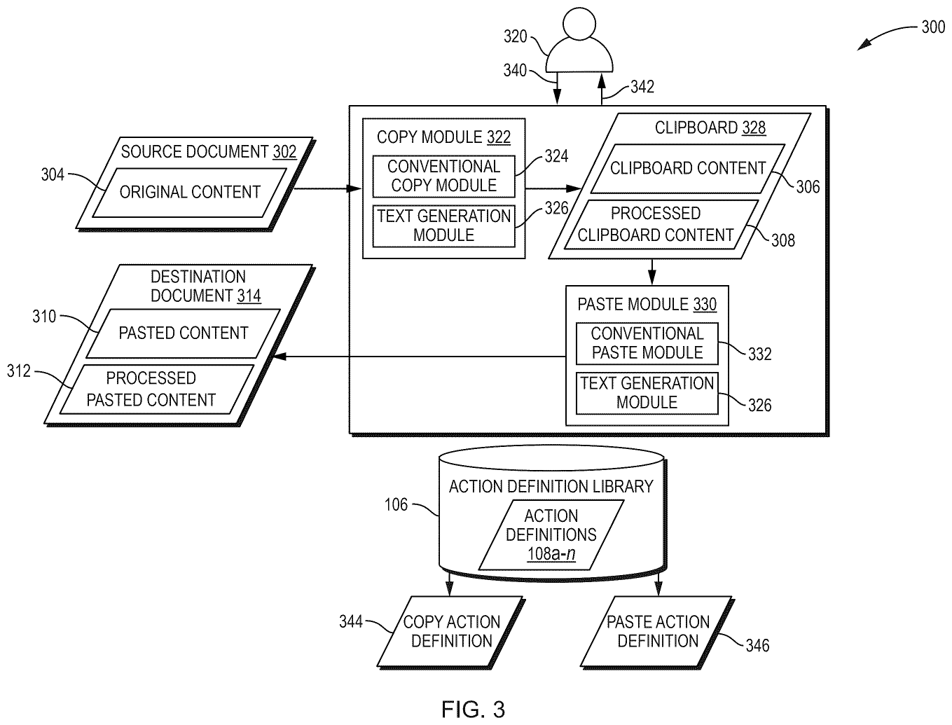

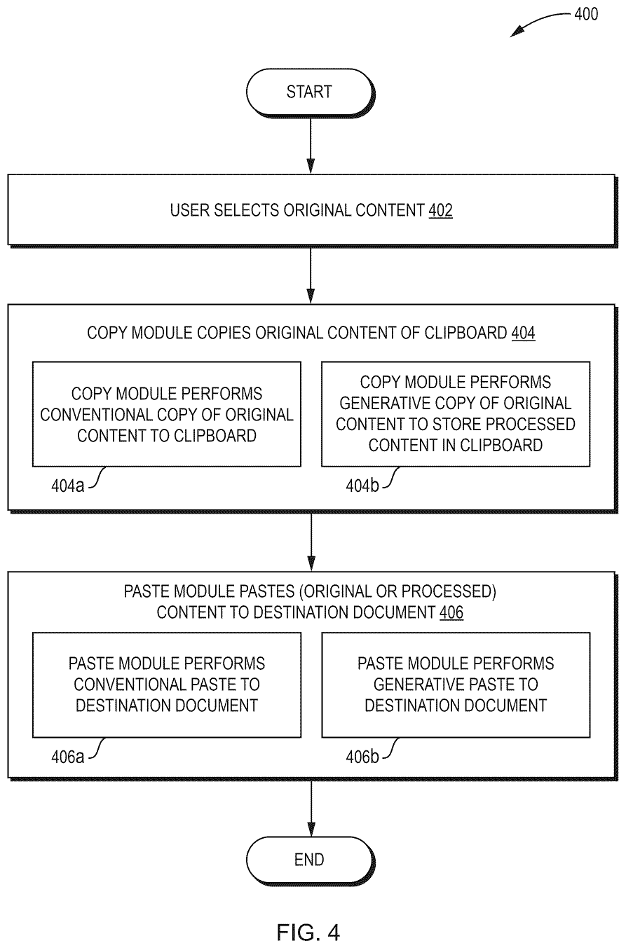

In addition to the document revision capabilities described above, embodiments of the present invention also include a novel “generative cut and paste” feature. This feature extends the power of generative AI to standard clipboard operations, further enhancing the writing and editing process. Referring to FIG. 3, a dataflow diagram is shown of a system 300 for implementing the generative cut and paste feature according to one embodiment of the present invention. Referring to FIG. 4, a flowchart is shown of a method 400 performed by the system 300 of FIG. 3 according to one embodiment of the present invention. The system 300 and method 400 may, for example, be used in connection with the system 100 of FIG. 1 and the method 200 of FIG. 2 to extend the capabilities of that system 100 and method 200 to include generative AI processing during clipboard operations, further enhancing the writing and editing process.

The generative cut and paste feature may operate in either of both of two primary modes:
Generative Copy: When content (e.g., text) is copied from a document or any other source, the system 300 applies generative AI to the copied content, producing processed copied content. This processed content is then stored in the clipboard, either replacing or supplementing the original copied content.
Generative Paste: When content is pasted from the clipboard (whether that content is original content or previously processed content), the system 300 applies generative AI to the pasted content, producing processed pasted content. This processed content is then inserted into the target document, either replacing or supplementing the original clipboard content.

The generative cut and paste feature may leverage the same action definition framework described earlier herein. Any action definition, such as simple text prompts, tokenized prompts, alternative take prompts, chained prompts, and/or scripted prompts, may be applied to process copied or pasted content. This integration allows for a seamless extension of the system 100's capabilities to copy and paste operations, enabling a wide range of content transformations and enhancements during these common document editing tasks.

For the purposes of the disclosure herein, the term “copying” is used to encompass both the actions of copying and cutting content. Copying refers to the process of duplicating selected content and storing it in the clipboard without removing it from its original location. Cutting, on the other hand, involves removing the selected content from its original location and storing it in the clipboard. To streamline the description and avoid repetition, whenever “copying” is mentioned in the context of the generative cut and paste feature, it should be understood to encompass copying and/or cutting operations. This convention allows for a more concise explanation of the feature while covering both content duplication methods.

The system 300 for implementing the generative cut and paste feature comprises several elements that represent the content at various stages of the process:
[symbol] Source Document 302: The document or source from which content is initially copied.
[symbol] Original Content 304: The specific content that is copied from the source document 302.
[symbol] Clipboard Content 306: The content as it is stored in the clipboard before any processing using an action definition occurs.
[symbol] Processed Clipboard Content 308: The content after it has undergone processing by an action definition and is stored in the clipboard.
[symbol] Pasted Content 310: The content after it has been pasted from the clipboard but before any action definition processing has been applied.
[symbol] Processed Pasted Content 312: The content after it has been pasted from the clipboard and subsequently processed using an action definition.
[symbol] Destination Document 314: The document or location where the pasted content is ultimately inserted.

The terms “source document” 302 and “destination document” 314 encompass any source or destination for content, including documents, text fields, web pages, databases, or any other medium from which content can be copied or into which content can be pasted.

The system 300 and method 400 may apply any kind of action definition disclosed herein to content, whether or not such action definition uses generative AI. For example, scripted prompt action definitions may apply formatting rules and data transformations using techniques other than generative AI.

Processing described as applied to original content 304 during copy operations may equally be applied to clipboard content 306 or processed clipboard content 308 during paste operations, and vice versa.

The system 300 may: (1) apply action definitions during copy to produce processed clipboard content 308, then paste conventionally; (2) copy conventionally to produce clipboard content 306, then apply action definitions during paste; or (3) apply a first action definition during copy and a second action definition during paste for multi-stage processing.

The system 300 includes a user 320 that may be a human user, software program, device, or combination thereof. The source document 302 contains original content 304, which may be selected by the user 320 for copying. Multiple instances of original content 304 may be processed with different action definitions.

Embodiments may implement components directly for full control, or use pre-existing operating system components for conventional operations while implementing novel features on top. This hybrid approach enables adaptation to various environments including standalone applications, plugins, cloud services, and mobile apps.

The system 300 may interact with operating system clipboard functionality through clipboard APIs, event listeners, custom clipboard formats, inter-process communication, or system hooks to enhance conventional cut-and-paste operations with generative capabilities while maintaining compatibility.

Although only certain aspects of the system 300 of FIG. 3 and the method of FIG. 4 are disclosed herein, additional details may be found in U.S. patent application Ser. No. 19/054,800, filed on Feb. 15, 2025, entitled, “Computer-Implemented Methods and Systems for Generative Text Painting,” which is hereby incorporated by reference herein.

Referring now to FIG. 4, in operation 402, the user 320 selects the original content 304 within the source document 302. This operation defines the scope of content for subsequent generative AI operations and transformations.

Operation 402 may be implemented through various methods including mouse selection by clicking and dragging across desired text, keyboard shortcuts such as Ctrl+A or Shift+Arrow keys, touch gestures on touch-enabled devices, voice commands in systems with voice recognition, and/or programmatic selection through API calls or scripted commands. The system 300 registers the selection and may provide visual feedback through highlighting or other visual cues. The system 300 may also support selecting content from multiple documents or non-document sources such as web pages.

The method 400 includes a copy operation 404 with conventional copy sub-operation 404a creating clipboard content 306 and generative copy sub-operation 404b creating processed clipboard content 308. The system 300 may select between sub-operations based on user preferences, system settings, or contextual factors, either through explicit user choice, automatic system determination, or hybrid approaches performing both operations simultaneously. The system 300 may support only conventional copy operations while providing generative capabilities during paste operations, offering workflow compatibility, improved performance, and flexibility for applying generative processing at paste time.

The copy operation 404 may be triggered by input 340 from the user 320, such as keyboard shortcuts (Ctrl+C, Cmd+C), menu selection, toolbar buttons, touch gestures, or voice commands. The user 320 may provide a single input that both selects the original content 304 and triggers the copy operation 404, such as through double-click and drag, touch-based selection, voice commands with content specification, or smart selection features. The system 300 recognizes these input types and initiates either the conventional copy operation 404a or the generative copy operation 404b based on user preferences or system settings.

As part of performing the generative copy operation 404b, the system 300 selects a copy action definition 344 to apply to the original content 304 to produce the processed clipboard content. The system 300 may select the copy action definition 344 from the action definitions 108a-n in the action definition library 106 or from any other suitable source of action definitions. The system 300 may select the copy action definition 344 through user selection via menus, default configurations based on content type, context-aware selection based on content analysis, keyboard shortcuts, or programmatic selection through API calls.

The copy module 322 includes a conventional copy module 324 that produces clipboard content 306 and a text generation module 326 that applies the copy action definition 344 to generate processed clipboard content 308. The clipboard 328 stores both the original clipboard content 306 and the processed clipboard content 308, enabling users to select between versions during paste operations.

The paste operation 406 includes conventional paste operation 406a and generative paste operation 406b. Operation 406a inserts clipboard content into the destination document 314 without modification. Operation 406b applies an action definition to clipboard content to generate processed pasted content 312 using generative AI capabilities. The system 300 may select between operations 406a and 406b based on user preferences or system settings, maintaining compatibility with existing workflows while providing enhanced generative functionality. In some embodiments, the system 300 implements only generative copy operation 404b with conventional paste operation 406a, providing generative processing during copy while ensuring predictable paste behavior.

As part of performing the generative paste operation 406b, the system 300 may select a paste action definition 346 from the action definitions 108a-n in the action definition library 106 to apply to the clipboard content 306 or processed clipboard content 308 to produce the processed pasted content 312.

The system 300 may select the paste action definition 346 through user selection from interface menus, application of pre-configured default definitions, context-aware automatic selection based on content type or target document, keyboard shortcuts, or sequential application of multiple action definitions. The system 300 may determine whether to use the clipboard content 306 or the processed clipboard content 308 as input for the generative paste operation 406b, and may offer options to preview the results of applying different paste action definitions before finalizing the paste operation.

The paste module 330 includes a conventional paste module 332 for standard paste operations and the text generation module 326 for generative paste operations. The conventional paste module 332 inserts clipboard content into the destination document 314 as pasted content 310 without modification. The text generation module 326 applies the paste action definition 346 to clipboard content to generate processed pasted content 312. The paste action definition 346 may be selected by the user or determined automatically based on context.

The paste operation 406 may be triggered by input 340 from the user 320, such as keyboard shortcuts, menu selection, or voice commands. The user 320 may provide a single input that both specifies the paste location and triggers the paste operation 406. The system 300 initiates either the conventional paste operation 406a or the generative paste operation 406b based on user preferences or system settings.

The clipboard 328 may include both clipboard content 306 and processed clipboard content 308. The paste operation 406 may handle both types through user preferences, context-aware selection based on the destination document 314, user prompts during paste operations, differentiated keyboard shortcuts, or application-specific behaviors. These methods provide flexibility while maintaining compatibility with traditional clipboard functionality.

The system 300 and method 400 may apply generative processing at both copy and paste stages, where generative copy produces processed clipboard content 308 from original content 304, and generative paste then processes this content to produce processed pasted content 312. The copy action definition 344 and paste action definition 346 may be the same or different. When different, this enables multi-stage processing such as language translation during copy followed by cultural adaptation during paste, or technical summarization during copy followed by simplification during paste.

The cut-and-paste system 300 and method 400 integrate AI-driven content processing into familiar copy and paste operations, enabling users to leverage generative capabilities directly within their normal document editing workflow. The system 300 provides granular control by allowing users to apply action definitions to specific text selections, including individual words, sentences, paragraphs, or non-contiguous text portions. Users can apply different action definitions to different portions of the same document as needed. The two-stage processing capability enables separate generative processing during both copy and paste operations. During copying, users can apply an action definition to generate processed clipboard content. During pasting, users can apply a second action definition to the processed clipboard content, allowing for context-aware transformations that consider both source and destination document contexts.

Embodiments of the present invention provide text transformation capabilities that enable users to apply action definitions to existing text through an intuitive painting interface. A user selects destination text by dragging over it, causing the system to automatically apply an action definition to produce painted text that replaces the destination text. The painted text is generated by providing a prompt to a language model based on the destination text. The modification applied to produce painted text may be determined based on source text selected by the user. A painting configuration is generated based on the source text, and the destination text is modified according to this configuration. The painting configuration may be selected using language model output generated from a prompt based on the source text. These operations are performed when the system is in painting mode, which is activated and deactivated through user input such as selecting a painting mode button.

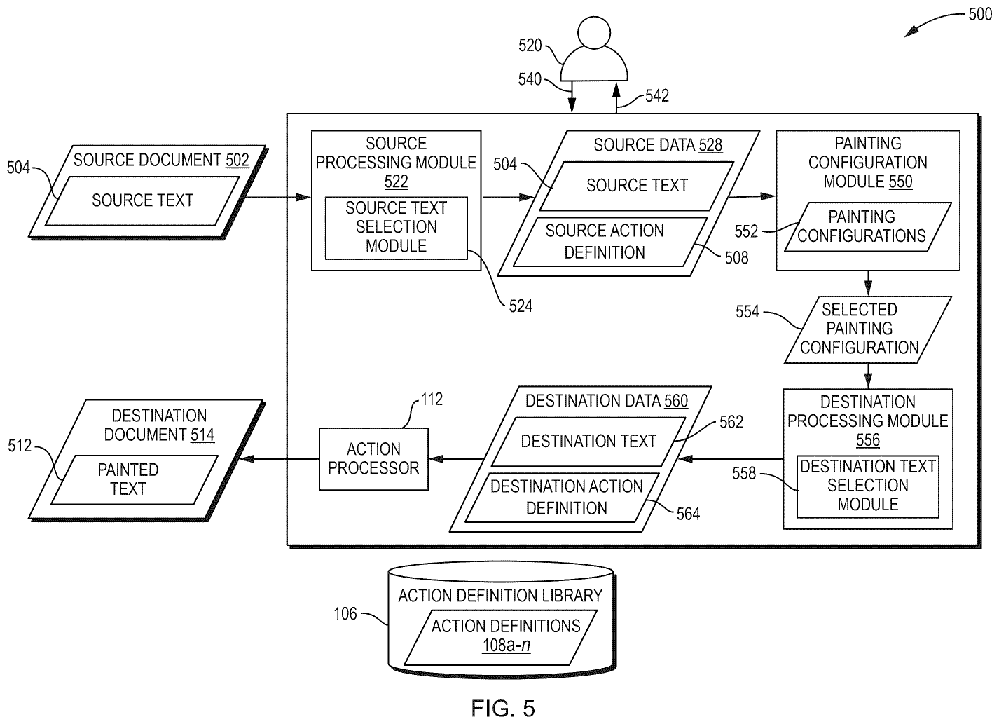

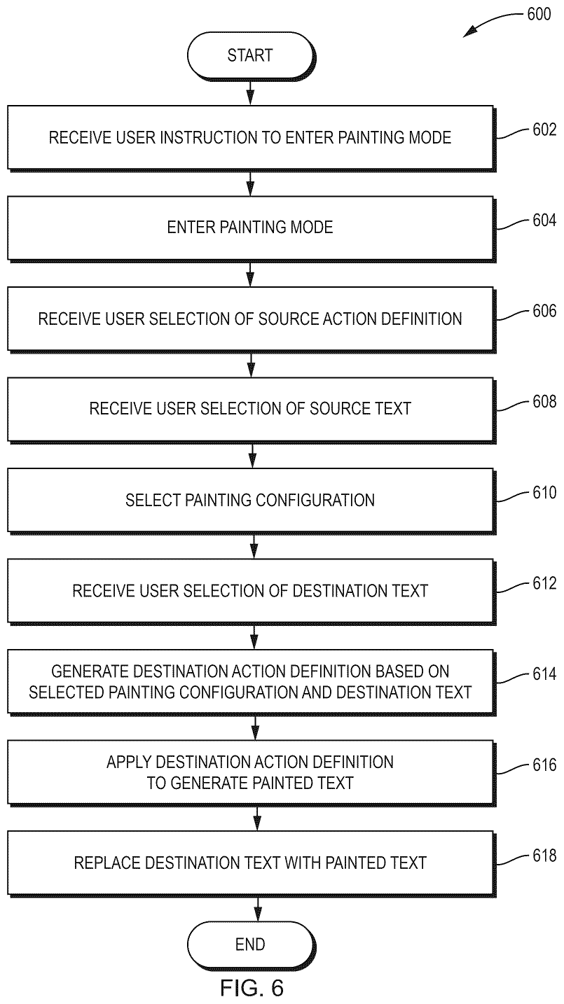

Referring to FIG. 5, a dataflow diagram is shown of a system 500 for implementing painting features. Referring to FIG. 6, a flowchart is shown of a method 600 performed by the system 500.

The user 520 may provide input 540 representing an instruction to enter a painting mode. The system 500 may receive the input 540 from the user 520 representing the instruction to enter the painting mode (FIG. 6, operation 602). In response to receiving the input 540 representing the instruction to enter the painting mode, the system 500 may enter the painting mode (FIG. 6, operation 604). The painting mode enables the application of text transformations using paint action definitions. The instruction to enter painting mode may be provided through various user interface methods including buttons, menu selections, keyboard shortcuts, gesture-based activation, voice commands, or context menu options. These input methods provide flexibility and accessibility for users to enter and exit the painting mode.

The user 520 may provide input 540 selecting a source action definition 508 from the action definitions 108a-n in the action definition library 106 (FIG. 6, operation 606). The source action definition 508 may be any type of action definition disclosed herein. The system 500 may automatically select the source action definition 508 based on context analysis or user preferences.

The user 520 provides input 540 selecting source text 504 from source document 502 (FIG. 6, operation 608). The user 520 may select the source text 504 using any of the selection methods disclosed for selecting original content 304 in system 300. The source processing module 522 processes the user's selection of source action definition 508 and source text 504. The source text selection module 524 receives the user's input 540 and prepares the source text 504 for processing. The source data 528 includes the source text 504. The source text selection module 524 may receive user input through mouse selection, keyboard shortcuts, touch gestures, voice commands, or programmatic selection methods.

The system 500 includes a painting configuration module 550 containing painting configurations 552 that specify text transformations. The painting configurations 552 may be implemented as action definitions 108a-n or may take any suitable form for performing the disclosed painting functions.

The painting configuration module 550 selects one of the painting configurations 552, referred to herein as the selected painting configuration 554 (FIG. 6, operation 610). The painting configuration module 550 may select the selected painting configuration 554 based on the source text 504, the source action definition 508, or both in combination.

Unlike conventional format painters limited to text formatting properties, embodiments can “paint” destination text with properties derived from the source text 504, including writing style, tone, content structure, vocabulary level, language, and argumentation style. Different source text 504 or source action definitions 508 may cause selection of different painting configurations 554 that specify different transformations, enabling the system 500 to tailor transformations based on the specific nature of the source content.

The painting configuration module 550 may apply the source action definition 508 to the source text 504 to produce source action definition output, then select the selected painting configuration 554 based on this output. For example, if the source action definition 508 includes the prompt “Identify the tone of the source text” and produces output “informal”, the module may select a painting configuration designed to transform text into informal tone.

The user 520 provides input 540 selecting destination text 562 (FIG. 6, operation 612). The destination text 562 may be in the same document as the source document 502 or a different document. The destination processing module 556 and destination text selection module 558 receive the user's input and extract the destination text 562 for processing.

The destination processing module 556 generates the destination action definition 564 based on the selected painting configuration 554 and the destination text 562 (FIG. 6, operation 614) by selecting from existing action definitions 108a-n or generating a new definition by concatenating the prompt from the selected painting configuration 554 with the destination text 562. Operation 614 may be performed when the system 500 is in painting mode.

The system 500 applies the destination action definition 564 to generate painted text 512 (FIG. 6, operation 616) using the action processor 112. The destination action definition 564 may be generated based on the destination text 562 and applied to produce the painted text output. Where the destination action definition 564 is a final prompt, operation 616 provides the prompt to a language model which generates the painted text output. The painted text 512 may be the painted text output or generated based on the painted text output. Operation 616 may be performed only when the system 500 is in painting mode.

The system 500 replaces the destination text 562 in the destination document 514 with the painted text 512 (FIG. 6, operation 618). The system 500 may perform direct replacement by substituting the destination text 562 with the painted text 512, or may use differential updates that compute and apply only necessary changes while preserving formatting and structural elements. In some embodiments, operation 618 performed if and only if the system 500 is in painting mode.

Operations of method 600 may be performed in different orders, including selecting source text 504 before entering painting mode, selecting painting configuration before selecting source text 504, selecting destination text 562 before source text 504, iteratively applying configurations to multiple document parts, or modifying the selected painting configuration 554 after text selection but before application.

Embodiments of the system 500 and method 600 enable users to transform text by selecting source text with desired characteristics, activating painting mode, and applying transformations to destination text sections. The system supports style transformation, tone adjustment, language simplification, and multi-document transformation operations.

The system 500 and method 600 provide control through multi-stage transformation sequences, context-aware analysis for tailored painting configurations, custom action definition creation, interactive refinement capabilities, and configurable language model parameters. These capabilities enable customized and context-aware transformations while maintaining ease of use and precise control.

The system extends generative text transformation capabilities through generative drag operations that apply action definitions dynamically during drag operations, with transformed output inserted at the destination. The system intelligently selects different action definitions based on drag context and supports touch-based interactions including pinch, spread, and directional swipes mapped to specific transformations. Real-time preview capabilities enable users to evaluate transformation effects and compare multiple outputs simultaneously.

Embodiments implement a “generative drag” feature that applies an action definition to dragged text during drag operations, resulting in transformed content being inserted at the destination rather than the original selected text. The workflow includes user selecting text, initiating generative drag operation, system selecting and applying action definition to generate new content, and inserting generated text at destination location when user releases drag.

The generative drag feature combines operations into a single interaction, enables real-time processing with visual feedback, provides context-aware transformations based on drag location, and makes text transformations intuitive through familiar drag-and-drop paradigm. The system incorporates dynamic action selection based on current drag location context. As users drag text across different document parts, the system analyzes potential destination areas and dynamically selects different action definitions, applying these selections in real-time with preview mode updates as the drag operation moves across document sections. Dynamic action selection may vary complexity levels by simplifying technical content for introductory sections while expanding detail for advanced sections, translate language across multilingual document sections, adapt tone and style between formal and informal sections, and generate appropriate data visualizations based on destination context. The system uses context types for dynamic action selection including document structure, content complexity, writing style and tone, target audience, language and localization, data presentation requirements, citation styles, technical jargon levels, emotional tone, and time-based context.

Embodiments of the present invention incorporate gesture-based interactions for touch-enabled devices that integrate with the generative text transformation capabilities disclosed herein. Touch-based gestures may control text selection through double-tap or drag operations, action definition selection through circular motions or multi-finger swipes, generative drag operations through modified drag gestures, real-time preview control, and switching between painting configurations. These gestures may be replaced or complemented by camera-captured movements including hand signs, motion tracking, and finger position detection through computer vision algorithms.

Specific gesture implementations include pinch gestures for summarization actions, spread gestures for text expansion, directional swipes for adjusting formality and complexity, circular motions for rephrasing actions, and multi-finger gestures for tone adjustment and significant transformations. Any gesture may be mapped to perform any action disclosed herein.

Action definition parameters are variables that customize text transformation behavior. Parameters include complexity level (simple to technical), formality scale (casual to formal), summarization ratio (percentage of original length), language model temperature (output randomness), and citation style (APA, MLA, Chicago). Parameter values may be adjusted through gesture-based interactions including swiping, pinch/spread gestures, circular motions, slider controls, text input fields, and voice commands. These input methods enable intuitive control and fine-grained adjustments for tailoring transformations to user needs.

The user interface enhancements integrate text manipulation capabilities using LLMs into document editing workflows through generative drag operations that apply action definitions dynamically as users drag text, with transformed output inserted at the destination. The system intelligently selects different action definitions in real-time based on drag context and supports enhanced touch gestures including pinch, spread, directional swipes, and multi-finger interactions for accessing generative text transformations. Real-time preview capabilities enable evaluation of generative actions and comparison of multiple transformations simultaneously, creating synergies with existing action definitions and painting configurations through gesture-based interactions and context-aware application of transformations.

The user interface enhancements disclosed herein may improve workflow efficiency through a generative drag feature that combines text selection, transformation, and placement into a single fluid interaction. The system may automatically select appropriate action definitions based on document context during drag operations and provide real-time preview with immediate visual feedback of transformations during application. The system may address accessibility through customizable gesture sensitivity, multi-modal interactions, visual feedback, and voice integration capabilities.

Embodiments include a “generative merge” feature that extends the action definition framework for bulk document creation. Unlike conventional mail merge that replaces static placeholders with predefined data, the generative merge feature employs action definitions to create personalized content using generative AI. The generative merge feature integrates with the text generation modules disclosed herein to apply transformations across document sections during merge operations. The feature supports all action definition types including simple text prompts, tokenized prompts, compound prompts, and scripted prompts for context-sensitive content creation.

The term “generative” encompasses any technology capable of performing the disclosed functions, not limited to generative AI technologies.

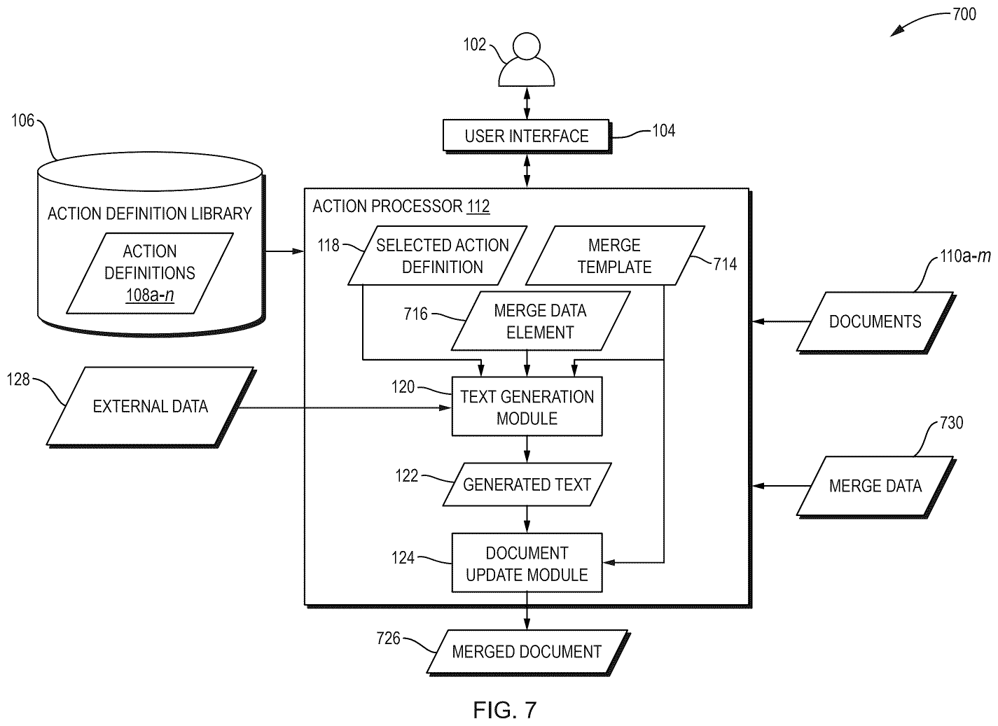

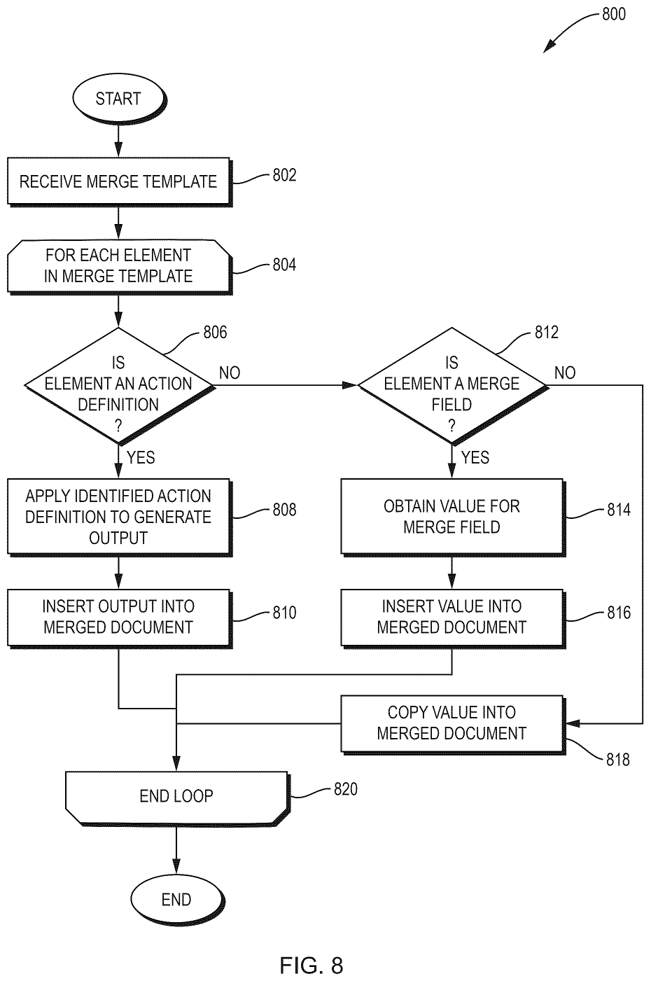

FIGS. 7 and 8 illustrate system 700 and method 800 for implementing the generative merge feature. System 700 shares components with system 100 including action definition library 106, action definitions 108a-n, external data 128, user 102, user interface 104, action processor 112, selected action definition 118, text generation module 120, generated text 122, document update module 124, and documents 110a-m. System 700 adds merge-specific elements including merge template 714, merge data element 716, merge data 730, and merged document 726.

The system 700 receives the merge template 714, which serves as the foundation for the generative merge process (FIG. 8, operation 802). The merge template 714 may be received through user input via the user interface 104, automatic system selection by the action processor 112, API integration, database retrieval, or cloud storage integration.

The merge template 714 may take various forms including text documents (e.g., .docx, .txt, .pdf), structured data formats (XML, JSON, YAML), database records, spreadsheet formats, web-based formats (HTML, Markdown), or custom data structures optimized for efficient processing of action definitions.

The merge template 714 uses a recursive content model supporting three fundamental types of content elements: static content comprising traditional text elements that remain unchanged during the merge process; dynamic content including action definitions that trigger content generation using language models; and hybrid content representing collections of content elements where each element may be static, dynamic, or hybrid content. This recursive structure enables arbitrarily complex document hierarchies where different content types may be nested and combined.

The merge template 714 serves as a container for action definitions and other content that will be processed by the generative merge feature to produce the merged document 726.

The merge template 714 may be created through graphical user interface elements that enable menu-driven selection of action definitions from the action definition library 106, displaying short names such as “Summarize|Rephrase|Expand” for easy selection. The system 700 may provide buttons or toolbar options for inserting action definitions into the template and visual indicators highlighting different element types such as action definitions, merge fields, and static content.

Users may select action definitions by clicking on manifested short names in menus or buttons, using voice commands, employing keyboard shortcuts, or utilizing programmatic selection through APIs. These selection mechanisms provide flexibility in how users interact with the action definition library 106 for both manual and automated template construction.

The system 700 may enable users to add new action definitions to the library, modify existing action definitions using text editor interfaces, create custom prompts for language models, and define metadata such as descriptions and short names. These customization capabilities allow users to extend the functionality beyond the default action definitions 108a-n provided in the action definition library 106.

Interactive preview capabilities may allow users to preview generated content before finalizing action definitions and provide real-time feedback on transformation results. The preview functionality may display sample outputs based on test merge data 730, allowing users to evaluate how their action definitions will perform with actual data.

Advanced configuration options may include fine-tuning of language model parameters, creation of compound and chained action definitions, definition of custom tokens and variables, and specification of transformation rules and constraints. The system 700 may provide specialized interfaces for advanced configuration, including visual editors for compound action definitions and parameter adjustment controls for language model settings.

The system 700 may maintain flexibility through support for both simple and advanced editing interfaces, various input methods including mouse, keyboard, voice, and programmatic approaches, and integration with existing document editing workflows. Simple editing interfaces may provide streamlined access to common functionality, while advanced interfaces may expose the full range of customization options.

This interface design enables users to efficiently create sophisticated merge templates while maintaining precise control over document structure and content generation capabilities.

Merge templates may include action definitions that specify prompts for large language models to generate content dynamically. The system 700 may process action definitions by providing their specified prompts to language models to generate output, allowing merge templates to leverage advanced AI capabilities while maintaining the structured approach of traditional mail merge operations.

A single merge template 714 may contain a mix of action definitions, conventional merge fields, and static content interspersed throughout the template structure. The system 700 may process each element type differently: action definitions trigger LLM-based content generation, merge fields receive conventional field values from merge data 730, and static content is copied directly to the merged document 726. A single merge template 714 may contain multiple different action definitions that vary in their prompt specifications, types such as simple text, tokenized, compound, or scripted variations, and transformation rules and parameters. This diversity enables merge templates to perform complex, multi-stage content generation operations while maintaining document structure and coherence.

The system 700 may provide context-aware content generation through action definitions where generated content adapts based on merge data values, document context, and recipient-specific information. The text generation module 120 may produce content that is specifically tailored to each document instance while maintaining consistency with the overall template structure.

Templates may maintain author-defined structure while enabling dynamic content generation through the coordinated operation of the action processor 112 and document update module 124. Authors may specify which elements remain static and which should be dynamically generated, providing precise control over the balance between automation and consistency.

The system 700 may support multi-instance generation where templates generate multiple document instances with consistent structure. Each instance may incorporate different merge field values, uniquely generated content from action definitions, and context-specific adaptations based on the particular merge data 730 associated with that instance.

When creating the merge template 714, users may freely place action definitions at any arbitrary location within the template structure by selecting or creating any type of action definition and positioning it wherever desired within the template.

The merge template 714 may contain any combination of action definitions, traditional merge fields, and static content in any sequence. Action definitions may specify language model operations, while merge fields enable data substitution and static content provides structural consistency. This flexible architecture supports both traditional mail merge functionality and generative content capabilities within a single template.

Users may insert action definitions at any point in the template where dynamic content generation is desired, interspersed with conventional merge fields and static content. Multiple different action definitions may be defined throughout the template, each potentially specifying different prompts or transformation rules. The system places no restrictions on the number, location, or sequence of action definitions within a merge template. Templates may contain only action definitions, only merge fields, only static content, or any combination in any order. This unrestricted placement capability allows document authors to design templates that precisely match their intended structure while incorporating generative capabilities wherever needed. This arbitrary placement capability enables users to create highly customized templates that precisely specify where and how dynamic content generation should occur while maintaining complete control over document structure.

Action definitions may be embedded into the merge template 714 using metadata-based approaches such as XMLtags, document properties, hidden characters, or custom styles. Field-based methods may leverage form fields, content controls, bookmarks, or comment threads. External reference systems may use unique identifiers linking to external databases, sidecar files, or cloud storage repositories.

Hybrid approaches may combine multiple embedding methods within a single template, such as using metadata for simple action definitions while employing external references for complex operations. The embedding method may be selected based on document format compatibility, processing requirements, and workflow needs. The flexibility in embedding methods enables embodiments to adapt to various document formats, user workflows, and technical requirements while maintaining consistent processing capabilities across different implementation approaches.

The system 700 may manifest action definitions within the merge template 714 using action definition labels (short names) that provide user-friendly identifiers summarizing each action definition's purpose. For example, a complex summarization prompt may be manifested simply as “Summarize.”

The system 700 may manifest any data within the action definition, any subset thereof, or information derived therefrom. This enables users to view different levels of detail, from metadata and descriptions to complete prompts, based on their needs. The system 700 may implement hybrid approaches such as manifesting labels by default while providing expandable sections or tooltips that reveal additional details when needed.

Merge templates incorporating the generative capabilities of embodiments of the present invention may be used for email marketing campaigns with personalized content based on recipient data, business proposals with customized value propositions, customer service responses with personalized solutions, educational materials that may adapt to student levels, and HR communications with role-specific details. These applications may benefit from the system's ability to maintain consistent document structure while enabling sophisticated content generation through action definitions that may process multiple data sets to create personalized document instances.

The system may apply different action definitions for various content sections, enabling targeted transformations within different portions of the same document. The system may combine static content with dynamically generated elements, providing flexibility in document composition while preserving author-defined structural elements and ensuring coherent integration of both fixed and generated content components.

As just one example, and without limitation, the following may be an example of a particular embodiment of a merge template that may include both traditional merge fields and action definitions that may include prompts that may be designed to be provided as inputs to a generative AI-based module, such as a large language model:
Subject: {customer_name}, Your Personalized Travel Recommendations
Dear {customer_name},
[ACTION_DEFINITION_1]
“Generate a personalized travel destination recommendation based on the following customer data:
   Previous destinations: {travel_history}
   Budget range: {budget_preference}
   Travel style: {travel_style}
   Write in an engaging, conversational tone highlighting 2-3 specific destinations.”
[/ACTION_DEFINITION_1]
Based on your interests, here are some exclusive offers for your next adventure:
[ACTION_DEFINITION_2]
“Using the recommended destinations above, generate compelling promotional offers that:
   [symbol] Highlight unique experiences
   [symbol] Include specific pricing details using {budget_preference}
   [symbol] Create urgency through limited-time messaging
      Format as 3 distinct bullet points with emotional appeal”
      [/ACTION_DEFINITION_2]
Book your trip by {offer_expiration_date} to receive:
   Complimentary airport transfers
   Priority check-in at all hotels
   Exclusive local experiences
[ACTION_DEFINITION_3]
“Generate a personalized call-to-action paragraph that:
   [symbol] References the customer's loyalty tier: {loyalty_status}
   [symbol] Mentions their available reward points: {point_balance}
   [symbol] Provides a clear next step for booking
      Use an encouraging but not pushy tone
      [/ACTION_DEFINITION_3]
Best regards,
Your Travel Team

Operation 804 of the method 800 may initiate a loop that iterates over each element in the merge template 714. This loop may systematically process the contents of the merge template 714 to generate the merged document 726. During each iteration, the system 700 may determine the nature of the current element and may take appropriate action based on its type, such as applying action definitions, processing merge fields, or copying content directly.

The elements processed in operation 804 may include characters, tokens, XML/HTML tags, JSON objects, database fields, custom delimiters, or semantic units such as sentences or paragraphs. This flexibility may allow the system 700 to adapt to various template formats and structures, ensuring all components of the merge template 714 may be appropriately handled during document generation.

Operation 806 may determine whether the current element is an action definition, enabling the system 700 to differentiate between content requiring dynamic generation and content processed using conventional merge techniques.

The system 700 may implement operation 806 through delimiter-based identification using special characters or tags, token analysis to match action definition patterns, semantic parsing to understand element meaning, reference lookup to check pointers to the action definition library 106, metadata analysis, type checking in structured formats, pattern matching using regular expressions, hash-based identification for rapid comparison, machine learning classification, signature-based detection, context-aware identification based on surrounding elements, version-based identification, namespace-based identification, statistical analysis of element characteristics, or hybrid identification combining multiple methods.

The implementation method may depend on the merge template 714 format, action definition representation, and system 700 design, allowing adaptation to various document structures while maintaining effective action definition identification.

The selected action definition 118 may be the action definition represented by the current element when determined to be an action definition in operation 806, enabling seamless integration with existing action definition processing capabilities.

When the current element is an action definition, operation 808 may apply this action definition to generate output using the text generation module 120, similar to how the selected action definition 118 may generate the generated text 122 in system 100.

Operation 808 may leverage existing system 700 infrastructure, enabling application of various action definition types including simple text prompts, tokenized prompts, compound prompts, and scripted prompts for sophisticated content generation during the merge process.

In the generative merge feature, the selected text 116 of system 100 may not be utilized, as action definitions may generate new content based on their inherent instructions rather than transforming existing selected text.

The text generation module 120 may apply solely the current action definition or may combine it with external data 128 and documents 110a-m to generate output.

Operation 810 may insert generated output into the merged document 726 either by building a new document based on the merge template 714 or through in-place replacement where generated output may replace the action definition directly within the merge template 714. Both implementations may use a current location that advances as the method 800 iterates through each element, ensuring generated content may be inserted in correct sequence and position within the merged document 726.

The system 700 may operate with varying degrees of user involvement, from fully automated processing to interactive approaches. In fully automated mode, the system 700 may apply action definitions, may generate output, and may insert it into the merged document 726 without user intervention, maximizing efficiency for rapid document generation. Interactive modes may include review and approval where generated output may be presented to user 102 for verification, alternative take selection where users may choose from multiple generated outputs, interactive refinement allowing direct modification of generated content, and contextual feedback providing information about how output may fit within the broader document context. These interaction levels may combine automated content generation efficiency with manual editing precision, allowing the system 700 to adapt to different user preferences and document generation scenarios while ensuring the merged document 726 may meet desired quality standards.

The method 800 may process conventional merge fields in the merge template 714. In operation 812, the method 800 may determine whether the current element is a merge field, such as text enclosed in double angle brackets (e.g., < >), text surrounded by curly braces (e.g., {LastName}), or text prefixed with special characters (e.g., &Address&). The system 700 may employ delimiter-based identification, token analysis, or pattern matching using regular expressions to detect merge field syntax.

If the current element is identified as a merge field, the system 700 may obtain a value for that field by retrieving data from the merge data 730, querying a database or external data source, applying predefined rules or calculations, or prompting the user for input. In operation 816, the method 800 may insert the obtained value into the merged document 726 at the current location, either by building a new document or performing in-place replacement of the merge field in the merge template 714. By processing both action definitions and conventional merge fields, the method 800 may combine AI-driven content creation with traditional mail merge functionality. Some embodiments may omit operations 812, 814, and 816, or may only perform those operations when conventional merge processing has been enabled.

Operation 818 of the method 800 may handle elements that are neither action definitions nor merge fields. In this scenario, the method 800 may copy the current element into the merged document 726 without modification. Such elements may include static content, formatting elements, structural components, or metadata that are intended to be preserved unchanged in the merged document 726. This approach may ensure that the final merged document 726 seamlessly combines dynamically generated content from action definitions, merged data from conventional merge fields, and static content from unprocessed elements.

Some embodiments of the generative merge feature may expand upon the capabilities of the system 700 and method 800 by incorporating an enhanced version of the merge data 730. This enhanced merge data 730 may serve a dual purpose, supporting both conventional merge fields and providing specialized data for action definitions within the merge template 714.

Such embodiments may create a more versatile document generation system that integrates traditional mail merge functionality with AI-driven content creation. By leveraging both conventional merge data and action definition data, the system 700 may produce customized documents that combine static content, dynamically merged information, and AI-generated text.

This embodiment may enable the system 700 to process the merge template 714 and create a single merged document 726 that incorporates conventional merge field data, AI-generated content based on action definitions, and static content from the original template. In some embodiments, the merge data 730 may only include action definition data for use with action definitions, without including conventional merge data.

To enable the use of the merge data 730 in enhancing the generation of the merged document 726, the system 700 and method 800 may include data structure enhancements where the merge data 730 is structured to include action definition data. For example, the merge data 730 may include conventional fields such as customer names and account balances alongside action definition data such as personalization context including purchase history, communication style, and interests.

Operation 806 may be extended to identify action definitions and extract identifiers or references that link to specific data in the merge data 730. For example, an action definition may include embedded references such as “[ACTION_DEF:personalize_greeting Idata_key:customer_profile]” where “personalize_greeting” identifies the action and “customer_profile” specifies which data object in the merge data 730 to retrieve.

A data retrieval operation may be introduced between operations 806 and 808 to retrieve relevant data from the merge data 730 for the current action definition. This may involve parsing the action definition for data references, querying the merge data 730 using these references, and preparing the retrieved data for use in the text generation process. Operation 808 may be modified to incorporate the retrieved data when applying the current action definition, with the text generation module 120 accepting and processing this additional input alongside the action definition itself.

These modifications may allow the system 700 and method 800 to leverage the merge data 730 effectively, creating more dynamic and data-driven merged documents 726 that combine the benefits of traditional mail merge with AI-driven content generation.

Embodiments of the generative merge feature may expand upon the system 700 and method 800 by enabling the merge data 730 to include multiple sets of action definition data and merge data. Each set within the merge data 730 may be utilized by the system 700 and method 800 to generate a distinct instance of the merged document 726. This embodiment may provide a document generation system that combines traditional mail merge operations with AI-driven content creation. By leveraging multiple data sets within the merge data 730, the system may produce a series of customized documents, each tailored to a specific set of inputs.

The system 700 may process the merge template 714 multiple times, once for each set of data in the merge data 730, resulting in multiple instances of the merged document 726. Each instance may incorporate conventional merge field data specific to that instance, AI-generated content based on action definitions customized for each instance, and static content from the original template.

This approach may enhance the scalability and efficiency of document generation, enabling the creation of multiple, personalized documents from a single merge template and a comprehensive set of merge data. In some embodiments, the merge data 730 may include only action definition data for use with action definitions, without conventional merge data, allowing the system 700 to focus solely on AI-driven content generation.

To enable the use of the merge data 730 to generate multiple distinct instances of the merged document 726, the system 700 and method 800 may include data structure enhancements where the merge data 730 is restructured to accommodate multiple sets of data, each containing both conventional merge data and action definition data. The system 700 may support various data formats including JSON structures with nested objects, XML hierarchies with schema validation, CSV formats with header mappings, database result sets with relational constraints, and/or custom binary formats optimized for processing performance.

The method 800 may be modified to iterate over each set of data in the merge data 730 by wrapping the existing method 800 in an outer loop that processes each data set sequentially. The system 700 may implement configurable iteration strategies such as sequential processing for memory-constrained environments, parallel processing pools for high-performance scenarios, and/or adaptive processing that automatically adjusts parallelization based on system resources and data set characteristics. Context management may maintain separate contexts for each instance of the merged document 726 being generated, ensuring that data and generated content from one instance do not interfere with other instances through separate memory spaces, temporary file systems, and/or containerized processing environments.

For each iteration, the system 700 may create a new instance of the merged document 726 starting from the original merge template 714, select the corresponding data set from the merge data 730, and process action definitions using the action definition data from the current data set. The system 700 may handle multiple output documents through creating a collection of merged documents 726, implementing various output collection mechanisms such as streaming output to disk for large document sets, in-memory collections for smaller batches, and/or database storage for persistent document management. Performance optimization may include parallel processing of document instances, memory-mapped file processing for large data sets, connection pooling for database-backed merge data, and/or caching mechanisms for frequently used action definitions.

The system 700 may enable user-driven selection of action definitions embedded within the merge template 714. For example, the user 102 may provide input selecting one or more action definitions within the merge template 714, in response to which the action processor 112 may apply the selected action definition(s) in any of the ways disclosed herein.

The user 102 may select such action definitions through visual selection of manifestations within the merge template 714, such as by clicking or tapping on visual manifestations of action definitions. In response to such user input, the action processor 112 may apply the selected action definition 118 to generate output and insert that output into the document.

When the user 102 selects text in the merge template 714 that includes multiple action definitions, the action processor 112 may apply each selected action definition. For example, if the user 102 selects a portion containing “Dear {customer_name}, {action_def_1: personalize_greeting} We are pleased to inform you that {action_def_2: generate_product_recommendation},” the action processor 112 may apply action_def_1 to generate personalized greeting text and apply action_def_2 to generate product recommendation text, replacing each action definition with its corresponding generated output.

The system 700 may support mixed processing approaches where some action definitions within the merge template 714 are processed automatically while others are processed in response to user selection. The user 102 may specify which action definitions should be processed automatically and which should await user selection through configuration settings or by designating certain action definitions as requiring user approval before execution.

In some embodiments, the output generated by applying an action definition may itself be or include another action definition. More generally, embodiments of the present invention may apply first dynamic content to generate second dynamic content, and so on. The system 700 may implement technical safeguards including generation depth counters that track recursion levels and prevent infinite loops through configurable depth limits. Cycle detection algorithms may identify circular dependencies between action definitions, while performance optimization mechanisms such as lazy evaluation and content caching may enhance processing efficiency during recursive operations.

When the text generation module 120 applies an action definition (e.g., within hybrid content, such as the merge template 714) to generate output (e.g., in FIG. 8, operation 808), that output may take the form of hybrid content that contains both static text and one or more embedded action definitions. The newly generated action definition(s) may be activated by a user or automatically processed by the system 700, leading to further content generation, which may include dynamic content (e.g., hybrid content). This recursive capability enables the creation of self-expanding document structures where each level of expansion can spawn additional levels. The system 700 may maintain separate processing contexts for each recursion level to prevent interference between generations and may implement error recovery mechanisms that handle failures in child action definitions through fallback strategies such as reverting to static content or using alternative action definitions.

For example, when processing an action definition that generates a business report summary, the output may include static text describing key metrics along with one or more embedded action definitions such as “Generate detailed financial analysis” or “Expand market research findings.” When these embedded action definitions are subsequently activated, they may generate their own hybrid content containing both informational text and one or more additional action definitions for even more specific analyses.

The system 700 may handle this recursive generation through any of a variety of approaches. In some cases, the newly generated action definitions may be processed immediately in a cascading fashion, where each level of generation automatically triggers the next. Alternatively, the system 700 may present the newly generated action definitions to the user 102 for selective activation, allowing for controlled exploration of the content hierarchy. The system 700 may provide visual indicators in the user interface 104 to distinguish between static content and embedded action definitions, may offer preview capabilities that show potential recursive expansions without committing to generation, and may include undo/redo functionality that operates across multiple recursion levels.

This recursive capability may be particularly useful in scenarios where the depth and breadth of required content cannot be predetermined. For instance, a legal document template may generate contract clauses that themselves contain action definitions for generating jurisdiction-specific modifications, compliance requirements, or risk assessments. Each of these generated elements may further contain action definitions for creating supporting documentation or alternative formulations.

The merge template 714 may be designed to accommodate this recursive structure by supporting nested action definitions and maintaining context across multiple levels of generation. The system 700 may track the relationships between parent and child action definitions, enabling features such as context inheritance, constraint propagation, and dependency management across the recursive hierarchy. The system 700 may implement content validation mechanisms including schema validation to ensure generated action definitions conform to expected formats, semantic analysis to verify that embedded prompts are coherent and executable, and quality scoring mechanisms that evaluate the appropriateness of recursive content generation.

Embodiments of the present invention (e.g., the system 700 and method 800) may implement a structured content generation architecture that ensures language models reliably produce hybrid content containing embedded executable prompts rather than generating only static text. This architecture addresses the fundamental challenge that language models, when given conventional prompts, typically generate plain text output without embedded dynamic elements. The structured generation architecture guides language models to produce content that conforms to the recursive content model by providing explicit formatting instructions, output specifications, and parsing mechanisms that convert generated text into functional content objects containing both static text and executable prompt elements.

Embodiments of the present invention may provide structured output specifications to language models alongside content generation requests to ensure the generated content includes both static text and dynamic elements in appropriate locations. These specifications may include schemas or templates that define the expected structure of the output, indicating where dynamic elements should be embedded within the generated content.

Embodiments of the present invention may provide format directives that specify the arrangement of static and dynamic components within the generated output. For example, embodiments of the present invention may instruct the language model to “Generate response in format: {static_intro, dynamic_expansion_prompt, static_conclusion}” where each component type is explicitly defined. The language model receives these structural requirements as part of the generation request, enabling it to produce content that conforms to the hybrid content model.

The output specifications may include metadata about each content component, such as activation methods for dynamic elements, context requirements, and relationship information that defines how components interact with each other. Embodiments of the present invention may also specify constraints for dynamic elements, including depth limits, content types that may be generated, and inheritance rules that govern how properties propagate to child elements.

Embodiments of the present invention include a parser that converts the language model's structured output into executable content objects. The parser processes the generated content to identify and extract dynamic elements, transforming them from textual representations into functional prompt components that can be activated within the document system.

The parser may identify dynamic elements within generated content and convert them to functional prompts capable of triggering additional content generation. This conversion process may involve extracting prompt text, activation parameters, and contextual information from the structured output, then creating executable prompt objects that maintain the necessary metadata for proper functioning within the recursive content system.

The parsing mechanism may maintain separation between descriptive text about prompts and actual executable prompt elements. This distinction ensures that references to prompts or descriptions of dynamic functionality within the generated content do not inadvertently become executable elements, while genuine dynamic components are properly recognized and converted to functional form. The parser may use formatting markers, structural indicators, or metadata tags to distinguish between descriptive content and executable prompt specifications.

Embodiments of the present invention may utilize prompt templates that specify both content requirements and structural requirements for generated output. These templates may define not only what information should be generated but also how that information should be organized within the hybrid content structure, including the placement and configuration of dynamic elements.

The system may combine user requests with structural directives before sending prompts to the language model. This integration process may involve merging user-specified content goals with template-defined structural requirements, creating generation instructions that address both the substantive content needs and the technical formatting requirements necessary for proper hybrid content creation.

The templates may ensure consistent generation of hybrid content across different use cases by providing standardized frameworks for content structure. Templates may define common patterns for embedding dynamic elements, specify default activation methods, and establish inheritance rules that maintain coherence across multiple generations. This templating approach enables the system to reliably produce hybrid content regardless of the specific domain or application context.

Each generated dynamic element may include metadata specifying how it should behave when activated. This metadata may define activation methods, processing parameters, output constraints, and relationship information that governs the element's behavior within the recursive content system. The metadata ensures that dynamic elements maintain consistent functionality and appropriate boundaries when generating subsequent content.

Embodiments of the present invention maintain context and constraints that propagate through multiple generation levels. Context information may include document state, user preferences, previous generation history, and environmental parameters that influence content generation. Constraints may encompass formatting requirements, content boundaries, depth limitations, and quality standards that ensure generated content remains coherent and appropriate throughout the recursive generation process.

Generated prompts inherit properties from parent prompts to maintain document coherence across multiple generation levels. This inheritance mechanism may transfer stylistic guidelines, domain-specific constraints, formatting requirements, and contextual information from parent elements to their generated children. The inheritance system may propagate specific types of metadata including security permissions that determine which types of content can be generated at each recursion level, formatting constraints that ensure visual consistency across generated content, business rules that govern content appropriateness in different organizational contexts, and access control parameters that restrict certain types of generation based on user roles or document sensitivity levels. The inheritance system ensures that content generated at deeper levels of recursion maintains consistency with the overall document structure and adheres to the governing principles established by ancestor elements.

In some embodiments, the merge template 714 may include multiple action definitions that operate sequentially, with one action definition processing the output generated by a previous action definition and/or merge field. This enables sophisticated multi-stage content generation where each stage can build upon and refine content created in earlier stages.

For example, a first action definition in the merge template 714 may generate initial content, while a subsequent action definition in the merge template 714 processes that generated content to produce more refined output. This chained processing enables complex transformations where the context and content from earlier generations inform and enhance later content generation steps.

This capability enables merge templates to implement multi-stage processing workflows where initial action definitions generate foundational content based on merge field data, and subsequent actions process and refine that generated content. In some cases, multiple transformations may be chained together within a single template, allowing for complex content generation processes that build upon previous outputs. Later stages may reference both original merge data and previously generated content, creating sophisticated content relationships that enhance the overall document generation process. This multi-stage approach enables embodiments of the system to create more nuanced and contextually appropriate content by allowing each processing stage to contribute specialized transformations while maintaining coherence across the entire document generation workflow.

Through this sequential processing capability, the system enables merge templates to implement sophisticated content generation workflows while maintaining precise control over document structure and formatting. The ability to chain multiple action definitions together allows for complex, context-aware content generation that goes beyond simple field substitution or single-stage processing.

Embodiments of the invention support multiple mechanisms for action definitions to reference and process previously-generated content within merge templates, including content that was inserted to the document as the result of applying one or more previous action definitions and/or one or more previous merge fields.

For example, an action definition may explicitly reference specific previously-generated content through any one or more of several mechanisms. An action definition may include a direct reference to the output of a specific prior action definition by its identifier, enabling precise targeting of previously generated content within the document processing workflow. The action definition may alternatively reference content generated within a particular template section or field, allowing for section-specific content retrieval and processing. In some cases, the action definition may reference content generated during a specific processing stage, providing temporal control over content dependencies. The action definition may also reference content generated from specific merge field data, enabling data-driven content relationships and processing sequences.

Additionally or alternatively, an action definition may implicitly reference previously-generated content through broader contextual references. For example, an action definition may reference the entire document state, which includes any previously generated content that has been incorporated into the document during prior processing steps. In some cases, an action definition may reference the surrounding context of the current insertion point, enabling the action definition to consider nearby text, formatting, or structural elements when generating new content. An action definition may also reference related document sections that may contain generated content, allowing for coordination between different parts of the document that have undergone content generation processes. Furthermore, an action definition may reference document-level metadata that reflects prior generation steps, such as information about previous transformations, generation parameters, or processing history that can inform subsequent content generation operations.

Additionally or alternatively, an action definition may include one or more compound (i.e., direct and indirect) references to previously generated content. Such compound references may, for example, include references that combine multiple generated content elements, enabling the action definition to process and integrate content from various sources within the document. The compound references may include references that process both generated content and original merge field data, allowing the action definition to create sophisticated relationships between dynamically generated content and static data elements. In some cases, the compound references may include references that analyze relationships between different generated elements, enabling the action definition to understand and leverage connections between various pieces of generated content. The compound references may include references that consider both local and document-wide generated content, allowing the action definition to access and process content from specific document sections as well as content distributed throughout the entire document structure.

An action definition may, for example, reference document content (including metadata) using Document Object Model (DOM) or DOM-like structures that provide programmatic access to document elements. This structured representation enables precise navigation and manipulation of document content through well-defined interfaces. For example, such structures allow action definitions to access hierarchical relationships between document elements, navigate parent-child relationships between content sections, reference specific nodes within the document tree, query document structure using standardized selectors, and traverse document content systematically. These capabilities enable action definitions to interact with document structure in sophisticated ways that support complex content generation and manipulation operations. The DOM or DOM-like structures may provide standardized methods for accessing document elements, attributes, and content, allowing action definitions to programmatically interact with document structure regardless of the underlying document format or implementation.

When referencing previously generated content, action definitions may utilize DOM or DOM-like interfaces to perform various document navigation and content selection operations. For example, action definitions may select specific content nodes by type, attributes, or location within the document structure. Action definitions may also access surrounding context through parent and sibling relationships, enabling comprehensive understanding of content positioning and hierarchical relationships. In some cases, action definitions may navigate document structure using standard DOM traversal methods, providing systematic access to document elements. Action definitions may query document state using DOM-based selectors, allowing for precise identification and retrieval of specific content elements. Additionally, action definitions may reference content across different structural levels, enabling cross-sectional content analysis and manipulation within complex document hierarchies.

The DOM-based approach provides a standardized mechanism for action definitions to reference and process document content while maintaining structural relationships. This enables sophisticated content generation that preserves document hierarchy and formatting while allowing precise access to previously generated elements.

In some embodiments, the system 700 enables action definitions to reference and process content that will be generated by action definitions and/or merge fields that appear later in the merge template 714. Implementing such forward references may involve executing action definitions in an order that differs from their sequential appearance in the merge template 714. For example, consider a first action definition that appears at a first location in the merge template 714 that is earlier in the merge template 714 than a second location of a second action definition. The first action definition refers, directly or indirectly, to output generated by applying the second action definition. The system 700 may implement any of a variety of mechanisms for executing the second action definition before executing the first action definition.

For example, an executive summary section at the beginning of a document may need to reference key points that will be generated in later sections. Through forward references, the action definition generating the summary can process content that will be created by subsequent action definitions, ensuring the summary accurately reflects the complete document content.

Similarly, a table of contents or index section may need to reference and process content that appears throughout the rest of the document. Forward references enable these organizational elements to be placed at their natural location in the template while still accessing content that will be generated later in the processing sequence.

As the above implies, the loop performed in operations 804-820 of the method 800 may not identify and/or apply action definitions in the order in which they appear in the merge template 714. Instead, the method 800 may be implemented in any suitable way to identify and apply action definitions in the merge template 714 in a sequence that is consistent with any dependencies between action definitions in any of the ways disclosed herein.

The system 700 may determine and apply appropriate execution ordering in any of a variety of ways. For example, in one embodiment the system 700 may analyze references between action definitions to identify dependencies that exist between different action definitions within the merge template 714. The system 700 may build a dependency graph of action definitions that represents the relationships and interdependencies among the various action definitions 108a-n. Based on the dependency graph, the system 700 may determine an execution sequence that satisfies all dependencies, ensuring that action definitions are processed in the correct order to maintain data integrity and proper content generation. The system 700 may coordinate processing across distributed system components, enabling efficient execution of complex merge operations that span multiple computing resources or processing modules.

The system 700 may implement dependency-based execution control that prevents action definitions from executing until their required inputs become available. In this context, inputs may be considered “available” when they contain processed content that has been generated by completed action definitions, rather than empty placeholders, unprocessed action definitions, or content that is still pending generation. An input may also be considered “available” when it contains contents, such as plain or rich text, that was manually entered by the user. The system automatically triggers execution when all dependencies are satisfied. For each action definition in the dependency graph, the system 700 may identify the specific inputs required by that action definition, such as output generated by other action definitions, content from particular document sections, or values from merge fields. The system 700 may monitor the availability status of these inputs and maintain each dependent action definition in a waiting state until all of its required inputs contain actual content rather than empty placeholders or unapplied action definitions.

When the system 700 determines that a prerequisite input has transitioned to an available state-such as when Action Definition A generates output that serves as input to Action Definition B, or when a document section transitions from empty to containing generated content—the system 700 may automatically evaluate whether all dependencies for waiting action definitions have been satisfied. In response to determining that all required inputs for a particular action definition are now available (meaning they contain processed, usable content), the system 700 may automatically trigger execution of that action definition without requiring additional user intervention. This dependency-based execution control ensures that action definitions are applied only when their inputs are ready, while enabling automatic processing as soon as dependencies are satisfied.

For example, if Action Definition B requires content from a particular document section as input, the system 700 may maintain Action Definition B in a waiting state while that document section is empty or contains only an unapplied action definition (both states indicating unavailable inputs). When Action Definition A generates content for that document section, making the required input available to Action Definition B (by providing processed, usable content), the system 700 may automatically detect this state change and trigger execution of Action Definition B using the newly available content as input.

Embodiments of the system 700 may enable complex document templates that appear to build themselves automatically as content becomes available. For example, consider a user 102 creating a comprehensive business proposal template that includes multiple interconnected action definitions 108a-n. The user 102 may begin by manually entering basic project information, such as “Project Name: Website Redesign” and “Client: ABC Corporation.” This initial manual input may trigger the first wave of automatic content generation.

With continued reference to FIG. 7, when the system 700 detects that the project name and client fields contain content, Action Definition A may automatically execute to generate a project overview section. This action definition may create content such as “This proposal outlines our approach for the Website Redesign project for ABC Corporation, including timeline, deliverables, and budget considerations.” The generation of this overview content may then trigger Action Definition B, which depends on the project overview to generate a detailed scope of work section.

As the scope of work section populates, Action Definition C may automatically activate to create a timeline based on the identified deliverables. The timeline generation may trigger Action Definition D, which calculates resource requirements based on the project duration and complexity. When the resource requirements become available, Action Definition E may execute to generate budget estimates, and Action Definition F may simultaneously create a risk assessment section based on the project scope and timeline.

From the user 102's perspective, this process may appear as a cascading series of document sections automatically appearing and filling with relevant content. The user 102 may observe the document expanding from their initial two-line input into a comprehensive multi-page proposal, with each new section triggering the generation of additional related content. The text generation module 120 may process each action definition as its dependencies become satisfied, creating a dynamic document building experience where the merge template 714 appears to intelligently construct itself based on the available information. In some cases, this wave process may pause while it waits for manual user input, if an action definition has an input that requires such manual user input. As a result, the wave process may be fully automated or may be punctuated by pauses which wait for required user input.

The system 700 may continue this process through multiple waves of content generation. For example, when the budget section completes, Action Definition G may generate a payment schedule, which may trigger Action Definition H to create contract terms, which may in turn activate Action Definition I to generate a signature block with appropriate legal language. Throughout this process, the document update module 124 may seamlessly integrate each piece of generated content into the evolving merged document 726, maintaining proper formatting and structure while the template builds itself out automatically.

One or more of the action definitions 108a-n may include data or otherwise be stored in a manner that explicitly specifies or otherwise indicates or provides hints about the order in which to execute some or all of the action definitions 108a-n. For example, some or all of the action definitions 108a-n may include explicit sequence identifiers, which may include explicit ordering information through numeric sequence identifiers that specify absolute execution order; decimal sequence values that enable fine-grained ordering control; named execution phases that group related processing steps; or priority values that determine relative execution order. In some cases, numeric sequence identifiers may use simple integer values such as 1, 2, 3 to establish a clear sequential order for action definition execution. Decimal sequence values may provide more granular control through values such as 1.1, 1.2, 2.1, enabling the insertion of additional action definitions between existing sequence points without requiring renumbering of the entire sequence. Named execution phases may organize action definitions into logical groups such as preprocessing, main processing, and postprocessing phases, allowing for structured execution workflows. Priority values may establish relative importance or urgency levels that determine the order in which action definitions are processed when multiple definitions are available for execution.

As another example, the system 700 may store, identify, and/or apply action definition ordering through structural mechanisms. Such structural mechanisms may include linked list structures connecting related action definitions, which enable sequential processing relationships between action definitions. The system 700 may also utilize tree structures representing hierarchical processing relationships, allowing for complex parent-child relationships between action definitions where higher-level action definitions may control or influence the execution of subordinate action definitions. In some cases, the system 700 may implement dependency graphs specifying execution prerequisites, which ensure that action definitions are executed in the correct order based on their interdependencies and requirements. The system 700 may employ processing queues managing execution sequences, which provide ordered processing of action definitions while maintaining system performance and resource allocation efficiency.

As another example, the system 700 may store, identify, and/or apply relative ordering of action definitions through various mechanisms. The system 700 may, for example, establish before/after relationships with other action definitions, enabling sequential processing where certain action definitions execute only after prerequisite action definitions have completed. The system 700 may implement dependencies on specific processing stages, allowing action definitions to be triggered based on the completion of particular phases within the document processing workflow. The system 700 may define relationships to document structure elements, where action definitions are associated with specific document components such as headers, paragraphs, or sections, ensuring that processing occurs in alignment with the document's organizational structure. The system 700 may support conditional execution based on processing state, where action definitions are activated or deactivated depending on the current status of the document processing operation, the results of previous action definitions, or other contextual factors within the merge template processing environment.

The ability of embodiments of the present invention to execute action definitions out-of-sequence represents a fundamental departure from conventional mail merge systems. Traditional mail merge functionality follows a strictly sequential processing model, applying merge fields in the exact order they appear in the template. This sequential limitation exists because conventional systems are designed for simple field substitution without interdependencies between merge fields, making more sophisticated processing capabilities unnecessary.

In contrast, embodiments of the present invention enable interdependencies between action definitions, allowing generated content to reference and build upon other generated content regardless of template position. This capability enables several significant advances over conventional merge processing. For example, the system 700 supports sophisticated content relationships through action definitions that process output from other actions appearing later in the template, generated content that adapts based on both prior and subsequent content, complex dependencies between multiple content elements, and bidirectional relationships between different document sections. These interdependencies may enable action definitions to create dynamic content that references outputs from subsequent processing steps, allowing for forward-looking content generation that anticipates and incorporates information that will be generated later in the template processing sequence. The system 700 may support content adaptation mechanisms where generated text modifies based on contextual information from both preceding and following document elements, creating coherent document flows that maintain consistency across all generated sections. In some cases, the complex dependencies between multiple content elements may enable cascading content generation where changes to one element automatically trigger updates to related elements throughout the document, maintaining document coherence while allowing for sophisticated content relationships that would be impossible with traditional sequential processing approaches.

These capabilities enable significantly more sophisticated document generation in various ways. For example, embodiments of the present invention may generate executive summaries that accurately reflect content from throughout the document by processing and synthesizing information from multiple document sections. The system may create table of contents entries that reference dynamically generated section content, ensuring that navigation elements remain synchronized with the actual document structure as content is generated and modified. Embodiments may maintain cross-references that preserve accuracy across generated elements, automatically updating reference relationships as content changes throughout the document processing workflow. The system may ensure document-wide consistency in generated content by applying coherent styling, terminology, and formatting standards across all generated sections and elements within the document.

The generative merge feature may be extended beyond creating individual document instances to generating entire hierarchies of related documents. In this extended implementation, merge templates serve as genetic templates that spawn not just individual documents, but document trees where each node represents a distinct document with inherited characteristics from its parent template.

When a merge template spawns a document, that spawned document may inherit the merge template's structural framework and embedded action definitions, enabling it to function as a template for generating its own child documents. This inheritance mechanism creates a recursive document generation system where each document in the tree maintains the capability to spawn additional documents while preserving the contextual relationships and constraints established by its ancestors.

The document tree structure enables sophisticated content organization patterns where documents can branch into specialized variations, drill down into detailed sub-topics, or expand into related domains while maintaining coherent relationships throughout the hierarchy. Each document node in the tree may contain its own merge data, action definitions, and spawning rules, allowing for complex document ecosystems that can evolve and expand based on user interactions or automated triggers.

This document tree generation capability transforms the merge template from a tool for creating parallel document instances into a foundation for building interconnected document networks that can grow and adapt over time while preserving the structural and contextual integrity established by the original template design.

The recursive content generation principles described herein may be extended from content-level operations to document-level operations. Just as dynamic content can generate more dynamic content within a document, merge templates can generate new merge templates that themselves can generate additional documents, creating hierarchical tree structures of related documents.

This document-level recursion may follow the same fundamental pattern as the content recursion disclosed herein, where the output of applying a merge template may include not only document content but also new merge templates with their own action definitions and spawning capabilities. When a merge template generates a child document, that child document may itself be and/or contain embedded one or more merge templates that can spawn their own descendants, enabling unlimited depth in document tree generation.

The recursive document architecture may, for example, use the same constraint inheritance and context preservation mechanisms described herein for content generation. Parent merge templates may propagate structural rules, formatting constraints, and/or contextual information to child templates, ensuring consistency across the document hierarchy while allowing for specialized adaptations at each level.

Each node in the document tree may represent a fully functional merge template capable of independent operation while maintaining its genealogical relationships. This enables document trees where different branches can evolve specialized characteristics while preserving their connection to the common ancestor template. The recursive generation process may continue indefinitely, with each generation potentially spawning new branches based on the action definitions and merge data available at that level.

This recursive document generation capability enables the creation of self-organizing document ecosystems where the initial merge template serves as the foundational genetic code that governs how the entire document family can evolve and expand over time.

The dynamic document tree features disclosed herein are not limited to use with the generative merge features disclosed herein. For example, the dynamic document tree features disclosed herein may be used in connection with other uses disclosed herein of the action processor 112 to generate text.

Referring to FIG. 1, if the action processor 112 in the system 100 uses the selected action definition 118 to generate the generated text 122 and then uses the document update module 124 to generate the updated document 126, the system 100 may apply any of the dynamic document tree techniques disclosed herein to make that updated document 126 part of a document tree. As this example illustrates, such a document tree may be generated and updated using any of the techniques disclosed herein, even if generative merge techniques are not used.

The action processor 112 may, for example, apply document tree generation techniques to any document processing operation that involves the selected text 116, the selected action definition 118, or the generated text 122. In some cases, the document update module 124 may create hierarchical relationships between the updated document 126 and other documents in the documents 110a-m, enabling the formation of document trees through any of the text generation and document update processes described herein.

Similarly, the generative cut and paste system 300 of FIG. 3 may create document trees when the text generation module 326 generates processed clipboard content 308 that spawns related documents. The painting system 500 of FIG. 5 may generate document trees through the painting configuration module 550, where painted text 512 in the destination document 514 may serve as a parent document for subsequently generated child documents.

For example, when the action processor 112 applies an action definition that generates content containing embedded action definitions or spawning instructions, the resulting generated text 122 may automatically trigger the creation of child documents. The document update module 124 may detect such spawning triggers within the generated text 122 and initiate document tree creation processes accordingly.

Any of the systems disclosed herein may coordinate document tree creation through their respective action processors and document update modules. The hierarchical relationships between parent and child documents may be maintained consistently across different system implementations, enabling seamless document tree management regardless of which system initiates the tree creation process. Users may control document tree creation through any of the user interfaces disclosed herein, including the user interface 104 of system 100, enabling selective approval of document spawning operations and management of hierarchical document relationships.

Embodiments of the present invention may implement document tree generation using either or both of the following approaches that balance computational efficiency with user experience requirements.

Eager Document Tree Generation: In eager generation, the system pre-generates one or more documents (nodes) in a document tree, e.g., by recursively applying merge templates with different data sets or contexts. Each node in the tree represents an actual generated document with fully realized content. For example, the system may process the root merge template and immediately generate some or all potential child documents based on the available merge data and action definitions. This process may continue recursively through one or more (e.g., each and every) level of the hierarchy. Eager generation provides immediate access to all documents in the tree without generation delays, enabling rapid navigation and comprehensive search capabilities across the entire document ecosystem. The approach may be particularly suitable for scenarios where the document tree size is bounded and computational resources are sufficient to generate all potential documents upfront. Each document node contains complete content and maintains full genealogical relationships with its ancestors and descendants.

Lazy Document Tree Generation: In lazy generation, the system creates abstract document trees showing potential documents without generating actual content until accessed. Documents are only realized when accessed, using the same just-in-time generation principles described for content elements. The system initially creates a tree structure containing merge template specifications and metadata for each potential document node, but defers content generation until a user or process specifically requests a particular document. This approach enables the exploration of potentially infinite document trees without requiring unlimited computational resources. Users may navigate through the abstract tree structure, preview potential documents through metadata and summaries, and selectively realize only the documents they need. The lazy generation strategy maintains the same context inheritance and constraint propagation mechanisms while optimizing resource utilization by generating content only when required.

The system may combine both approaches within a single document tree, such as by using eager generation for frequently accessed or critical documents while applying lazy generation to less commonly needed branches. This hybrid strategy enables optimization based on usage patterns and resource constraints while maintaining the full capabilities of the recursive document generation system.

The multiple merge data sets concept may be extended to include hierarchical data structures where each data set can specify child data sets, creating natural tree relationships that correspond to document tree structures. In this enhanced implementation, the merge data 730 may be organized as a hierarchical structure where individual data sets contain not only their own merge field values and action definition data, but also references or specifications for child data sets that should be used to generate descendant documents.

Each data set within the hierarchical merge data structure may include metadata that defines its relationships to other data sets, such as parent-child relationships, sibling relationships, and inheritance rules. This hierarchical organization enables the merge template processing system to follow the data relationships automatically when generating corresponding document trees, ensuring that the document hierarchy mirrors the logical structure of the underlying data.

The merge template processing may traverse the hierarchical merge data structure systematically, applying the root merge template to the top-level data set to generate the root document, then recursively processing each child data set to generate the corresponding child documents. During this traversal, the system may propagate contextual information and constraints from parent data sets to child data sets, maintaining consistency across the document tree while allowing for specialized adaptations at each level.

This hierarchical approach enables sophisticated document generation scenarios where the structure of the document tree is determined by the logical relationships inherent in the data itself. For example, an organizational chart data structure could automatically generate a corresponding hierarchy of employee profile documents, or a product catalog structure could spawn detailed specification documents for each product category and individual product.

The system may support various hierarchical data formats, including nested JSON structures, XML hierarchies, database relationships with foreign keys, and custom data models that define parent-child relationships. This flexibility allows the document tree generation capability to integrate with existing data systems while maintaining the powerful recursive generation and constraint inheritance mechanisms established for the merge template processing system.

Embodiments of the system may implement speculative search capabilities that enable users to search not only through realized document content but also through potential content that has not yet been generated. This speculative search functionality may extend conventional search operations to explore the possibility space of both document trees and individual documents, providing search results for content that could exist based on embedded action definitions and merge templates. The speculative search may operate across the documents 110a-m (FIG. 1) and may utilize the action definitions 108a-n stored in the action definition library 106 to identify potential content matches.

When performing speculative search, embodiments of the system may analyze both generated content that exists as actual content and abstract content elements that represent potential content. For realized content, the search may operate using conventional text matching and semantic analysis techniques applied to the documents 110a-m. For potential content, the action processor 112 may compute match probabilities based on the action definitions 108a-n, merge templates, and contextual data that would be used to generate that content. The text generation module 120 may be consulted to evaluate the likelihood that applying specific action definitions would produce content matching the search query.

In the case of single documents, embodiments of the system may analyze potential content that could be generated by applying action definitions 108a-n to selected text 116 or elements within that document, enabling speculative search within individual documents. The action processor 112 may evaluate how different action definitions would transform existing text elements to produce content that matches search criteria. In the case of document hierarchies, the system may analyze potential content across multiple related documents within the documents 110a-m, enabling speculative search across document hierarchies by considering how merge templates and action definitions would generate content in different document contexts.

The speculative search may return results in multiple categories through the user interface 104. Realized results may represent actual matches found in existing content within the documents 110a-m. Potential results may indicate high-probability matches in ungenerated content, where the action processor 112 determines that generated text 122 would likely contain the search query based on analysis of the underlying prompts and context from the action definitions 108a-n. Speculative results may represent lower-probability but possible matches where the search terms might appear in generated content under certain conditions. These categories may apply whether the speculative search is performed within a single document or across multiple documents in a tree structure, with the user interface 104 presenting the results in a manner that distinguishes between the different probability levels.

Embodiments of the system may implement probabilistic matching algorithms that evaluate whether content generated from specific action definitions 108a-n would likely contain the search query. This analysis may consider semantic similarity between the search terms and the action definition prompts stored in the action definition library 106, contextual relevance based on merge data, and historical patterns of content generation for similar prompts. The text generation module 120 may, for example, evaluate how applying a selected action definition 118 to a particular word, phrase, or selected text 116 within the document would likely produce generated text 122 matching the search query. The external data 128 may also be analyzed to determine how additional context would influence the probability of generating matching content.

When users select potential or speculative search results through the user interface 104, embodiments of the system may perform just-in-time generation of the corresponding content to realize the text and confirm the match. This approach may enable users to discover relevant information without requiring pre-generation of all possible content variations. In single-document contexts, this may involve the action processor 112 applying action definitions 108a-n to specific text elements to generate the potential content that was identified during the speculative search process. The text generation module 120 may generate the actual content on demand, and the document update module 124 may integrate the generated text 122 into the document structure to create an updated document 126 that contains the realized search result.

The speculative search capability may support various search strategies implemented through the action processor 112, including semantic concept searches that identify content likely to contain related ideas even when specific terms do not appear in the prompts of action definitions 108a-n, temporal searches that find content that would match queries at future time points, and counterfactual searches that explore content that would exist under different assumptions or conditions. These search strategies may be applied within individual documents by considering how action definitions would transform existing text elements, as well as across document trees by analyzing potential document variations. The external data 128 may provide additional context for these advanced search strategies, enabling more sophisticated analysis of potential content generation scenarios.

This comprehensive search functionality may transform both individual documents and document trees from static content into explorable knowledge spaces where users can discover both existing and potential information through intelligent search operations that understand the generative capabilities and recursive structure of the content ecosystem. Within a single document, users may search through potential content that could be generated by applying various action definitions 108a-n to different text elements, while across document trees, users may explore potential documents and their relationships within the hierarchical structure. The user interface 104 may present these search capabilities in an intuitive manner that allows users to navigate between realized and potential content seamlessly.

The speculative search capabilities described herein may be extended to operate across entire document trees, enabling users to search through both realized and potential documents within the tree structure. This extension may transform the search functionality from operating on individual documents 110a-m to exploring the complete possibility space of document hierarchies. The action processor 112 may coordinate search operations across multiple levels of document trees, analyzing how different combinations of action definitions 108a-n and merge data would generate content at various nodes in the hierarchy.

When performing speculative search across document trees, embodiments of the system may analyze both generated documents that exist as actual content and abstract document nodes that represent potential documents in the tree structure. For realized documents within the documents 110a-m, the search may operate using conventional text matching and semantic analysis. For potential documents, the action processor 112 may compute match probabilities based on the merge templates, action definitions 108a-n, and hierarchical merge data that would be used to generate those documents. The text generation module 120 may evaluate the likelihood of generating matching content at different levels of the document hierarchy, considering how parent-child relationships between documents would influence content generation.

The search results may be organized hierarchically through the user interface 104 to reflect the document tree structure, showing users not only where matches occur but also the genealogical relationships between matching documents. Users may navigate search results by exploring different branches of the document tree, understanding how potential matches relate to their parent and child documents within the hierarchy. The user interface 104 may provide visual representations of the document tree structure that highlight both realized and potential matches, enabling users to understand the context and relationships of search results within the broader document ecosystem.

Embodiments of the system may implement lazy search expansion across document trees, where search operations progressively explore deeper levels of the tree structure based on match probabilities and user interest. High-probability matches in abstract document nodes may trigger just-in-time generation of those documents through the text generation module 120 to provide more detailed search results, while lower-probability branches may remain unexplored to optimize computational resources. The action processor 112 may manage this progressive exploration by prioritizing the evaluation of action definitions 108a-n that are most likely to produce matching content, thereby efficiently allocating processing resources while maintaining comprehensive search coverage.

Speculative search across document trees may enable sophisticated query scenarios such as finding all documents in a tree that would contain specific information, identifying potential document paths that lead to desired content, and discovering relationships between concepts across different branches of the document hierarchy. The search functionality may also support temporal queries that explore how document trees might evolve over time based on changing merge data or updated action definitions 108a-n. The external data 128 may provide temporal context that influences how the action processor 112 evaluates potential content generation scenarios across different time periods, enabling users to search for content that would be relevant at specific points in time or under changing conditions.

This comprehensive search capability may transform document trees from static hierarchies into explorable knowledge spaces where users can discover both existing and potential information through intelligent search operations that understand the recursive structure and generative capabilities of the document ecosystem. The integration of the action processor 112, text generation module 120, and user interface 104 may enable seamless navigation between realized and potential content, providing users with unprecedented access to the full possibility space of document-based knowledge systems.

Embodiments of the system may implement speculative search using a process that analyzes both realized and potential content. The speculative search process may begin when the user interface 104 receives a search query from the user 102. The action processor 112 may then analyze the documents 110a-m to identify existing content that matches the search query using conventional text matching techniques. The action processor 112 may evaluate the action definitions 108a-n stored in the action definition library 106 to identify potential content that could be generated and would likely match the search query.

The action processor 112 may compute match probabilities for potential content by analyzing semantic relationships between the search query and the prompts contained within the action definitions 108a-n. For each action definition, the action processor 112 may evaluate how applying that action definition to specific text elements would likely produce content containing the search terms. The text generation module 120 may be consulted to provide probability estimates based on language model capabilities and historical generation patterns. The external data 128 may provide additional context that influences these probability calculations, enabling more accurate predictions of potential content matches.

The user interface 104 may present search results in categorized format, distinguishing between realized matches found in existing content, potential matches with high probability of containing the search query, and speculative matches with lower but possible probability. When users select potential or speculative results through the user interface 104, the action processor 112 may trigger just-in-time content generation by applying the relevant action definition to the identified text element. The text generation module 120 may generate the actual content, which the document update module 124 may then integrate into the document structure to create an updated document 126 containing the realized search result.

For document tree scenarios, the speculative search process may extend across multiple document levels by analyzing hierarchical relationships and potential document generation paths. The action processor 112 may evaluate how different combinations of merge data and action definitions 108a-n would generate content at various nodes in the document tree, computing match probabilities for potential documents that do not yet exist. The system 100 may implement lazy expansion techniques where high-probability matches trigger progressive exploration of deeper tree levels, while lower-probability branches remain unexplored until user interest or additional context warrants their evaluation.

Embodiments of the document tree generation capabilities may build on the recursive generation engine, constraint inheritance system, and context preservation mechanisms described herein. This approach may require minimal additional technical infrastructure while expanding the system's capabilities from individual document processing to document ecosystem management.

The recursive generation engine that enables dynamic content to spawn additional dynamic content within documents may operate at the document level, where merge templates spawn child documents that themselves contain merge templates. The same algorithmic foundations, processing loops, and generation logic may apply to both content-level and document-level operations.

The constraint inheritance system may maintain its architecture when extended to document trees. Parent merge templates may propagate constraints, formatting rules, and contextual parameters to child documents using the same inheritance mechanisms established for content generation. The system may preserve the ability to enforce semantic boundaries, maintain consistent styling, and apply constitutional constraints across multiple generations.

Context preservation mechanisms may function across document boundaries, maintaining the accumulated context, user preferences, and environmental parameters that inform generation decisions. The context management system may maintain hierarchical context relationships that extend from content elements to document nodes.

This approach may leverage the existing foundation while extending it to document-level operations. The text generation module 120, document update module 124, and action definition processing systems may operate without modification, applying their existing capabilities to document tree nodes rather than individual content elements. The user interface 104 and action processor 112 may maintain their established interaction patterns while supporting the expanded scope of operations.

The integration may ensure that existing features, optimizations, and safeguards automatically apply to document tree operations, providing a foundation for the expanded capabilities while minimizing implementation complexity and maintaining system reliability.

The system may implement a “quantum” pre-generation approach that generates multiple variations of content simultaneously and stores them in a superposition state until user selection collapses the superposition to a specific version. This approach enables the system to prepare content optimized for different contexts or user preferences without knowing in advance which version will be needed.

When processing a document node, the quantum pre-generation system may generate multiple variations of the same content concurrently, such as detailed, summary, technical, and simplified versions. These variations are stored together in what may be termed a “superposition,” where all potential versions exist simultaneously within the system until a selection mechanism determines which version to manifest.

The collapse of the superposition to a specific version may occur through various selection mechanisms. The user may manually select from the available variations through the user interface, choosing the version that best meets their immediate needs. Alternatively, the system may automatically select the most appropriate variation based on stored user profile data, which may include preferred writing styles, technical expertise levels, reading preferences, or historical interaction patterns.

The quantum pre-generation approach may be implemented through a class structure that manages the superposition state and collapse mechanism. Each generated variation may include metadata describing its characteristics, target audience, complexity level, and other distinguishing features. The collapse process evaluates these characteristics against the selection criteria to identify the optimal match.

This approach provides several advantages over sequential generation methods. Users experience immediate access to appropriately tailored content without waiting for generation to occur after their preferences are known. The system can optimize content for multiple potential use cases simultaneously, ensuring that regardless of user needs or context changes, suitable content is readily available.

The quantum pre-generation method may be particularly effective in scenarios where user preferences are variable or unknown at generation time, where content needs to serve multiple audiences, or where rapid response times are critical to user experience. The superposition state enables the system to maintain multiple potential content states until the moment of user interaction determines which state becomes reality.

Embodiments of the present invention may implement quantum pre-generation capabilities that enable text generation modules to generate multiple variations of content simultaneously when applying action definitions to selected text. For example, referring to FIG. 1, embodiments of the system 100 may implement such quantum pre-generation capabilities in the text generation module 120 when applying action definitions 108a-n to selected text 116. The quantum pre-generation approach may operate by generating a plurality of content variations concurrently through the application of a single selected action definition, storing these variations in a superposition state until a selection mechanism determines which variation to manifest as generated text. Although such quantum pre-generation capabilities may be described in connection with FIG. 1, this is merely an example; such quantum pre-generation capabilities may be implemented in connection with any of the techniques disclosed herein.

When the action processor 112 applies the selected action definition 118 to the selected text 116, the text generation module 120 may generate multiple distinct variations of output content rather than producing a single instance of generated text 122. These variations may differ in characteristics such as writing style, complexity level, tone, length, or technical detail while all being responsive to the same selected action definition 118 and selected text 116. The system 100 may store all generated variations simultaneously in what may be termed a superposition state, where each variation exists as a potential candidate for the generated text 122 until a selection process determines which variation becomes the actual generated text 122.

The quantum pre-generation process may leverage the stochastic nature of language models to produce diverse content variations from identical inputs. When the text generation module 120 provides a prompt derived from the selected action definition 118 and selected text 116 to a language model, the system 100 may execute multiple inference operations with the same prompt to generate different outputs due to the probabilistic sampling mechanisms inherent in language model processing. Each inference operation may produce a distinct variation that represents a different potential realization of the generated text 122, enabling the system 100 to explore multiple possibilities within the content generation space defined by the selected action definition 118.

With continued reference to FIG. 1, the superposition state may be maintained through data structures that store multiple content variations along with associated metadata describing the characteristics of each variation. The metadata may include information such as complexity scores, readability metrics, tone classifications, length measurements, or semantic similarity scores relative to the selected text 116. This metadata enables the system 100 to evaluate and compare variations during the selection process, providing quantitative measures for determining which variation best matches specified criteria or user preferences.

The collapse of the superposition to a specific variation may occur through various selection mechanisms implemented by the action processor 112. In some cases, the user 102 may manually select from the available variations through the user interface 104, with the system 100 presenting multiple options and enabling the user 102 to choose the variation that best meets their immediate needs. The user interface 104 may display the variations simultaneously or sequentially, potentially with preview capabilities that allow the user 102 to evaluate each option before making a selection. Alternatively, the system 100 may automatically select the most appropriate variation based on stored user profile data, historical interaction patterns, or contextual analysis of the document containing the selected text 116.

Referring to FIG. 2, the quantum pre-generation process may be integrated into the method 200 at operation 210, where the application of the selected action to the selected text generates multiple variations rather than a single output. The method 200 may include an additional operation between operation 210 and operation 212 where the system selects one variation from the multiple generated variations before updating the selected document. This selection operation may involve presenting the variations to the user through the user interface 104 for manual selection, or automatically selecting a variation based on predetermined criteria or learned user preferences.

The quantum pre-generation approach may provide several technical advantages over sequential generation methods. The system 100 may reduce response latency by pre-generating multiple content options before user preferences are fully determined, enabling immediate presentation of appropriately tailored content once selection criteria become available. The approach may also improve content quality by enabling comparative evaluation of multiple generated options, allowing the system 100 to select variations that best meet specific quality metrics or user requirements. Additionally, the quantum pre-generation method may enhance user experience by providing choice and control over generated content while maintaining the efficiency benefits of automated text generation.

The superposition state management may include mechanisms for handling memory allocation and computational resource optimization. The system 100 may implement configurable limits on the number of variations generated simultaneously, balancing content diversity against system performance requirements. The system 100 may also include garbage collection mechanisms that automatically release unused variations after selection occurs, preventing memory accumulation during extended operation periods. In some cases, the system 100 may implement lazy evaluation techniques where certain variations are generated on-demand during the selection process rather than being fully realized during the initial generation phase.

The quantum pre-generation feature may be particularly effective when applied to action definitions 108a-n that benefit from multiple interpretation possibilities or when the selected text 116 contains ambiguous elements that could be processed in different ways. For example, when applying an action definition 118 that involves summarization, the text generation module 120 may generate variations with different levels of detail, different organizational structures, or different emphasis on various aspects of the selected text 116. Similarly, when applying an action definition 118 that involves style transformation, the system 100 may generate variations that interpret the target style in different ways or that apply the transformation with varying degrees of intensity.

The system may implement a recursive document reproduction capability that enables documents to spawn additional documents through embedded prompt elements. This recursive architecture creates self-reproducing document systems where each generated document contains the capability to generate further documents, enabling unlimited expansion of document hierarchies.

The recursive reproduction process may begin with generating a parent document that contains at least one embedded prompt element. These embedded prompt elements comprise action definitions that specify instructions for content generation using language models. The embedded prompt elements may be stored within the document structure using any of the embedding methods described herein, including metadata-based storage, field-based implementation, or external reference systems.

When an embedded prompt element is activated, the system executes a spawning operation that creates a child document separate from the parent document. The child document contains content generated by applying the embedded prompt element's specifications to a language model. This spawning process creates a distinct document entity while maintaining genealogical relationships with the parent document through the relationship tracking mechanisms described herein.

The content generated during the spawning operation automatically includes at least one new embedded prompt element within the child document. This ensures that the child document possesses the same reproductive capability as its parent, enabling it to serve as a parent document in subsequent iterations of the spawning process. The new embedded prompt elements may inherit contextual information and constraints from the parent document while potentially introducing specialized characteristics based on the generated content.

This recursive structure enables unlimited document reproduction, where each generation of documents can spawn additional generations through the same spawning mechanism. The recursive process maintains the constraint inheritance and context preservation mechanisms established for content generation, ensuring consistency across multiple generations while allowing for evolutionary adaptations at each level.

The recursive document reproduction capability transforms individual documents into self-expanding document ecosystems. Each document in the hierarchy maintains both its individual content and its generative potential, creating networks of related documents that can grow and evolve based on user interactions or automated triggers. The system preserves genealogical relationships throughout the recursive reproduction process, enabling navigation and management of complex document family trees.

Embodiments of the present invention may expand upon traditional mail merge capabilities by integrating generative AI functionality. Unlike conventional mail merge systems that substitute basic field values within templates, embodiments may enable dynamic content generation and transformation through action definitions that may use generative AI such as LLMs.

By incorporating action definitions into merge templates, embodiments may enable documents to be customized beyond simple data insertion. When processing action definitions within a template, embodiments may use language models to generate contextually appropriate content, allowing for transformations that may adapt to both the document author's message and the readers' preferences.

Referring to FIG. 7, the system 700 may process multiple sets of merge data while applying AI-driven transformations to enable mass personalization. Each generated document instance may incorporate customized field values and AI-generated content tailored to specific contexts, audiences, or requirements. This combination of traditional merge functionality with generative AI capabilities may enable organizations to create personalized documents at scale while maintaining consistency and quality.

The merge template 714 may allow authors to define sophisticated transformation rules through action definitions, enabling context-aware content generation that adapts to specific recipient characteristics and document contexts. Embodiments may support style and tone adaptations, dynamic text transformations, audience-specific content modifications, and complex content restructuring based on merge data characteristics and action definition specifications.

These capabilities may enable document customization and personalization that was previously impossible with conventional mail merge systems, while maintaining the efficiency and scalability benefits of automated document generation.

With continued reference to FIG. 7, embodiments may enable document authors to maintain control over document structure while allowing dynamic content generation. The merge template 714 may allow authors to define the structure and purpose of document elements, including where action definitions 108a-n, merge fields, and static content should appear. Authors may specify how content should be generated through customizable action definitions 108a-n stored within the action definition library 106, ensuring the generated text 122 aligns with the author's intent while enabling personalization based on merge data 730.

The system 700 may balance automation and control by allowing authors to define which elements remain static and which may be dynamically generated. The document update module 124 may process the generated text 122 to ensure that transformations maintain the structural integrity defined by the merge template 714 while incorporating personalized content based on the specific merge data element 716 being processed.

Embodiments may enable large-scale structured personalization through the ability to process multiple sets of merge data to generate distinct document instances. The system 700 may process multiple sets of merge data within the merge data 730, with each set being used to generate a distinct instance of the merged document 726. This may enable the creation of numerous personalized documents from a single merge template 714, with enhanced capabilities through the integration of action definitions 108a-n and the text generation module 120.

For each document instance, the system 700 may maintain the author-defined template structure while applying action definitions 108a-n consistently across all generated documents. The action processor 112 may process merge fields with instance-specific data from the merge data 730, and the text generation module 120 may generate AI-driven content tailored to each specific context. This approach may enable organizations to generate large numbers of personalized documents while maintaining consistent structure and quality.

Embodiments may seamlessly integrate advanced AI capabilities, particularly large language models, into document creation workflows. By incorporating action definitions that leverage LLMs, embodiments may allow users to apply complex text transformations and generate context-aware content directly within the merge template. When processing an element identified as an action definition, the system may provide a prompt specified by the action definition to a large language model, generating output that is then inserted into the merged document.

This approach may combine the power of AI-driven content generation with the familiarity of traditional document merge processes. Users may create merge templates that include conventional merge fields and AI-powered transformations within a single workflow. The integration may enable dynamic and context-aware content generation, complex text transformations, and maintain the efficiency and scalability of traditional merge operations while adding the flexibility of AI-generated content.

Embodiments may provide users with flexibility in customizing and controlling the document generation process. The system may support varying degrees of user involvement, from fully automated processing to detailed interactive refinement. At the automated end, embodiments may process merge templates and generate documents with minimal user intervention. For users requiring more control, embodiments may support interactive refinement through selection and modification of action definitions, review and adjustment of generated content, and customization of processing workflows.

By supporting this range of user involvement, embodiments may enable organizations to balance automation efficiency with the need for control over document content and quality. This flexibility may allow the system to adapt to different use cases, from high-volume automated document generation to carefully crafted, individually refined documents.

The various systems and methods disclosed herein may be implemented and/or executed across a plurality of computers and/or software modules in a variety of ways. Embodiments of the present invention may support distributed implementations where the user interface 104 may be implemented on the user's local computer while other components such as the action processor 112 may be implemented on one or more remote servers. Components may communicate across a network using APIs and other interfaces, and the system may support cloud-based implementations where generative processing happens server-side while conventional operations occur client-side.

Embodiments of the present invention may utilize modular architectures where functions can be performed by multiple modules in any combination, including separate software applications. Some functions may be performed by conventional components such as word processing applications while others are performed by specialized components such as plugins. The system may support hybrid approaches leveraging existing functionality while implementing novel features on top of established platforms.

Various implementation options may be employed across different deployment scenarios. Embodiments may include standalone applications with custom-implemented components for maximum control, plugins or extensions for existing software that use host application functions while implementing custom processing logic, cloud services with client-side clipboard operations and server-side generative processing, or mobile apps using device native APIs with custom user interface and processing logic. These implementation approaches may be selected based on specific deployment requirements and technical constraints.

Communication between system components may be facilitated through various methods depending on the implementation architecture. Standard operating system APIs may be used for basic operations, while event listeners may detect and respond to user actions. Custom clipboard formats may handle metadata transmission, and Inter-Process Communication (IPC) may coordinate between conventional and generative components. System-level hooks may provide deep integration capabilities where supported by the underlying platform.

Embodiments of the present invention may implement distributed architectures where various modules and operations are distributed across multiple computers to optimize performance and resource utilization. In a two-computer distribution configuration, the user interface 104 and basic operations may be implemented on a local computer, including document editing and selection capabilities, conventional copy and paste operations, and document display with basic editing functionality. The processing server in such configurations may handle the action processor 112 including language model operations, the text generation module for processing action definitions, and storage of the action definition library.

Three-computer distribution architectures may provide enhanced separation of concerns by implementing a local client that handles the user interface 104, document editing and display, and selection handling operations. An application server in such configurations may manage action processor 112 coordination, action definition management, and the document update module. The AI processing server may be dedicated to language model operations, text generation processing, and complex transformations that require significant computational resources. This separation enables specialized optimization of each component while maintaining system coherence across the distributed architecture.

Multi-server distribution configurations may implement even greater specialization through dedicated server roles. The local client may continue to handle the user interface 104 and document editing functions, while a template server manages storage and management of merge templates along with the action definition library. Processing servers may handle distributed language model processing and parallel processing of multiple document instances, enabling scalable operations across large document sets. A storage server may manage document storage and external data management, providing centralized data access while supporting distributed processing operations. These multi-server architectures enable embodiments of the present invention to scale efficiently while maintaining performance across complex document processing workflows.

Traditional document editing tools provide limited capabilities for automated content analysis and revision. While conventional spell checkers and grammar checkers can process document elements in the background and suggest corrections, they are restricted to fixed rule sets and cannot perform sophisticated content transformations.

In contrast, certain embodiments of the present invention automatically analyze and revise documents through the application of action definitions to document elements. The action definitions may be user-defined. The system processes elements within a document automatically and in the background, applying one or more action definitions to generate suggested revisions that can be reviewed and selectively applied by users.

One aspect of such embodiments is the ability to define custom action definitions that specify how document elements should be processed and transformed. These action definitions may include prompts for language models (e.g., large language models), enabling sophisticated content generation and transformation beyond simple rule-based corrections. When applying an action definition to a document element, the system may generate a processed prompt by combining the element's content with the action definition's specifications. This processed prompt may be provided to a language model to generate output that forms the basis for suggested document revisions.

The system may process document elements automatically in the background, identifying applicable action definitions and applying them to generate output. This output may be manifested to a user as suggested revisions. When the user accepts a suggestion for a particular document element, the system may apply the corresponding transformation to revise that element, producing an updated version of the document.

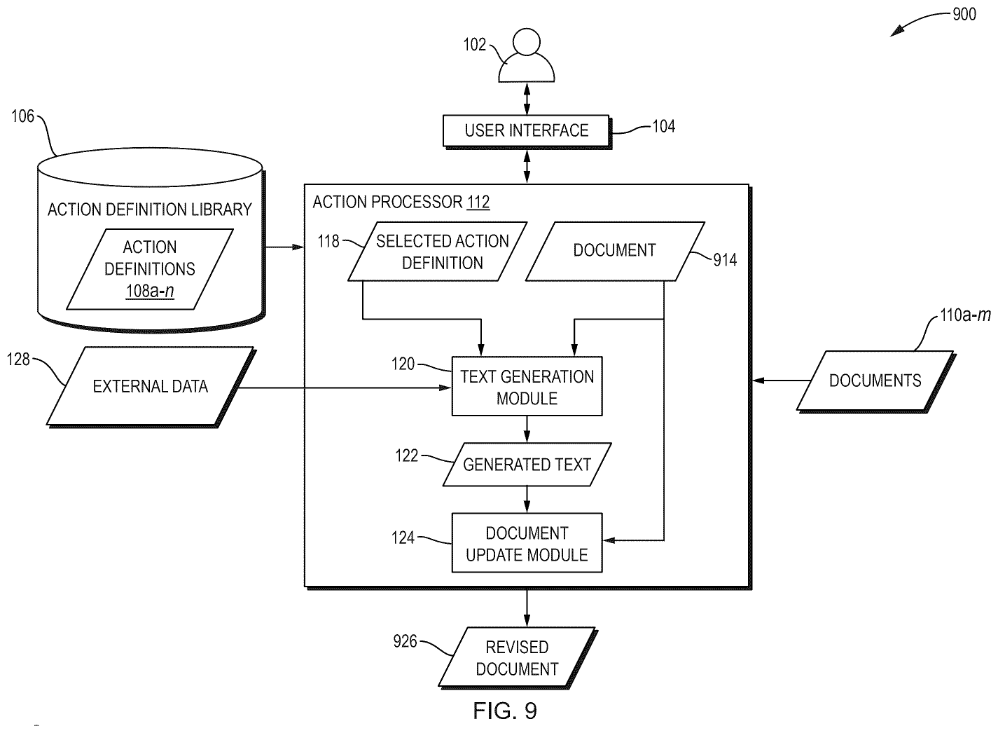

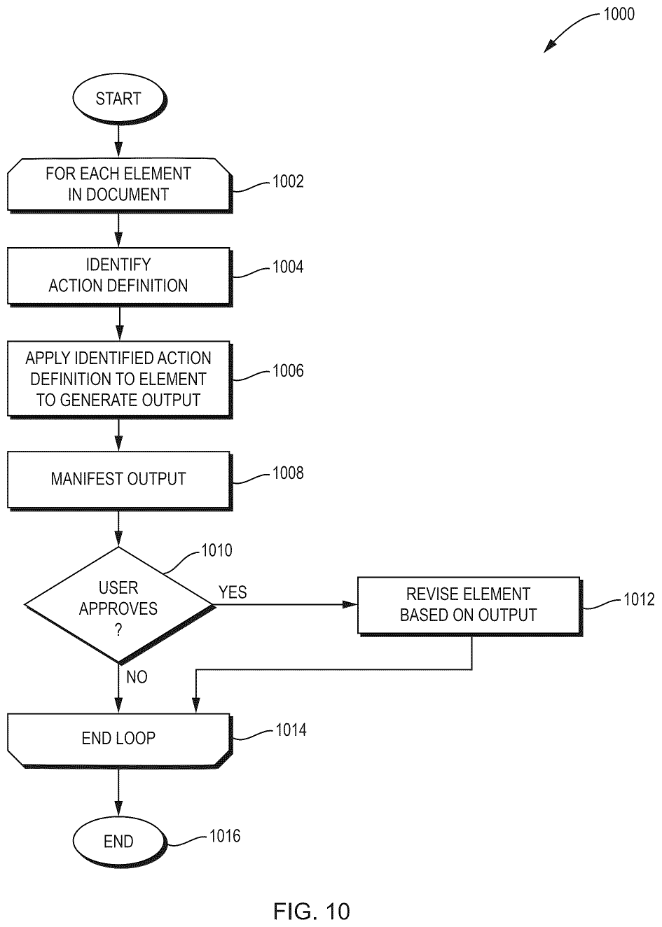

Referring to FIG. 9, a dataflow diagram 900 is shown of a system for implementing an automated document revision feature according to one embodiment of the present invention. Referring to FIG. 10, a flowchart is shown of a method 1000 performed by the system 900 of FIG. 9 according to one embodiment of the present invention.

The method 1000 enters a loop over each of a plurality of elements in the document 914 (FIG. 10, operation 1002). The loop being iterated over in the current iteration of the loop is referred to herein as “the current element” or “element E”.

For each element E, the system 900 identifies an action definition to apply to that element (FIG. 10, operation 1004). The identified action definition 118 may be selected from among the action definitions 108a-n stored in the action definition library 106. The identified action definition becomes the selected action definition 118 for processing the current element. The system 900 may identify the selected action definition 118 automatically in any of a variety of ways, some of which are described below.

The system 900 then applies the selected action definition 118 to element E to generate output (FIG. 10, operation 1006). This application may, for example, be performed by the text generation module 120, which processes the current element according to the selected action definition 118. If the selected action definition 118 includes a prompt for a language model (such as an LLM), the text generation module 120 may generate a processed prompt based on both the content of element E and the prompt in the selected action definition 118, provide the processed prompt to a language model, which produces output that becomes the generated text 122.

The system 900 may manifest the generated text 122 to the user 102 via the user interface 104 (FIG. 10, operation 1008). This manifestation may, for example, present a potential revision suggestion to the user 102 for review.

The system 900 determines whether the user 102 approves of the manifested output (FIG. 10, operation 1010). This approval may be received through the user interface 104.

If the user 102 approves the output, the document update module 124 revises element E based on the generated output (FIG. 10, operation 1012), thereby producing a revised version of the document 926. The document update module 124 may revise element E in response to the user 102 approving the output. If the user 102 does not approve, the element E may remain unchanged.

The system 900 determines whether to continue processing additional elements (FIG. 10, operation 1014). If there are remaining unprocessed elements in document 914, the method 1000 returns to operation 1004 to process the next element. Otherwise, the method 1000 ends (FIG. 10, operation 1016).

This iterative process enables automated processing of document elements while maintaining user control over which suggested revisions are applied to produce the final revised document 926.

Some or all of the operations in method 1000 may be performed automatically. Some or all of the operations in method 100 may be performed in the background. Some or all of the operations in method 1000 may be performed automatically and in the background. For example, all of operations 1002, 1004, 1006, and 1008 may performed automatically (and optionally in the background). In some embodiments, some or all iterations of the method 1000 are performed automatically (and optionally in the background) with operations 1008, 1010, and 1012 omitted, so that the method 1000 processes a plurality of document elements using operations 1002, 1004, 1006, and 1014 automatically (and optionally in the background) before manifesting any output to the user 102.

This approach may enable batch processing of multiple elements without interrupting user workflow, complete analysis before manifesting any suggestions, and efficient use of system resources through uninterrupted processing. For example, embodiments of the system 900 may process all document elements in a single operation, allowing the text generation module 120 to analyze and generate outputs for multiple elements before presenting any results to the user 102. This may provide improved system efficiency by reducing the number of individual processing requests and may allow for more comprehensive analysis of document content relationships across multiple elements.

Even further, in some embodiments, the system 900 may perform operation 1004 (identification of the action definition) before initiating the loop at operation 1002. This enables the system 900 to identify a single action definition that will be applied across a plurality of document elements before beginning element processing. For example, the system 900 may identify and apply a single action definition to all document elements in the loop of operations 1002-1014.

After identifying the action definition, the method 1000 may then execute a streamlined loop consisting of operation 1002 (iterating over document elements), operation 1006 (applying the pre-identified action definition to generate output), and operation 1014 (checking for loop completion). This approach may enable more efficient processing by eliminating the need to repeatedly identify action definitions for each document element during the loop execution.

This approach may provide several benefits, such as improved processing efficiency by identifying the action definition once rather than for each element, enabling batch processing of multiple elements using the same action definition, supporting background processing without requiring repeated action definition identification, and allowing the system to defer output manifestation until after processing multiple elements. For example, the system 900 may process hundreds or thousands of document elements using a single action definition without the computational overhead of repeatedly identifying the same action definition. This streamlined processing may be particularly advantageous when applying consistent transformations across large documents or when processing multiple documents with similar content structures. The ability to identify an action definition before element processing aligns with the system's background processing capabilities, enabling efficient batch operations while maintaining the flexibility to manifest results to the user 102 at appropriate times. This represents an optimization over approaches that identify action definitions separately for each element.

Although FIG. 10 shows a loop-based implementation, the system 900 and method 1000 may process document elements using non-loop approaches. For example, the system 900 may support asynchronous and background processing of elements in document 914, similar to how conventional word processors perform continuous spell checking and grammar checking. The system 900's event-based design enables flexible processing approaches including background processing, event-driven processing, and real-time content analysis.

Background processing may include continuous monitoring of document content for processing opportunities, asynchronous application of action definitions to elements, processing elements as they are modified or created, and parallel processing of multiple elements simultaneously. Event-driven processing may encompass processing elements in response to specific triggers or events, real-time dynamic interaction between user and system, support for asynchronous document revisions, and the ability to process any part of the document at any time. The system 900 may implement non-loop processing through event handlers triggered by specific document actions, background processing threads monitoring document state, asynchronous processing queues for element transformation, and real-time content analysis and processing.

The system 900 may implement various optimization techniques to achieve real-time performance. For example, embodiments of the system 900 may employ predictive processing techniques that pre-generate likely outputs based on gesture trajectories, cache commonly used transformations, anticipate potential next actions, and/or dynamically predict user interaction patterns. This predictive approach may enable the system 900 to respond more quickly to user gestures by having relevant content ready before the user completes their interaction.

Embodiments of the system 900 may implement caching strategies to improve performance. For example, the system 900 may utilize a multi-level cache architecture for storing frequently used action definitions, common transformation results, intermediate processing outputs, and generated text variations. The system 900 may further employ context-aware cache management that adapts to the current document state and user workflow. The system 900 may implement adaptive cache invalidation based on content updates and may utilize distributed cache systems across processing nodes to ensure efficient access to cached data regardless of where processing occurs.

Performance optimization in embodiments of the system 900 may include incremental processing of gesture-based transformations, which allows the system to process user interactions in stages rather than waiting for complete gesture completion. The system 900 may implement progressive loading of generated content, enabling users to see results as they are generated rather than waiting for complete processing. Furthermore, the system 900 may utilize parallel processing of multiple potential outputs, resource-aware task scheduling that adapts to available computational resources, and dynamic load balancing across processing nodes to ensure optimal performance across different hardware configurations and usage scenarios.

The system 900 may implement various caching mechanisms to improve performance and efficiency. For example, the system 900 may implement action definition caching, which may include storing preprocessed versions of action definitions, caching transformed representations, maintaining frequently used prompt variations, and/or implementing dynamic cache updates based on usage patterns. The action definition caching may enable the system 900 to avoid repeated processing of commonly used action definitions by maintaining ready-to-use versions in memory or storage.

The system 900 may implement result caching mechanisms to store and reuse previously generated outputs. For example, result caching may include storing generated outputs for common transformations, caching intermediate processing results, maintaining context-specific transformation results, and/or implementing progressive cache population during idle periods. This approach may enable the system 900 to provide faster response times for repeated or similar processing requests by retrieving cached results rather than regenerating content.

In some embodiments, the system 900 may implement a distributed cache architecture to coordinate caching across multiple processing nodes. The distributed cache architecture may include coordinated caching across multiple processing nodes, hierarchical cache organization, cache synchronization protocols, and/or adaptive cache distribution based on load. This distributed approach may enable the system 900 to scale caching capabilities across multiple computing resources while maintaining consistency and optimal performance across the distributed system.

These optimization and caching strategies may enable the system to maintain responsive performance during gesture-based interactions by minimizing processing latency through predictive generation, reducing computational overhead through strategic caching, enabling progressive content updates during continuous gestures, maintaining responsiveness through distributed processing, and adapting resource utilization based on interaction patterns. For example, the system may minimize processing latency by predicting likely content transformations before they are explicitly requested, thereby reducing the time between user gesture initiation and visible response. The system may also reduce computational overhead by strategically caching frequently used action definitions and previously generated outputs, allowing for rapid retrieval during similar gesture operations. Additionally, embodiments of the system may enable progressive content updates during continuous gestures, providing real-time feedback as users perform drag operations or other extended interactions. The system may maintain responsiveness through distributed processing capabilities, where computationally intensive language model operations may be performed on dedicated servers while user interface interactions remain local. Furthermore, the system may adapt resource utilization based on interaction patterns, allocating more processing power to frequently used features while optimizing performance for the user's specific workflow requirements.

This event-based architecture enables the system 900 to perform flexible document 914 processing operations. The system 900 may make asynchronous revisions to the document 914, allowing editing of any part of the document 914 at any time according to the user 102's creative flow, while maintaining responsive performance during processing operations.

The system 900 may provide support for different levels of user involvement during asynchronous processing. This ranges from fully automated processing that requires no user intervention, to interactive refinement of generated content, to structured review and approval workflows. The system 900 may enable selective manifestation of processed content, giving users control over how and when generated content is displayed.

The elements processed by the system 900 and method 1000 may take various forms. The elements that are looped over in operation 1002 may, for example, include individual characters within the document, single words within the document, phrases or segments of text, individual sentences within the document, single paragraphs within the document, semantic units based on the meaning within the document, custom-delimited text segments defined by special character sequences, structured elements like XML/HTML tags or JSON objects, and/or database fields or records. These various element types may provide flexibility in how embodiments of the system 900 process different types of document content and structure.

Importantly, the elements processed within a single document may all be of the same type (e.g., all individual words) or may include different types of elements (e.g., some elements may be individual words while others may be complete sentences or paragraphs).

For example, the system 900 may process some elements that consist of less than all of the text in the document (such as single characters, words, or sentences) while also processing other elements that include all of the text in the document. An element may include or consist of a single contiguous block of text or multiple non-contiguous blocks of text within the document.

When processing non-contiguous text selections, each text selection may be contiguous within itself while being separated from other selections. For example, if a document includes contiguous text blocks A, B, and C in sequence, the system may process text block A and text block C as elements while excluding text block B.

The set of elements processed by the method 1000 may include all elements in the document 914 or only a subset of those elements. The system 900 may employ various techniques to determine which elements to include in the loop performed in operation 1002. For example, the system 900 may use context-based selection, where the system 900 may analyze the content and structure of the document 914 to automatically choose appropriate elements based on factors such as document type, content structure, and writing style. Elements may be selected based on their semantic meaning within the document.

The system 900 may employ user-directed selection, where the system 900 may enable the user 102 to select specific elements for processing through the user interface 104. Users may select multiple contiguous or non-contiguous blocks of text as elements to be processed. Selection may be performed through various input methods including mouse selection and dragging across desired text, keyboard commands, touch gestures on touch-enabled devices, and/or voice commands in systems with voice recognition.

Automated analysis may be used by the system 900 to identify elements based on document structure and/or formatting. Elements may be identified through pattern matching or regular expressions, where the regular expressions or pattern matching criteria may be received via user input through the user interface 104 in some embodiments. The system 900 may use metadata analysis to determine which elements should be processed, where the metadata analysis criteria may be specified by the user 102 in some embodiments. The system 900 may implement rule-based selection, where elements may be selected based on predefined criteria or rules, which may be configured by the user 102 through the user interface 104 in some embodiments. The system 900 may apply filters to include or exclude certain types of elements, where such filters may be defined by user input in some embodiments. Selection may be based on element characteristics such as length, format, and/or content type, where the thresholds or criteria for these characteristics may be specified by the user 102 in some embodiments.

In automated scenarios, the system 900 may use programmatic selection, where elements may be selected through API calls or scripted commands that may be provided by the user 102 or received via user input in some embodiments. The system 900 may use structured selectors to identify specific elements within the document, where such selectors may be defined or customized by the user 102 through the user interface 104 in some embodiments. This programmatic approach may enable efficient processing of large documents or batch operations across multiple documents, while still allowing user control over the selection criteria in some embodiments.

The system 900 may employ resource-based selection to determine which elements to include in the loop performed in operation 1002. With resource-based selection, an element may be selected for processing (e.g., in operation 1002) only in response to the system 900 determining that applying an action definition to that element would require no more than a maximum allowable amount of computational resources. The system 900 may analyze factors such as required processing time to apply the action definition, memory requirements for generating and storing output, language model computational costs, and/or available system resources.

This approach enables efficient processing by automatically excluding elements that would exceed defined resource thresholds. For example, if applying an action definition to a particularly large paragraph would require more than the maximum allowed processing time, that paragraph may be excluded from the set of elements processed by method 1000.

Embodiments of the system 900 may implement time-based resource limits that prevent processing operations from blocking user interaction. For example, the system 900 may set maximum processing times of about 100 milliseconds to about 1 second, about 100 milliseconds to about 750 milliseconds, about 100 milliseconds to about 500 milliseconds, or about 100 milliseconds to about 250 milliseconds per element to maintain responsive user experience during typing and editing. Elements requiring longer processing times may be deferred to background processing or excluded from real-time analysis. The action processor 112 may evaluate each element's expected processing duration before initiating operation 1006 to ensure user interface responsiveness.

The system 900 may implement memory-based selection to prevent system slowdowns or crashes. The system 900 may analyze memory requirements for processing different element types and exclude elements that would consume excessive RAM. For example, very large tables or embedded objects may be excluded from certain processing operations to maintain system stability. The text generation module 120 may evaluate memory requirements before generating output in operation 1006, ensuring that processing operations remain within available system memory constraints.

The system 900 may implement document-level resource thresholds that adapt processing based on overall document size. In large documents with thousands of pages, the system 900 may process only visible or recently edited sections to conserve computational resources. This approach may enable responsive performance even in enterprise-scale documents. The document update module 124 may prioritize elements within the current viewport or recently modified sections when performing operation 1012, ensuring that user-visible content receives processing priority.

Word processors integrating with language models may implement token-based resource selection. The system 900 may analyze the token count required to process each element and exclude elements that would exceed language model context windows or API rate limits. This ensures reliable integration with external AI services. The text generation module 120 may evaluate token requirements before applying action definitions in operation 1006, preventing processing failures due to language model limitations.

On mobile devices or laptops, the system 900 may adjust resource thresholds based on battery level or performance mode settings. In power-saving modes, the system 900 may process fewer elements or use less computationally intensive action definitions to preserve battery life. The action processor 112 may monitor device power status and adapt the selection criteria in operation 1004 accordingly, reducing processing load when battery conservation is prioritized.

For cloud-based processing, the system 900 may implement bandwidth-aware selection that considers network connectivity. Elements requiring large data transfers may be excluded when network conditions are poor, ensuring consistent user experience across different connectivity scenarios. The text generation module 120 may evaluate network bandwidth before initiating processing operations that require external data 128, adapting processing strategies based on available network resources.

In some embodiments, the system 900 may determine whether cloud-based processing will produce results with sufficiently low latency before selecting a processing approach. The action processor 112 may evaluate factors such as network latency, server response times, and the computational complexity of the selected action definition to predict whether cloud-based processing will meet latency requirements. If the system 900 determines that cloud-based processing will produce results with sufficiently low latency (e.g., with a latency that is less than a particular maximum latency), the text generation module 120 may use cloud-based processing to apply the action definition to the element. Otherwise, the system 900 may use local processing to apply the action definition to the element, ensuring responsive performance regardless of network conditions. As this implies, in such embodiments the system 900 may include both a cloud-based action processor and a local action processor.

In a related embodiment, the system 900 may implement adaptive processing that starts with cloud-based processing but switches to local processing if needed. The action processor 112 may initially begin cloud-based processing of an element in operation 1006, while simultaneously monitoring response times and processing progress. If the cloud-based processing does not produce a result within a predetermined time threshold, the system 900 may automatically switch to local processing of the same element. This approach may allow the system 900 to leverage the computational advantages of cloud-based processing when network conditions are favorable, while maintaining responsiveness by falling back to local processing when cloud-based processing experiences delays.

The system 900 may implement limits on simultaneous processing operations to prevent system overload. When multiple documents are open or multiple users are active, the system 900 may reduce per-document processing to maintain overall system responsiveness. The action processor 112 may coordinate processing across multiple instances of method 1000, ensuring that concurrent operations remain within system capacity limits.

The system 900 may employ size-based selection to determine which elements to include in the loop performed in operation 1002. With size-based selection, an element is selected for processing (e.g., in operation 1002) only if it meets defined size criteria. The size criteria may include minimum size requirements, such as words that must contain at least a specified number of characters, maximum size limits, such as paragraphs that must not exceed a specified number of characters, and/or combined size constraints, such as phrases that must be between a minimum and maximum length.

This approach enables focused processing by automatically including or excluding elements based on their size characteristics. For example, if a minimum word length is specified, single-character words may be excluded from the set of elements processed by method 1000. Similarly, if a maximum paragraph length is defined, exceptionally long paragraphs that exceed that length would not be selected for processing.

The system 900 may employ position-based selection to determine which elements to include in the loop performed in operation 1002. With position-based selection, one or more elements may be selected for processing based on the user 102's current position within the document 914, such as the current cursor position or insertion point. This approach may enable focused processing of content that is contextually relevant to where the user 102 is currently working within the document.

For example, the system 900 may select elements at the user 102's current cursor position for processing. In some embodiments, the system 900 may select the specific element that contains the cursor position, such as the current word, sentence, paragraph, or section in which the cursor is located. The action processor 112 may identify the cursor position through the user interface 104 and determine which document element encompasses that position for processing in operation 1002.

The system 900 may implement window-based selection around the user 102's current position. In such embodiments, the system 900 may select elements within a defined window or range before and/or after the current cursor position. For example, the system 900 may select elements within a specified number of characters before and after the cursor position, such as 50 characters, 100 characters, 200 characters, or 500 characters in each direction. The system 900 may alternatively select elements within a specified number of words before and after the cursor position, such as 5 words, 10 words, 25 words, or 50 words in each direction.

In some embodiments, the system 900 may select elements within a specified number of sentences before and after the cursor position. For example, the system 900 may select the current sentence containing the cursor position plus one sentence before and one sentence after, or may select a larger window such as three sentences before and three sentences after the current position. The system 900 may select elements within structural boundaries, such as the current paragraph containing the cursor position, the current section, or a combination of the current paragraph plus adjacent paragraphs.

The position-based selection may be dynamic, updating automatically as the user 102 moves the cursor to different locations within the document 914. As the cursor position changes, the system 900 may automatically update the set of elements selected for processing in operation 1002, enabling continuous processing of contextually relevant content as the user 102 navigates through the document. This dynamic selection approach may provide responsive processing that adapts to the user 102's current focus area within the document.

The system 900 may combine position-based selection with other selection criteria disclosed herein. For example, the system 900 may apply position-based selection to identify a candidate set of elements around the cursor position, then apply additional filters such as size-based selection, resource-based selection, or content-based selection to refine the final set of elements for processing. This combined approach may enable sophisticated element selection that considers both the user 102's current context and other processing constraints or requirements.

Position-based element selection may provide significant processing efficiency advantages by focusing computational resources on contextually relevant content rather than processing entire documents. By limiting processing to elements within the user 102's current working area, the system 900 may reduce the total number of elements that require evaluation in operation 1004 and processing in operation 1006, thereby decreasing overall computational load and improving system responsiveness.

Referring to FIG. 10, the efficiency gains from position-based selection may be particularly pronounced in large documents where processing all elements would require substantial computational resources. The text generation module 120 may benefit from this focused approach by applying action definitions only to elements that are immediately relevant to the user 102's current editing context.

The dynamic nature of position-based selection may provide additional efficiency benefits by enabling the system 900 to adapt processing load in real-time as the user 102 navigates through the document 914. As the cursor position changes, the action processor 112 may automatically shift processing focus to the new location without requiring complete document reanalysis. This adaptive approach may maintain consistent processing performance regardless of document size, as the processing load remains proportional to the defined window size rather than the total document length.

With continued reference to FIG. 10, position-based selection may enable more efficient memory utilization by reducing the amount of content that needs to be held in active memory during processing operations. The system 900 may load and process only the elements within the defined window, allowing other document sections to remain in storage until needed. This approach may be particularly beneficial when processing documents that exceed available system memory, as the focused processing window ensures that memory requirements remain within system constraints.

The efficiency advantages may extend to network-based processing scenarios where the system 900 communicates with external language models or cloud-based services. By transmitting only the contextually relevant elements rather than entire documents, position-based selection may reduce bandwidth requirements and minimize network latency. The text generation module 120 may benefit from faster response times when applying action definitions to position-selected elements, as the reduced data payload enables more rapid communication with external processing resources.

The system 900 may implement background processing capabilities that enable automated document analysis and revision while allowing users to continue their normal document editing workflow. This background processing functionality may operate in conjunction with the method 1000 to analyze document elements and generate suggested revisions without requiring explicit user initiation.

From an internal implementation perspective, the action processor 112 may be implemented as one or more software modules that operate alongside or as a plugin to a conventional word processing application. The system 900 may leverage existing word processing capabilities for basic document operations while implementing the novel background processing features through custom components. The background processing may be implemented through event-based design that can perform functions at any time in response to user input, asynchronous processing that allows document editing while analysis occurs, integration with existing document editing workflows, and/or support for distributed implementations across local and remote components.

From the user's perspective, the background processing may operate seamlessly within their normal document editing experience. Users may continue editing the document 914 while the system processes elements. The system may automatically identify and process elements without requiring user initiation. Suggested revisions may be manifested through the user interface 104 for user review, and users may maintain control by choosing which suggestions to apply.

The method 1000 may support this background operation by processing document elements automatically without blocking user interaction, generating suggestions through action definition application in the background, manifesting suggestions to users when ready for review, and/or applying approved revisions while preserving user control.

The system may implement an event-based architecture that enables real-time, dynamic interaction between the user 102 and the system 900. Given that writing is typically non-linear, this design allows users to make asynchronous revisions while the system continues background processing. Users remain free to edit any part of the document at any time, in any order, according to their creative flow. This background processing while the user is editing may constitute a form of parallel processing that results in increased efficiency of the combined user editing and action definition processing operations compared to performing those operations sequentially.

The elements processed by method 1000 may be selected and processed in any order, which may or may not correspond to the order in which those elements appear in document 914. This flexibility in processing order enables several sophisticated approaches to document analysis and revision. For example, if there is an Element E1 at position P1 in the document 914, and there is an Element E2 at position P2 in the document 914, where P2>P1, the method 1000 may process element E2 (in one iteration of operation 1006) before or after processing element E1 (in another iteration of operation 1006). The system 900 may determine and apply appropriate execution ordering in various ways, such as by analyzing references between elements to identify dependencies, building a dependency graph of elements, determining an execution sequence that satisfies all dependencies, and/or coordinating processing across distributed system components. These computational operations for dependency analysis and execution ordering represent improvements to computer technology by enabling more efficient document processing than sequential approaches.

Embodiments of the system 900 may implement dependency graph analysis similar to spreadsheet recalculation engines, where the system may analyze references between document elements to build a directed acyclic graph (DAG) that represents processing dependencies. The system 900 may then use topological sorting algorithms to determine an evaluation order that ensures all prerequisite elements are processed before dependent elements. The system 900 may implement circular reference detection mechanisms, where the system may identify and handle cases where document elements have circular dependencies through iterative calculation approaches or by flagging circular dependencies for user resolution. These algorithmic approaches to dependency management are inherently computational and represent technical improvements to computer-based document processing systems.

Some beneficial processing orders may include forward references, where the system may process elements that are referenced by other elements before processing the referencing elements. For example, when processing an executive summary section at the beginning of a document, the system may first process later sections that contain key points that will be referenced in the summary. This enables the summary to accurately reflect the complete document content. The system 900 may also implement table of contents processing, where elements that will appear in a table of contents or index section are processed after content throughout the rest of the document to ensure organizational elements can properly reference all content, regardless of where it appears in the document. These non-sequential processing capabilities require computational analysis and memory management that are only possible through computer implementation.

Embodiments of the system 900 may support volatile and non-volatile element classification to distinguish between cells that require recalculation on every evaluation cycle versus those that only need recalculation when their dependencies change. The system 900 may mark certain document elements as volatile (requiring processing on each document update) while treating others as stable (only requiring processing when their content or dependencies change). The system 900 may implement incremental processing strategies, where only elements affected by changes are reprocessed rather than processing the entire document. This may include change propagation analysis that traces which elements are impacted by modifications to specific document sections, enabling efficient selective reprocessing. These optimization techniques represent concrete improvements to computer technology by reducing computational overhead and improving processing efficiency compared to conventional sequential document processing approaches.

The system 900 may further implement context-aware ordering by analyzing relationships between elements to determine an optimal processing sequence that maintains document coherence. This may include analyzing dependencies between specific elements, relationships to document structure, and/or conditional execution based on processing state. Additionally, the system 900 may implement resource-based ordering when applying action definitions to document elements. Under this approach, the system 900 processes elements in order of the computational resources required, applying action definitions that require fewer resources before those requiring greater resources. For example, the system 900 may analyze the processing requirements (e.g., clock cycles) for applying different action definitions, order the processing sequence from least to most resource-intensive, begin processing with elements requiring minimal computational resources, and progress to more resource-intensive processing operations. The system 900 may also support manual calculation modes where users can control when processing occurs, automatic recalculation that processes elements immediately when dependencies change, and hybrid approaches that combine automatic processing for certain element types with manual control for computationally intensive operations. These scheduling and resource management capabilities are necessarily rooted in computer technology and provide technical improvements by optimizing computational resource utilization and processing efficiency.

Operation 1004 (identifying the action definition) may be implemented in a variety of ways, including both user-driven and automated approaches. The action definition may, for example, be user-defined using any of the techniques disclosed herein, and at any time. The following describes various examples ways in which the action definition may be selected based on user input through the user interface 104.

In some embodiments, the user 102 may define and store one or more action definitions in the action definition library 106 before the method 1000 is performed, and then select one of those user-defined action definitions for use in the method 1000. For example, the user 102 may create custom action definitions with specific prompts, tokens, and/or scripts tailored to their particular document processing needs, store these definitions in the action definition library 106, and subsequently select from these pre-created definitions during operation 1004. As another example, the user 102 may define the action definition “on the fly” during the method 1000, with or without storing it in the action definition library 106. User-driven “identifying” of the action definition may include any combination of: (1) user selection of a previously-created action definition (whether user-created or otherwise); and/or (2) user creation of the action definition.

User-driven action definition selection methods may include direct selection from a list, where the user 102 may select from a manifested list of available action definitions. For example, selection may be made from contextual menus that appear when right-clicking, action definitions may be selected from toolbar or ribbon interfaces with buttons, and/or the system 900 may manifest dropdown menus containing available action definitions. Action definitions may be selected using corresponding short names or labels that are more user-friendly than the full definitions. For example, an action definition with a 500-character prompt may have a simple short name like “Summarize” or “Rephrase.” Users may select by clicking, tapping, or speaking these short names.

Various input methods may be used for selection, such as keyboard shortcuts, mouse selection and clicking, touch gestures on touch-enabled devices, voice commands in systems with voice recognition capabilities, and/or selection through toolbar buttons or menu items. Users may select action definitions after selecting specific text, and the system 900 may manifest context-appropriate action definitions based on the selected content. Selection may be made from contextual menus that appear in response to text selection. Users may override default action definitions through settings menus, where system-wide default settings may be modified by user preference. Individual action definitions may have default settings that users may override as needed.

The system may support flexible selection timing, allowing users to select action definitions before or after selecting text, make selections while the system is in various operational modes, and choose action definitions as part of ongoing document editing workflows.

This user-driven selection approach may enable precise control over which action definitions are applied while maintaining an intuitive and efficient interface that integrates seamlessly with existing document editing practices.

The system 900 may implement various automated methods for selecting action definitions in operation 1004. For example, the system 900 may use previous user selection, where the system automatically uses an action definition that was previously selected by the user 102, without requiring re-selection. In such embodiments, if the user selected an action definition before method 1000 executes, that selection may be reused. The original selected action definition may be used during subsequent instances without being re-selected, and the system may maintain and reuse the user's action definition selection across multiple processing iterations.

The system 900 may alternatively implement default selection, where the system automatically selects action definitions based on configured defaults. For example, pre-configured default action definitions may be applied automatically, and system-wide default settings may determine the automatic selection. Default selections may be based on document type or application, and the system may use recent usage patterns or preferences to determine defaults.

In some embodiments, the system 900 may implement session-based selection, where users may select an action definition once at the start of an editing session, and the system automatically reuses that selection throughout the session. The system may apply the selected action definition across multiple document elements and maintain the selection until the session ends or the user makes a new selection. This automated selection capability may enhance efficiency by reducing repetitive selection actions, enabling batch processing of multiple elements, supporting background processing without interruption, and maintaining consistent action definition application across elements.

The system 900 may automatically identify action definitions in operation 1004 based on analysis of the current document element's content in various ways. For example, the system 900 may perform context analysis by analyzing the element's context to select appropriate action definitions. This context analysis may include determining the content type (e.g., text, code, technical content), analyzing the writing style and tone, and/or identifying the structural role within the document (e.g., introductory section, technical details).

The system 900 may examine specific content characteristics of the element, including any one or more of the following: technical complexity level, writing style and formality, content structure and organization, and/or presence of specialized terminology or jargon. Additionally, the system 900 may adaptively select action definitions by analyzing the surrounding document context, determining the element's relationship to other document sections, considering document-level metadata and structure, and/or evaluating relationships between different content elements.

For example, when processing a complex technical explanation, the system 900 may select different action definitions based on the document section. In an introductory section, the system may select an action definition for simplifying technical content. For mid-level sections, it may choose definitions that maintain moderate technical detail. In advanced sections, it may select definitions for expanding and detailing technical content. The system may analyze factors such as document type and purpose, target audience characteristics, content complexity requirements, and/or structural relationships between elements.

This content-based selection may enable context-aware content generation, appropriate transformation selection based on content type, maintenance of document-wide consistency, and/or adaptation to different document sections and purposes. Through this automated analysis and selection process, the system 900 may provide intelligent action definition identification that adapts to the specific characteristics and context of each document element being processed.

The system 900 may automatically identify action definitions in operation 1004 based on analysis of the current document element's content in various ways. For example, the system 900 may perform context analysis by analyzing the element's context to select appropriate action definitions. Such context analysis may include determining the content type (e.g., text, code, technical content), analyzing the writing style and tone, and/or identifying the structural role within the document (e.g., introductory section, technical details).

The system 900 may examine specific characteristics of the element to identify appropriate action definitions. Such content characteristics may include technical complexity level, writing style and formality, content structure and organization, and/or presence of specialized terminology or jargon. These characteristics may enable the system 900 to select action definitions that are well-suited to the particular type and nature of content being processed.

Additionally, the system 900 may adaptively select action definitions by analyzing the surrounding document context, determining the element's relationship to other document sections, considering document-level metadata and structure, and/or evaluating relationships between different content elements. This adaptive selection approach may enable the system 900 to choose action definitions that are contextually appropriate not only for the individual element being processed, but also for its role within the broader document structure.

For example, when processing a complex technical explanation, the system may select different action definitions based on the document structure and content requirements. In an introductory section, the system may select an action definition for simplifying technical content, while for mid-level sections, it may choose definitions that maintain moderate technical detail. In advanced sections, the system may select definitions for expanding and detailing technical content.

The system may analyze factors such as document type and purpose, target audience characteristics, content complexity requirements, and structural relationships between elements. This content-based selection enables context-aware content generation, appropriate transformation selection based on content type, maintenance of document-wide consistency, and adaptation to different document sections and purposes.

The system 900 may utilize a language model (e.g., a large language model) to analyze element content and identify appropriate action definitions in operation 1004. This language model may be the same language model used to apply the action definition in operation 1006, or may be a different language model.

When using a language model for action definition identification, the system 900 may, for example, analyze the element's content characteristics and context, determine appropriate transformations based on content type and complexity, and select suitable action definitions based on the analysis results. The system's flexibility in using either the same or different language models for identification and application may enable efficient resource utilization when the same model is appropriate for both tasks, specialized processing when different models are better suited to each operation, and optimization of model selection based on specific processing requirements.

Although FIG. 9 shows a single selected action definition 118 and FIG. 10 refers to identifying a single action definition in operation 1004, the method 1000 may identify and process multiple action definitions in various ways.

For example, the system 900 may identify a plurality of action definitions in operation 1004 and apply each identified action definition to the current element in operation 1006 to generate multiple outputs. This enables application of different transformations to the same element, generation of multiple alternative outputs for user review, and complex multi-stage processing of individual elements.

For any particular element E, the method 1000 may process element E in multiple iterations of the loop, identify and apply different action definitions in each iteration, and generate different outputs from the same element using different transformations.

When considering a “selected action definition set” that may include one or multiple action definitions, the method 1000 may support applying the same action definition set across multiple elements, using different action definition sets for different document elements, and mixing uniform and varied application of action definition sets.

This flexibility in action definition identification and application enables sophisticated processing approaches that may apply multiple transformations to single elements, process elements multiple times with different action definitions, and maintain consistency or variation in processing across elements as needed. For example, embodiments of the system 900 may apply a first action definition to generate initial output for a document element, then apply a second action definition to the same element to generate alternative output, thereby providing multiple processing options for the same content. In some cases, the system 900 may process elements iteratively with different action definitions to achieve compound transformations, where each successive application builds upon or refines the results of previous processing steps.

Operation 1004 (identification of the action definition) may be implemented with flexible timing relative to the loop structure of method 1000, enabling several processing approaches. The system 900 may perform operation 1004 once before initiating the loop, enabling selection of a single action definition to be applied across multiple elements, efficient batch processing without repeated identification steps, and background processing of multiple elements using the pre-identified action definition.

The system 900 may perform initial action definition identification (operation 1004) before the loop, selectively perform operation 1004 within loop iterations only when specific conditions are met, and override the pre-loop selection based on element-specific requirements. Alternatively, the system 900 may perform operation 1004 during each loop iteration, select the same or different action definitions based on each element's content, and adapt transformations to element-specific context.

In some embodiments, the system 900 may identify the action definition during the first loop iteration, reuse that selection for subsequent iterations without re-identification, and maintain consistent processing across multiple elements. The system 900 may select an action definition at the start of an editing session, automatically reuse that selection throughout multiple loop iterations, and maintain the selection until explicitly changed or the session ends.

Operation 1006 involves applying the identified action definition to the current document element to generate output, such as the generated text 122. The resulting output may differ from the document element, and may include new text not previously present in the document 914.

The text generation module 120 may generate output (e.g., generated text 122) based on the selected action definition 118 and current element E using any of the techniques previously described for processing the selected text 116. For example, the current element E may serve as the selected text 116, allowing the text generation module 120 to apply the selected action definition 118 to the element using any of the previously disclosed methods. For example, performing operation 1006 may include using the selected action definition 118's corresponding prompt as an initial prompt, generating a processed prompt based on both the initial prompt and the current element E, and/or providing the processed prompt as input to a language model to generate output, such as the generated text 122.

For example, the text generation module 120 may generate a combined prompt that includes some or all of the selected action definition 118's corresponding prompt, some or all of the current element E content, and/or additional context from the document or external data.

The text generation module 120 may provide this combined prompt to a language model (e.g., an LLM) to generate output such as the generated text 122.

The system 900 may store the generated output (e.g., generated text 122) in any of a variety of ways. For example, the system 900 may use internal document storage, where the output may be stored directly within document 914. This approach may enable direct access to generated content within the document context and may maintain content relationships within the document structure. Alternatively, the system 900 may use external storage, where output may be stored externally to document 914. This approach may allow separation of generated content from source document and may enable flexible content management and version control.

The system 900 may create and store one or more links between various components to maintain relationships and traceability throughout the document processing workflow. For example, the system 900 may establish element-output links that connect the current element E with its corresponding output. These links may be stored inside or outside document 914, enabling tracking of relationships between source elements and generated content while maintaining content traceability and relationships throughout the processing workflow.

The system 900 may create action definition links that connect output with the selected action definition 118 used to generate that output. These links may be stored internally or externally to document 914, preserving information about which action definition generated specific output and enabling tracking of transformation history. Different links may links the same action definition to different outputs. Different links may link different action definitions to different outputs (e.g., a first action definition may be linked to a first output, and a second action definition may be linked to a second output, where the first action definition differs from the second action definition, and where the first output differs from the second output). This linking capability allows the system 900 to maintain comprehensive records of how content was generated and transformed, supporting both audit trails and potential reversal of operations when needed.

The different storage methods each provide distinct benefits for managing generated content and relationships. Internal storage within the document 914 enables direct access to generated content in its proper context, helping maintain the overall integrity and completeness of the document. This approach simplifies document management and sharing while preserving important relationships between document elements.

External storage provides additional flexibility by separating generated content from the source document. This separation enables more sophisticated content management capabilities and robust version control tracking. Additionally, external storage facilitates efficient management of multiple output versions that may be generated from the same source content.

Link storage, whether implemented internally or externally to the document, maintains valuable relationships between elements, outputs, and their corresponding action definitions. This relationship tracking enables comprehensive monitoring of content transformations over time while supporting advanced content management and version control capabilities. The link-based approach provides flexibility in how content is organized and accessed, allowing the system to maintain connections between related components while supporting different storage architectures.

When multiple action definitions are identified for the current element E in operation 1004, operation 1006 may include applying each identified action definition to generate distinct outputs. The text generation module 120 may process the element multiple times, once for each identified action definition, to create separate outputs (e.g., multiple instances of generated text 122). For each generated output, the system 900 may store such outputs in any of the ways described above in connection with storing a single output. Similarly, the system 900 may generate and store links between each such output and the current element E and/or its corresponding action definition in any of the ways described above.

The system may process these multiple outputs in various ways. For example, the system may present all outputs to the user 102 for review via the user interface 104, enabling selection of one or more preferred outputs. Alternatively, the system may process the multiple outputs internally to produce a single final output. The system may also combine outputs sequentially or synthesize them into new content, and/or use voting or consensus approaches to identify common elements across outputs.

The system 900's ability to manage multiple outputs while maintaining appropriate storage locations and relationship links enables sophisticated content transformation workflows that preserve traceability between source elements, action definitions, and generated content.

The system 900 may store generated output internally within document 914 in ways that keep it hidden or separate from regular user-entered content until explicitly manifested for review. This approach enables controlled presentation of generated content while maintaining document integrity.

The system may implement any of a variety of internal storage methods to manage generated content. These include storing output as hidden document elements, using document metadata to track generated content, maintaining separate internal layers to distinguish between generated and manual content, and implementing review-state tracking for generated outputs. For manifestation control, the system 900 may keep generated content hidden until explicitly manifested through the user interface 104, allowing selective manifestation of specific outputs for review. Content may be previewed without affecting the main document content.

The implementation may leverage document object model (DOM) structures that enable precise navigation and manipulation of document content. These structures establish hierarchical relationships between document elements, including parent-child relationships between content sections, specific nodes within the document tree, and standardized selectors for accessing content. This approach enables controlled review of generated content while maintaining a clear distinction between manual and generated content, provides preview capabilities without permanent document changes, and supports systematic content management and approval workflows.

The system 900 may apply various tags to generated outputs to track their status and characteristics. For generated content tracking, the system may use tags such as, for example, “Generated” to distinguish automatically generated content from manual content (which itself may be tagged as “Manual”), “Proposed” to indicate unapproved revisions to element E, and/or “Accepted” to mark content that has received user approval. These examples are merely provided for purposes of illustration and do not constitute limitations of embodiments of the present invention.

Processing status may be tracked through tags that indicate different stages of content review and refinement. These may include, for example, “In Review” for content awaiting user evaluation, “Rejected” for declined content, “Modified” for user-edited generated content, and/or “Final” to designate content approved and ready for use. These examples are merely provided for purposes of illustration and do not constitute limitations of embodiments of the present invention.

The system 900 may employ source-related tags to maintain content relationships and history. For example, an “Action Definition ID” may link output to its generating action definition, while “Element ID” may connect output to its source element. “Version” tags may track different iterations of the generated content to maintain version history. These examples are merely provided for purposes of illustration and do not constitute limitations of embodiments of the present invention.

Context-specific information may be preserved through tags that indicate the content's intended location (“Document Section”), the nature of the generated text (“Content Type”), the technical complexity level, and/or the intended audience. These contextual tags may help maintain appropriate content organization and targeting. These examples are merely provided for purposes of illustration and do not constitute limitations of embodiments of the present invention.

Relationship tracking may be accomplished through tags that establish connections between different content elements. For example, “Depends On” may mark dependencies between generated outputs, “Related To” may connect associated content elements, “Replaces” may indicate when content has been superseded, and/or “Derived From” may maintain content lineage tracking. These examples are merely provided for purposes of illustration and do not constitute limitations of embodiments of the present invention.

The system 900 may provide flexibility in tag storage, such as by allowing tags to be stored either internally or externally to document 914. This approach enables sophisticated tracking and management of generated content status, relationships, and characteristics throughout the content lifecycle.

Examples of functions that may be performed by the selected action definition 118 in the system 900 and method 1000 include error checking and/or validation operations. For example, the selected action definition 118 may perform error detection beyond basic spell checking and grammar checking, validate content consistency and accuracy, perform fact-checking using retrieval augmented generation (RAG), and/or verify technical accuracy and terminology. In some embodiments, the selected action definition 118 may implement an “Inclusive Language Checker” that goes beyond basic gendered language detection to understand context and nuance, enabling organizations to identify and address potentially exclusionary language patterns in corporate communications and HR documentation.

The selected action definition 118 may perform style and tone transformation functions. For example, the selected action definition 118 may convert between formal and informal writing styles, adjust emotional tone (e.g., empathetic, assertive), and/or adapt content for different audiences. In some cases, the selected action definition 118 may implement a “Corporate Speak” detector for business environments that flags vague buzzwords when concrete language would be more effective, such as transforming phrases like “synergize our efforts” into clearer alternatives like “work together.” The selected action definition 118 may perform content restructuring operations, such as converting between different content formats (e.g., paragraphs to bullet points), reorganizing document sections, and/or adjusting content complexity levels.

Language processing functions may be performed by the selected action definition 118. For example, the selected action definition 118 may perform translation between languages, localization of content, technical jargon adaptation, and/or vocabulary level adjustment. Embodiments of the system 900 may implement a “Plain Language” mode that addresses legal requirements in government, healthcare, and legal contexts by transforming complex technical language into accessible alternatives while maintaining accuracy and precision. The selected action definition 118 may further perform content generation and enhancement operations, such as expanding existing content, summarizing content, elaborating on technical concepts, and/or adding relevant details or examples.

Context-aware adaptation functions may be performed by the selected action definition 118, including adjusting content based on document section context, modifying content for target audience, adapting to surrounding content complexity, and/or maintaining consistency with document style. In some embodiments, the selected action definition 118 may implement an “Email Tone Calibrator” that analyzes written communications and provides feedback such as “This might sound harsh” or “This might sound weak,” enabling users to adjust their messaging tone appropriately for different professional contexts. The selected action definition 118 may perform document organization functions, such as creating executive summaries, generating table of contents, managing cross-references, and/or maintaining document-wide consistency.

Technical content management functions may be performed by the selected action definition 118, including simplifying complex technical explanations, expanding technical details for advanced sections, converting between technical and general audience content, and/or managing technical terminology. Additionally, the selected action definition 118 may perform content synthesis operations, such as combining multiple content elements, processing related content sections, creating coherent content from multiple sources, and/or generating consensus content from multiple versions.

These and other action definitions may be applied individually or combined through compound transformations to achieve more complex document revisions.

Operation 1006 may implement multi-stage processing when applying action definitions to document elements. When an action definition specifies multiple processing stages, operation 1006 may sequentially apply these stages to generate the final output. For example, the system may apply a first action to generate intermediate output, followed by applying a second action to that intermediate output to produce the final output of operation 1006. Importantly, while some processing stages may be specified within the selected action definition 118 itself, other stages may be defined externally, such as through system defaults or application settings.

This multi-stage processing capability enables sophisticated content transformations through sequential refinement. For example, action definitions may implement chained processing workflows where initial stages generate foundational content, while subsequent stages process and refine that generated content. This allows later stages to reference both original content and previously generated intermediate outputs.

Some practical applications of multi-stage processing may include converting complex technical content through staged simplification. For example, a first stage may use an LLM to generate a detailed technical explanation, while a second stage may apply rules-based processing to ensure consistent terminology. A final stage may convert the content to a standardized format or structure.

Another application may involve generating binary decisions from nuanced analysis. In such cases, a first stage may use an LLM to perform detailed content analysis that results in textual output. A second stage may apply defined criteria to convert the detailed analysis into binary output, while a final stage may format the binary decision according to document requirements.

The system's ability to chain multiple action definitions enables complex, context-aware content generation that goes beyond single-stage processing while maintaining precise control over document structure and formatting. This sequential processing allows merge templates to implement sophisticated content generation workflows that can build upon and refine content created in earlier stages.

Embodiments of the system 900 may implement any of a variety of multi-stage processing that combines language model and non-language model processing stages. For example, when applying an action definition to generate output in operation 1006, the system 900 may first apply a language model to the current element to generate textual output, followed by applying one or more non-language model processing stages that transform that textual output into final processed content.

For example, the system 900 may employ a language model in an initial stage to perform detailed content analysis and generate nuanced textual output. This output may then be processed by subsequent non-language model stages that apply defined rules, criteria, and/or algorithms to transform the text into specific output formats or types. These later stages may, for example, generate binary decisions, selections from predefined options, and/or other structured output formats based on the language model's textual analysis.

This hybrid approach combining language model and algorithmic processing may provide several benefits. For example, the system may leverage the sophisticated natural language capabilities of language models while ensuring outputs conform to specific requirements through controlled post-processing. In some cases, the language model may generate detailed technical explanations that subsequent rule-based processing stages can validate against terminology standards and formatting requirements. The approach may enable conversion of nuanced language model outputs into precise, structured formats needed for specific use cases. An initial language model stage may perform comprehensive content analysis, while later algorithmic stages distill that analysis into binary decisions or selections from permitted options based on well-defined criteria. The multi-stage processing may maintain precise control over final outputs while benefiting from the language model's capabilities. By applying non-language model processing stages after the language model generation, the system may ensure outputs meet exact specifications while still leveraging sophisticated AI-driven content generation.

This combination of processing approaches is necessarily rooted in computer technology, as it requires sophisticated computational resources to coordinate language model operations with algorithmic processing in real-time. The hybrid processing architecture represents a concrete improvement to computer technology by enabling more accurate and contextually appropriate content generation than either approach could achieve independently, while maintaining processing efficiency through optimized resource allocation between different computational methods. The language model stages provide powerful natural language understanding and generation, while the non-language model stages ensure outputs conform to required formats and standards through controlled processing.

The system 900 may provide flexibility in how intermediate processing outputs are handled during multi-stage processing. For example, when applying multiple processing stages in operation 1006, the system 900 may either store intermediate outputs for later reference or process them transiently only as needed to generate the final output.

For intermediate output storage, the system 900 may utilize various internal storage methods similar to those used for final generated content, including storing outputs as hidden document elements, using document metadata, or maintaining separate internal layers. This enables preservation of intermediate processing states while keeping them separate from regular document content.

The system 900 may support selective manifestation of intermediate outputs through the user interface 104. Intermediate outputs may be manifested for user review and refinement, similar to how the system handles final generated content. However, the system may also process intermediate outputs without ever manifesting them to the user 102, treating them purely as internal processing artifacts.

Each approach offers distinct advantages and tradeoffs. For example, storing intermediate outputs may enable detailed tracking of the processing pipeline for debugging and refinement, user review of intermediate stages when desired, the ability to revert to intermediate states if needed, and enhanced auditability of the transformation process.

Transient processing without storage may provide improved processing efficiency by reducing storage overhead, cleaner separation between final outputs and processing artifacts, simplified content management workflows, and reduced complexity in the document data model.

The system 900 may implement hybrid approaches where some intermediate outputs are stored while others are processed transiently, based on factors such as the specific action definition requirements, user preferences, or system configuration. This flexibility allows optimization of storage and processing based on specific use case needs.

Operation 1008 of method 1000 involves manifesting generated output (e.g., the generated text 122), such as to enable user evaluation and approval decisions. The system 900 may manifest the output through various methods, such as visual output (such as text, images, and video), audio output, haptic output, or any combination of these manifestation types. The system 900 may, for example, provide immediate visual feedback by manifesting the generated output alongside the original content through real-time preview capabilities. This side-by-side comparison may allow the user 102 to easily evaluate changes before accepting them, with the system 900 initially manifesting the output adjacent to the original text and only implementing the replacement in the document 914 after receiving user confirmation.

For larger text transformations, the system 900 may manifest the output incrementally, updating portions of the visual display as they are processed. This incremental approach may maintain responsiveness and provide immediate feedback even for complex transformations. When manifesting output, the system 900 may highlight or otherwise visually indicate specific changes made to the content, which may help the user 102 quickly identify and review the transformations that would be applied. The system 900 may adapt how it manifests output based on the surrounding context in document 914 through context-aware rendering, which may ensure the output integrates seamlessly with existing content while still being distinguishable for review purposes.

The system 900 may allow the user 102 to interactively edit or fine-tune the manifested output directly in the visual representation before accepting it through interactive preview capabilities. This immediate editing capability may enhance the system's responsiveness to user preferences and provide additional control over the final output before it is applied to the document 914.

The system 900 may support undo/redo visualization, providing visual cues for reverting or reapplying changes in the manifested output. This allows users to easily evaluate different versions of the generated content.

The system 900 may generate a manifestation of the generated output in operation 1008 in any of a variety of ways, such as by applying a language model (e.g., an LLM) to the generated output to generate the manifestation (or to generate output which is then further processed to generate the manifestation). If a language model is used to generate the manifestation, that language model may be the same or different language model than the language model that was used to generate the output itself based on the current document element.

The manifestation may take any of a variety of forms. For example, the system may use summary manifestation, where a language model generates concise summaries of longer generated content, allowing users to quickly evaluate the key changes and implications before reviewing the full text. This may enable rapid assessment of whether the generated content meets the intended goals. The system may also provide enhanced visual representations by manifesting the generated text with visual enhancements such as highlighting specific changes, using different formatting to distinguish modifications, or presenting side-by-side comparisons that emphasize key differences. This may help users quickly identify and evaluate proposed changes.

In some embodiments, the manifestation may include contextual analysis display, which may provide additional context about how the generated text relates to or impacts surrounding document content. This may include previews showing how the content integrates with existing sections or analysis of document-wide coherence. The system may support interactive exploration by manifesting the content through interactive views that allow users to explore different aspects of the generated text, such as viewing alternative phrasings or examining specific modifications in detail. This may enable users to make more informed decisions about accepting the content.

The system may support multi-modal presentation by manifesting content through various combinations of visual, audio, and/or haptic feedback. This may allow users to evaluate the generated content through different modalities that may be more effective for specific types of review. For content generated through multi-stage processing, the system may provide staged review display by manifesting intermediate outputs alongside final output, enabling users to understand the transformation process and evaluate both intermediate and final results when beneficial.

The system 900 may manifest multiple types of output in operation 1008 to provide users with comprehensive context for evaluation. For example, in addition to manifesting the generated text 122 produced by applying the selected action definition 118, the system 900 may manifest output generated based on the current element E and/or output generated based on the selected action definition 118 itself.

These different types of output may be manifested individually or in various combinations. For example, the system may support manifesting the generated text 122 alongside or otherwise contemporaneously with output derived from the current element E, output based on the selected action definition 118, or both. This flexible approach enables rich contextual presentation to aid user review.

For example, when manifesting output based on the selected action definition 118, the system 900 may display the prompt or other parameters that were used to generate the generated text 122. This provides valuable context by helping users understand how and why particular content was generated.

The system 900 may use any of a variety of manifestation methods for this contextual information, such as any one or more of visual output (text, images, video), audio output, haptic output, or combinations thereof. This allows the additional context to be presented in ways that enhance user understanding while maintaining clear separation between different types of manifested content.

The system 900 may manifest an indicator in operation 1008 to signal the existence of generated output for the current document element E. Such indicators may take various forms beyond direct manifestation of the output text itself.

Examples of such indicators include flags, highlighting, or underlining applied to the current element E within document 914 to show that generated output exists for that element. These indicators may be implemented as modifications to existing manifestations of the element within the document interface.

Importantly, such indicators may, but need not, include textual content. For example, the system 900 may employ purely graphical or visual indicators (e.g., annotations or modifications to a manifestation of the current element E) to signal the presence of generated output, such as changing the appearance of the current element E through formatting, colors, icons, or other non-textual visual cues.

For example, the system may manifest such indicators by applying highlighting or background colors to elements with available generated output, adding margin indicators or icons adjacent to relevant elements, modifying the visual styling (e.g., borders, underlining) of elements that have associated output, and/or using graphical overlays or badges to indicate output availability. The system 900 may also provide a visual indication linking a manifestation of the output of operation 1006 (e.g., the generated text 122) to its corresponding element, such as by using a line segment that connects the manifestation of the output of operation 1006 to the manifestation of its corresponding document element.

These visual indicators enable users to quickly identify elements that have generated output available for review, while maintaining a clear separation between the original document content and the generated suggestions. The system provides flexibility in how these indicators are implemented and displayed, allowing them to be integrated seamlessly into the document interface while remaining clearly distinguishable for user reference.

The system 900 may implement any of a variety of triggers for performing operation 1008 to manifest generated output. While FIG. 10 shows operation 1008 within the element processing loop (operations 1002-1016), this is merely an example and is not required in all embodiments. Performance of operation 1008 may be triggered by user commands, where the system may manifest output in response to explicit user input via the user interface 104, such as when the user 102 requests to review generated content. This allows users to control when they want to evaluate proposed changes. The system may perform operation 1008 through periodic processing at regular intervals to update manifestations of generated output, which enables batch processing of multiple elements while maintaining system responsiveness. When the system detects periods of user inactivity, it may utilize this time to manifest output for pending elements during system idle states, optimizing system resource usage.

When triggered, operation 1008 may process multiple document elements simultaneously rather than individually. The system 900 may manifest output for a plurality of elements contemporaneously within a single document window or view. This batch manifestation approach enables efficient review of multiple proposed changes.

Operation 1008 may implement conditional manifestation based on determining whether specific conditions have been satisfied. For example, operation 1008 may only manifest the output if a condition is determined to be satisfied. As this implies, in such embodiments, operation 1008 does not manifest the output if the condition is determined not to be satisfied (or is not determined to be satisfied). The method 1000 may evaluate conditions based on any of a variety of data sources, such as the current element E, output generated in operation 1006 by applying the selected action definition, additional output derived from processing the action definition's output, and/or metadata and context from the document 914, in any combination.

Examples of conditions that may gate manifestation include confidence thresholds, quality metrics, and content analysis. Confidence thresholds may involve evaluating whether confidence scores exceed predetermined thresholds, assessing statistical measures of output quality, and analyzing certainty levels for generated content. Quality metrics may include validating output meets specified formatting requirements, verifying technical accuracy and terminology, and confirming content coherence with surrounding document context. Content analysis may encompass evaluating whether binary decisions derived from language model output meet criteria, verifying selections from permitted options satisfy constraints, and assessing whether generated content aligns with document standards.

As previously described, operation 1006 may generate a plurality of outputs, such as if operation 1006 applies an “alternative take” action definition or if operation 1006 applies a plurality of action definitions. The system 900 may manifest such multiple outputs in operation 1008 in any of a variety of ways. For example, for alternative take prompts that generate multiple outputs, the system may provide all outputs to the user 102 for review via the user interface 104. The user can then select one or more preferred outputs, and the system will use the selected output(s) to update the document.

The text generation module 120 may process multiple outputs internally using various methods. For example, the text generation module 120 may concatenate all outputs sequentially into a single comprehensive output, use predefined criteria to select the “best” output among alternatives, create a synthesized output incorporating elements from multiple alternatives, and/or use voting or consensus approaches to identify common elements across outputs.

The system 900 may manifest multiple outputs using various approaches. For example, the system 900 may provide side-by-side comparisons allowing evaluation of different versions, incremental updates showing progressive changes, highlighting differences between alternative outputs, and/or interactive editing capabilities for refining multiple outputs.

When manifesting multiple outputs, the system 900 may adapt the presentation based on surrounding document context, relationships between different outputs, integration requirements with existing content, and/or user preferences for output review.

The system 900 may determine whether the user 102 approves of the output (e.g., the generated text 122) that was generated by applying the selected action definition 118 to the current element E in any of a variety of ways. For example, the system 900 may receive direct user input, where the user 102 may provide explicit approval or rejection through various input methods via the user interface 104, including speaking voice commands, typing textual commands, and/or interacting with GUI elements like buttons or menu items.

The system 900 may enable interactive review, where users may review and approve content through side-by-side comparisons of original and generated content, interactive preview capabilities before finalizing changes, and/or the ability to edit or fine-tune manifested output directly before approval. In some embodiments, the system 900 may implement staged approval, where the system 900 may first insert generated content alongside original content for comparison, only implementing final changes upon user confirmation. This approach may allow users to evaluate changes in context before approving.

The system 900 may enable multi-modal input for approval, where approval input may be received via visual interfaces (clicking/tapping), voice commands, haptic interactions, and/or combinations of different input modes. For multiple generated outputs, the system 900 may enable batch approval, where users may review and approve multiple changes simultaneously (e.g., via a single user input), select specific outputs to approve from a set of alternatives, and/or approve changes incrementally or in groups.

The system may obtain the user 102's approval at any of a variety of times and in any of a variety of ways. While FIG. 10 shows operation 1010 within the element processing loop, this represents just one possible implementation approach. The method 1000 may omit operation 1010 from some or all iterations of the loop, allowing outputs to be generated for multiple elements before seeking any user approval. This enables batch processing of elements while maintaining user control over final content updates. In some embodiments, the performance of operation 1010 may be event-triggered, where the loop of operations 1002-1014 operates on multiple elements without performance of operations 1010-1012, but where receipt of a user input acts as a triggering event that triggers performance of operation 1010 (and operation 1012, if the user approves of the output). Such a triggering event may or may not interrupt the performance of the loop.

The system 900 may implement any of a variety of approval timing approaches. For example, the system 900 may support user-initiated review, where the user 102 may trigger review and approval of generated outputs at any time through the user interface 104. This approach may allow users to evaluate proposed changes when convenient, rather than requiring immediate approval for each element.

The system 900 may implement a staged review process that provides a structured review workflow. In such embodiments, the system 900 may generate outputs for multiple document elements and step the user through reviewing each generated output sequentially. The staged review process may enable approval decisions for individual elements or groups of elements while maintaining tracking of approved versus pending changes.

For multiple generated outputs, the system 900 may enable batch approval functionality. This approach may support reviewing and approving multiple changes simultaneously, selecting specific outputs to approve from alternatives, and approving changes incrementally or in groups. The batch approval feature may provide efficiency benefits when processing large numbers of document elements.

For alternative take prompts that generate multiple outputs, the system 900 may implement any one or more of the following approaches. The system 900 may provide all outputs for user review via the user interface 104, enabling the user 102 to examine each generated alternative before making a selection. The system 900 may enable selection of preferred outputs from among the multiple alternatives, allowing the user 102 to choose which outputs best meet their requirements. The system 900 may allow approval of selected output(s) for document updates, providing the user 102 with control over which alternatives are ultimately applied to revise the document 914.

The system 900 may implement any of a variety of approaches for batch approval of multiple outputs through single user inputs. For example, the system 900 may enable action definition-based approval, where users may approve all outputs generated using a specific selected action definition 118 with a single approval action. This batch processing approach may increase efficiency by reducing processing resources, as the system 900 may process multiple approval decisions simultaneously rather than handling each approval individually, thereby reducing the computational overhead associated with multiple separate approval operations. The system 900 may implement confidence-based approval, where the system may filter and present outputs meeting specified confidence thresholds for batch approval. In such embodiments, users may approve all outputs exceeding minimum confidence levels in a single operation, which may reduce memory usage by consolidating multiple approval states into a single batch operation rather than maintaining separate approval tracking for each individual output.

The system 900 may provide batch review capabilities that enable users to review and approve multiple changes simultaneously within a single document window. For example, users may select specific groups of outputs to approve from alternatives, and/or may approve changes incrementally across document sections. These batch review capabilities may enhance the efficiency of the document revision process while maintaining user control over which outputs are ultimately applied to the document. The batch processing approach may increase processing efficiency by reducing the number of individual user interface update operations, as the system 900 may consolidate multiple review operations into a single interface rendering cycle, thereby reducing the computational resources required for repeated interface updates and memory allocations associated with individual approval processing.

The system 900 may support various batch approval methods to enable efficient user interaction with multiple generated outputs. For example, embodiments of the system 900 may provide visual interfaces that allow users to approve multiple outputs through clicking or tapping approval buttons. In some cases, the system 900 may support voice commands for group approval, enabling users to approve multiple outputs through spoken instructions. The system 900 may also implement keyboard shortcuts that allow users to quickly approve batches of generated content. Embodiments of the system 900 may provide menu-based selection interfaces that enable users to select and approve multiple outputs simultaneously through dropdown menus, checkboxes, or other selection mechanisms. These batch approval methods may increase processing efficiency by reducing the number of individual input processing operations, as the system 900 may handle multiple approval decisions in a single processing cycle rather than executing separate processing routines for each individual approval, thereby reducing CPU utilization and memory overhead associated with repeated input handling operations.

For alternative take prompts generating multiple outputs, the system 900 may implement batch selection of preferred outputs from multiple alternatives, simultaneous approval of selected outputs for document updates, and/or group processing of related content changes. These capabilities may enable users to efficiently review and approve multiple generated alternatives while maintaining precise control over which outputs are applied to document elements. The system 900 may, for example, present multiple alternative outputs in a unified interface that allows users to select preferred versions across different document elements simultaneously, thereby streamlining the approval process for complex document revisions involving multiple alternative take prompts. This batch processing approach may increase efficiency by reducing memory usage through consolidated data structures that store multiple approval states together rather than maintaining separate memory allocations for each individual alternative, and may reduce processing resources by enabling the system 900 to execute document update operations in batches rather than performing individual update operations for each selected alternative.

The system 900 may support conditional batch approval through multi-stage processing that generates intermediate outputs for validation. For example, the system 900 may combine language model and algorithmic processing to assess conditions. In some embodiments, the system 900 may perform context-aware analysis of how outputs integrate with existing content to determine whether approval conditions are met. This batch processing approach may increase processing efficiency by reducing computational overhead through consolidated validation operations that process multiple outputs simultaneously rather than executing separate validation routines for each individual output, and may reduce memory usage by maintaining shared validation state data structures rather than allocating separate memory resources for individual output validation processes.

The system 900 may omit operation 1010 and automatically accept one or more generated outputs without requiring user approval in certain cases. This automatic acceptance results in using the outputs to update their corresponding document elements directly. The system 900 may support any of a variety of conditions that can trigger automatic acceptance, such as confidence thresholds, quality metrics, and/or content analysis. This automated approach may provide processor efficiency benefits by eliminating the computational overhead of user interface rendering and interaction processing for approved outputs, while reducing memory usage through immediate processing rather than storing outputs pending user review.

For confidence thresholds, the system 900 may automatically accept outputs that exceed predetermined confidence scores, use statistical measures of output quality to determine acceptance, and/or evaluate certainty levels for generated content. Quality metrics may include validating outputs meet specified formatting requirements, verifying technical accuracy and terminology, and/or confirming content coherence with surrounding document context. Content analysis may involve evaluating binary decisions derived from language model output, verifying selections from permitted options satisfy constraints, and/or assessing whether generated content aligns with document standards. These automated validation processes may reduce computational load by performing batch evaluations rather than individual user interface interactions for each output.

The method 1000 supports fully automated processing where multiple document elements are processed, corresponding outputs are generated for each element, all outputs meeting acceptance criteria are automatically applied, and document updates occur without manual review. This automated acceptance approach enables efficient document transformation while maintaining systematic quality control through predefined acceptance criteria. The batch processing capabilities may improve system performance by consolidating document update operations and reducing the memory footprint associated with maintaining multiple pending approval states across document elements.

The system 900 may process a plurality of document elements to generate outputs and automatically accept all outputs that meet specified criteria, without requiring any user approval of those outputs. This enables efficient batch processing while maintaining quality control through multi-stage processing generating intermediate validation outputs, combining language model and algorithmic processing for assessment, and/or context-aware analysis of content integration. This automated approach may provide processor efficiency benefits by eliminating the computational overhead of user interface rendering and interaction processing for approved outputs, while reducing memory usage through immediate processing rather than storing outputs pending user review.

The method 1000 supports fully automated processing where multiple document elements are processed, corresponding outputs are generated for each element, all outputs meeting acceptance criteria are automatically applied, and document updates occur without manual review. This automated approach may enable efficient document transformation while maintaining systematic quality control through predefined acceptance criteria. The batch processing capabilities may improve system performance by consolidating document update operations and reducing the memory footprint associated with maintaining multiple pending approval states across document elements.

This automated acceptance approach enables efficient document transformation while maintaining systematic quality control through predefined acceptance criteria. The system may achieve processing efficiency gains by reducing CPU utilization and memory overhead associated with repeated input handling operations, while enabling streamlined document updates through consolidated processing workflows.

Operation 1012 of method 1000 involves revising the document element based on the generated output. The system 900 may implement any of a variety of approaches for implementing these revisions. The output generated in operation 1006 may serve various purposes, including flagging elements for attention, providing revision content, and/or indicating that revision is needed without necessarily specifying the content of the revision or how to make the revision. Although operation 1012 is labeled as “revise element based on output,” in practice the revision in operation 1012 may be based on factors other than or in addition to the output generated in operation 1006, such as input from the user 102 (e.g., the user input received in operation 1010), including input specifying how to revise the element and/or input containing revised content of the element. The system 900 may use the generated output as a trigger for revision while deriving the actual revision content from one or more other sources, such as user input, which may be within the user approval input received in operation 1010 and/or in other user input.

The document update module 124 may, for example, perform direct replacement by conducting straightforward substitution, removing the original element content and inserting some or all of the generated output in its place. This approach may be suitable when the generated output is intended to completely replace the original element. Alternatively, the document update module 124 may perform direct replacement based on user-provided content received in operation 1010, where the generated output serves as a flag indicating that revision is needed, and the user input provides the actual replacement content. Direct replacement may provide processor efficiency benefits by eliminating the need for complex comparison operations, as the system 900 may execute a single substitution operation rather than analyzing differences between original and generated content.

Rather than full replacement, the system 900 may modify the element content in-place, applying changes only where necessary to transform it based on the generated output and/or other sources such as user input. This approach may help preserve certain formatting or structural elements of the original content while reducing memory usage through optimized data structure management that is only possible with computer systems. Additionally, the system 900 may compute the differences between the original element and generated output, then apply only these differences to update the document through differential updates. In some cases, the system 900 may compute differences based on user-provided revision content rather than the generated output, where the generated output serves as an indicator that revision is needed. This approach may be more efficient for large documents or when changes are minimal, as it reduces both processing overhead and memory allocation requirements by updating only the specific portions that have changed rather than recreating entire document sections, demonstrating concrete technical improvements to computer-based document revision systems.

The system 900 may support using a language model (e.g., LLM) to perform the revision in operation 1012, which is necessarily rooted in computer technology as language models require significant computational resources and processing capabilities that can only be implemented through computer systems. This language model may be the same language model used to generate the initial output, a different language model specialized for revision tasks, and/or multiple language models working in combination. The system 900 may implement staged replacement by first inserting generated output alongside original content for comparison before finalizing changes through computer-controlled processing workflows. In some cases, the system 900 may implement staged replacement by presenting user-provided revision content alongside original content, where the generated output serves as a trigger for the revision process. This approach may allow for side-by-side review before implementing updates while providing memory efficiency benefits through deferred processing, as the system 900 may delay resource-intensive final updates until user approval is confirmed, thereby avoiding unnecessary memory allocation for rejected changes.

When revising document elements, the system 900 may implement changes as new versions or commits through version control integration, enabling easy tracking of changes and potential rollbacks. The system may support implementing rules or conditions for replacement, such as only replacing text meeting certain criteria, preserving specific portions of original text, and/or applying changes based on document context. For large documents or complex transformations, the system 900 may replace content incrementally, allowing for user intervention at each stage, validation of progressive changes, and/or controlled rollout of updates. Incremental replacement may provide processor efficiency benefits by distributing computational load across multiple processing cycles rather than executing all updates simultaneously, thereby reducing peak memory usage and enabling more responsive user interactions during large-scale document revisions.

The system 900 may provide real-time preview features by providing immediate visual feedback during replacement, showing incremental updates as processing occurs, enabling side-by-side comparisons, and/or highlighting specific changes made. The system may adapt how it manifests revised content based on surrounding document context, integration requirements, existing formatting, and/or document structure through context-aware rendering capabilities. Real-time preview features may achieve processing efficiency by utilizing cached rendering data and incremental display updates, reducing the computational overhead associated with full document re-rendering while maintaining responsive user interface performance during content revision operations.

A cascading (branched) revisions feature disclosed herein may be implemented across any of the systems and methods described in this specification, including but not limited to system 100 of FIG. 1, system 300 of FIG. 3, system 500 of FIG. 5, system 700 of FIG. 7, and system 900 of FIG. 9. This feature may support automatically generating chains of outputs by sequentially applying action definitions to create branching revision possibilities. For example, any of these systems may apply a first action definition to a document element to generate first output, then apply (e.g., automatically) the same or different action definition to that output to generate additional output, thereby creating a branch of potential revisions to the document element. At any node in the branch, the system may apply a plurality of different action definitions (or an alternative take action definition) to the output at that node, thereby forking off additional branches from that node.

This process creates tree structures where the original document element serves as the root node and different action definition applications create different branches, with each node representing a potential revision. Multiple such trees can exist for different document elements within the same document. Any of the systems disclosed herein may enable users to explore these generated trees of potential revisions, review different branches and nodes, and select and accept any node in the tree. When a node is accepted, the system revises the corresponding document element based on that accepted node.

This approach may be used to transform document revision from manual text writing to an exploration and selection process across any of the disclosed systems. Users may navigate through automatically generated revision options, compare different potential changes, and choose preferred revisions from the generated possibilities. The system may apply the selected revisions to update the document. Through this branching capability, any of the systems disclosed herein may maintain flexibility in how revision trees are generated and explored, while ensuring users maintain precise control over which revisions are ultimately applied to the document.

Any of the systems disclosed herein may support both explicit and implicit references between nodes in the revision trees, enabling sophisticated branching transformations. This allows for complex relationships between different potential revisions while maintaining document coherence. The system may process multiple document elements simultaneously, generating and managing multiple revision trees while preserving the overall document structure and formatting.

When generating a chain of outputs based on a particular document element, any of the systems disclosed herein may apply one or more action definitions sequentially to generate successive outputs. The first action definition applied to the document element may be selected using any of the methods previously described. Each subsequent output in the chain may be generated by applying an action definition to the previous output in the chain.

For example, when generating a second output in the chain, any of the systems disclosed herein may apply a second action definition to process the first output that was generated. The second action definition may be either the same action definition that was used to generate the first output, or it may be a different action definition.

Embodiments of the present invention may apply the same action definition repeatedly in a chain to achieve progressive refinement of content. For example, in a summarization refinement process, the system may first apply a summarization action definition to a long technical document element to generate an initial summary. The system may then apply the same summarization action definition to the initial summary to generate a further condensed version. In a third application, the system may apply the summarization action definition again to create an executive-level brief. Each iteration may produce increasingly concise content while maintaining key points from the original document element.

As another example of applying the same action definition repeatedly, embodiments may implement an expansion development process. In this approach, the system may first apply an expansion action definition to initial content to generate additional details. The system may then apply the same expansion action definition to the expanded content to further elaborate on the material. In a third application, the system may apply the expansion action definition again to add more depth and examples. Each iteration may build additional layers of detail and complexity upon the previous output. Alternatively, embodiments of the present invention may apply different action definitions in sequence to achieve compound transformations.

Embodiments of the present invention may implement technical content processing through sequential application of different action definitions. In this approach, the system may first apply an action definition that simplifies technical content for a general audience, transforming complex technical language into more accessible terminology. The system may then apply a second action definition that restructures the simplified content into bullet points, organizing the information into a more digestible format. Subsequently, the system may apply a third action definition that adds explanatory examples to the structured content, providing concrete illustrations of abstract concepts. This sequential processing may result in accessible, well-structured technical documentation that maintains technical accuracy while improving readability for non-technical audiences.

Embodiments may also implement language transformation through a multi-stage process involving different action definitions. The system may first apply an action definition that translates content to a target language, converting the source text while preserving meaning and context. Following the translation, the system may apply a second action definition that adapts the tone for cultural context, adjusting linguistic nuances and cultural references to align with the target audience's expectations. The system may then apply a third action definition that optimizes formatting for the specific locale, adjusting date formats, currency representations, and other locale-specific elements. This sequential transformation process may create culturally appropriate localized content that goes beyond literal translation to provide culturally sensitive communication.

Document refinement may be achieved through another sequential application approach where embodiments apply multiple action definitions to progressively improve content quality. The system may first apply an action definition that rephrases content for clarity, eliminating ambiguous language and improving sentence structure for better comprehension. The system may then apply a second action definition that adjusts tone for the target audience, modifying formality levels, vocabulary choices, and communication style to match audience expectations. Finally, the system may apply a third action definition that optimizes structure and formatting, reorganizing content hierarchy, improving visual presentation, and ensuring consistent formatting throughout the document. This multi-stage refinement process may produce polished, audience-appropriate content that effectively communicates the intended message while maintaining professional presentation standards.

Subsequent action definitions in a chain may be selected using any of the methods previously described for selecting action definitions. The system may support selecting these subsequent action definitions based on one or more previous outputs that were generated earlier in the chain.

The system enables both explicit and implicit references to previously generated outputs when selecting and applying subsequent action definitions in the chain. Explicit references may include direct references to specific prior outputs by their identifiers or references to content generated within particular template sections. Implicit references may encompass broader contextual references such as references to the entire document state or surrounding context.

The selection of subsequent action definitions may be based on any one or more of the following, in any combination: analysis of the content and structure of previous outputs, context-aware processing that considers document state, user preferences and workflow requirements, and/or document type and content sensitivity. For example, embodiments of the present invention may analyze the content and structure of previous outputs in the chain to determine which action definition would be most appropriate for the next transformation step. In some cases, the system may perform context-aware processing that considers the current document state, including formatting, structure, and existing content relationships. The selection process may take into account user preferences and workflow requirements, such as preferred writing styles, target audiences, and/or specific document objectives. Embodiments may consider document type and content sensitivity when selecting subsequent action definitions, ensuring that transformations are appropriate for the specific context and requirements of the document being processed.

For compound transformations, the system may support selecting action definitions that build upon and refine content created in earlier stages. This enables sophisticated multi-stage content generation where the context and content from earlier generations inform and enhance later content generation steps.

Any of the systems disclosed herein may enable applying multiple different action definitions to a single document element to generate distinct initial outputs, creating separate branches with the original element as the root node. Each of these branches may then be further developed using any of the previously described techniques for generating additional nodes. Some useful applications of generating multiple branches from a single document element include content adaptation, where one branch may apply action definitions to simplify technical content for general audiences, another branch may apply definitions to expand technical details for specialists, and a third branch may transform content for educational purposes. This enables creating multiple versions tailored to different audiences from the same source content.

Language processing applications may involve one branch generating translations into different target languages, another branch adapting tone and style for different cultural contexts, and additional branches optimizing formatting for different locales. This facilitates efficient multilingual content creation from a single source. Document structuring applications may include one branch transforming content into bullet points and summaries, another branch expanding content with detailed explanations, and additional branches reorganizing content for different document types. This enables flexible content restructuring for various documentation needs.

Style variations may be implemented where one branch adjusts tone for formal business communication, another branch creates casual, conversational versions, and additional branches adapt style for different industry contexts. This allows generating multiple style variations while maintaining core message integrity. These branching capabilities may enable users to explore different transformation possibilities from a single document element, providing flexibility in content adaptation while maintaining efficient processing workflows.

Any of the systems disclosed herein may maintain precise control over these branching transformations through context-aware processing that considers document state, support for both explicit and implicit references between branches, and the ability to process multiple branches simultaneously while preserving document structure. This enables sophisticated multi-branch content generation while ensuring document coherence and quality.

The context-aware processing capabilities may enable any of the systems disclosed herein to analyze the current state of the document during branching operations, including document structure, existing content relationships, and formatting requirements. For example, when generating multiple branches from a single document element, the system may consider surrounding paragraphs, section headings, and document metadata to ensure that each generated branch maintains appropriate contextual relevance. This context-aware approach may help preserve document coherence even when multiple transformation paths are explored simultaneously.

The support for explicit and implicit references between branches may provide sophisticated relationship management capabilities across the branching structure. Explicit references may include direct citations to specific nodes within the branch hierarchy, enabling one branch to reference content generated in another branch through identifiers or positional markers. Implicit references may encompass broader contextual relationships, such as thematic connections or stylistic consistency requirements that span multiple branches. These reference capabilities may enable complex interdependencies between different transformation paths while maintaining clear traceability of content relationships.

The ability to process multiple branches simultaneously while preserving document structure may involve coordination mechanisms that manage concurrent transformation operations. For example, when multiple document elements are being processed in parallel to generate their respective branching trees, the system may implement synchronization protocols to ensure that document formatting, numbering sequences, and cross-references remain consistent across all branches. This simultaneous processing capability may significantly improve performance for large documents while maintaining the integrity of complex document structures and relationships.

In some embodiments, when any of the systems disclosed herein is able to generate a chain (branch) containing a plurality of nodes automatically, the system may implement a method for controlling branch generation through stopping criteria. For example, the method may include generating a first node in a branch by applying an action definition to a document element. The method may further include determining whether a stopping criterion has been satisfied, such as by evaluating whether a predetermined chain depth limit has been reached, whether content convergence has been detected between successive outputs, or whether quality metric thresholds indicate diminishing returns in content refinement. If the stopping criterion has not been satisfied, the method may include generating another node in the branch by applying the same or a different action definition to the output of the previous node. If the stopping criterion has been satisfied, the method may include stopping the generation of additional nodes in the branch, thereby preventing infinite chains or excessive generation. This process may be repeated iteratively, with each iteration involving generating a new node, determining whether stopping criteria are satisfied, and either continuing or terminating the branch generation process based on that determination.

Such stopping criteria may be implemented through various mechanisms. For example, embodiments of the present invention may implement user-defined controls that enable users to specify maximum chain depth limits, set quality thresholds for continued generation, define specific stopping conditions based on content characteristics, and/or configure branch-specific generation parameters. These user-defined controls may provide flexibility in managing the extent and scope of branch generation according to specific user requirements and document contexts.

Embodiments of the present invention may implement stopping criteria that operate automatically, regardless of how such stopping criteria were specified (e.g., by a user or by system-defined defaults). For example, the system may implement content convergence detection that identifies when successive outputs become too similar, thereby indicating diminishing returns in continued generation. The system may employ quality metric thresholds that automatically halt generation when predetermined quality standards are no longer being met. Embodiments may include context-aware analysis of output coherence and relevance, along with statistical measures of diminishing returns in content refinement. These stopping criteria may be automatically applied by the system, enabling efficient branch generation while preventing excessive or unproductive content generation cycles.

Any of the systems disclosed herein may implement stopping logic through confidence thresholds, content analysis, and multi-stage validation. Confidence thresholds may involve automatically stopping when output confidence scores fall below thresholds, using statistical measures to evaluate output quality, and assessing certainty levels for generated content. Content analysis may include evaluating content coherence with previous outputs, verifying technical accuracy remains consistent, and analyzing whether further refinements provide meaningful improvements. Multi-stage validation may encompass generating intermediate validation outputs, combining language model and algorithmic processing for assessment, and context-aware analysis of content integration and quality.

As described elsewhere herein, any output generated by any of the systems disclosed herein may be stored within the corresponding document or outside the document. The same is true of any branches described herein. For example, any of the systems disclosed herein may implement any one or more of the following approaches for storing branches generated from document elements.

Embodiments of the present invention may implement internal document storage approaches where branches may be stored as embedded metadata within the document structure. The document may maintain a hierarchical representation of branches using DOM or DOM-like structures, enabling the system to preserve relationships between nodes while maintaining document formatting and organization. Branch data may be stored in specialized document sections that preserve relationships between nodes, allowing the system to maintain branch structures while preserving document formatting and organization.

Alternatively, embodiments of the present invention may utilize external storage options where branches may be stored in separate data structures outside the document. External databases may maintain branch relationships and metadata, while dedicated storage systems may manage complex branch hierarchies. Cloud-based storage may enable distributed access to branch data, providing flexibility in how branch information is maintained and accessed across different computing environments.

The system may support structured storage approaches through DOM-based interfaces that provide programmatic access to document elements. These approaches may utilize hierarchical relationships between document components and parent-child relationships between content sections. Standardized selectors may be employed for accessing branch nodes, enabling consistent and reliable navigation of branch structures regardless of the underlying storage implementation.

When storing branches internally, the system may select specific content nodes by type and attributes, enabling precise targeting of document elements for branch generation. The system may access surrounding context through structural relationships and navigate document structure using standard traversal methods. This approach may allow the system to reference content across different structural levels, maintaining coherent relationships between branch nodes and their corresponding document elements while preserving the overall document organization and formatting.

As described elsewhere herein, when any of the systems disclosed herein generates output, the user 102 may review and approve that output. Upon receiving the user's approval of a particular output, the system may revise the corresponding document element based on the approved output.

When any of the systems disclosed herein has generated a branch containing multiple nodes of successive outputs, the user 102 may select and approve any node within that branch, regardless of how many layers deep that node exists within the branch structure. The selected node may be, for example, the first output generated in the branch, the last output generated, or any intermediate output.

Upon receiving the user's selection of a particular node within a branch, any of the systems disclosed herein may employ any of the previously described techniques to revise the document element that corresponds to the root of that branch (i.e., the original document element from which the branch was generated) based on the selected node's output. This revision process maintains all the capabilities previously described for document updates, including the ability to replace existing content, modify content while preserving certain elements, or add new content without modifying the original.

Any of the systems disclosed herein may support this flexible selection and revision process through their respective document update modules, which may update the corresponding document based on any selected output to generate a revised version. This enables users to explore multiple potential revisions represented by different nodes in a branch while maintaining precise control over which revisions are ultimately applied to the document.

When applying an accepted node that exists multiple layers deep within a branch, any of the systems disclosed herein may apply each intermediate node in sequence, starting from the root and proceeding through each successive node up to and including the accepted node. This sequential application process is particularly important in cases where each node in the branch specifies incremental or differential changes relative to the previous node's output.

For example, when a user selects a node that is several layers deep in a branch, any of the systems disclosed herein may process the chain of transformations sequentially, with each node building upon and refining the content created by previous nodes. This enables compound transformations where the context and content from earlier generations inform and enhance later content generation steps. The respective text generation modules may process these chained transformations using one or more language models, with each successive action definition potentially employing the same or different language models to generate refined outputs.

In certain embodiments, any of the systems disclosed herein may implement document revisions through a state-based approach rather than directly modifying content of the corresponding document. When the user 102 approves a particular output, instead of modifying the content of the corresponding document element, the system may mark the original document element as “inactive” and mark the approved output as “active.” The current state of the document is then defined by the set of document elements that have an “active” status. In such embodiments, the system may manifest the current state of the document to the user 102 by rendering only those document elements that have an “active” status.

This approach provides several technical advantages for implementing document updates across any of the disclosed systems. For example, the respective document update modules may maintain both original and modified content while providing a clear representation of the current document state through selective rendering. This enables efficient tracking and management of document revisions without requiring direct modification of original content.

The implementation supports any of the disclosed systems' ability to process multiple document elements simultaneously while preserving document structure and formatting. When manifesting the document state, any of the systems disclosed herein may maintain proper document organization by rendering active elements in their appropriate positions and contexts within the document hierarchy.

Any of the systems disclosed herein may implement any of a variety of GUI approaches to enable users to navigate and select nodes from output trees. These approaches may include tree view navigation, which provides an interactive expandable/collapsible tree structure showing hierarchical relationships between outputs, visual indicators showing active/inactive status of nodes, preview capabilities when hovering over nodes, and clear highlighting of currently selected nodes. The systems may implement multi-panel interfaces that include a main document view showing current active content, a side panel displaying the tree of generated outputs, a preview panel showing content of selected nodes, and controls for applying selected nodes to documents. The systems may support visual branch navigation through graphical representation of branches and nodes, the ability to traverse up and down branches, visual indicators of node relationships and generation sequence, and interactive selection of nodes at any depth.

Any of the systems disclosed herein may support real-time preview capabilities when navigating these interfaces, allowing users to see immediate visual feedback of node content, compare multiple nodes simultaneously, evaluate potential revisions before approval, and navigate complex branch structures efficiently. These preview capabilities may enable users to make informed decisions about content selection while maintaining efficient workflow through the branch navigation process.

The cascading revisions feature may be implemented across different systems with system-specific adaptations. In the context of system 100 of FIG. 1, the text generation module 120 may generate multiple successive versions of generated text 122 by applying different action definitions sequentially to the selected text 116. The action processor 112 may coordinate the generation of revision trees, with each node representing a different transformation of the selected text 116. The document update module 124 may then apply any selected node from the revision tree to update the selected document 114.

For the generative cut and paste system 300 of FIG. 3, cascading revisions may be applied during either the copy operation or paste operation, creating multiple processed versions of clipboard content. During the copy operation, the text generation module 326 may generate a revision tree from the original content 304, storing multiple processed versions in the clipboard 328. During the paste operation, additional revision branches may be generated based on the destination context, enabling context-aware content adaptation.

In the painting system 500 of FIG. 5, cascading revisions may generate multiple painted text variations by sequentially applying different painting configurations 552. The painting configuration module 550 may select successive configurations to create revision chains, with each painted text 512 serving as input for subsequent transformations. This enables progressive refinement of content style and formatting through multiple painting stages.

For the generative merge system 700 of FIG. 7, cascading revisions may be applied to action definitions within the merge template 714. The text generation module 120 may generate revision trees for dynamic content elements, enabling multiple versions of merged content to be generated and evaluated. Each merge data element 716 may trigger different revision branches, creating personalized content variations within the merged document 726.

Various aspects of the system 900 and method 1000 may be implemented using agent-based architectures that enable sophisticated autonomous processing while maintaining user control over document revision workflows. Referring to FIG. 9, embodiments of the system 900 may employ multiple specialized agents that operate independently or in coordination to enhance the capabilities of the action processor 112, text generation module 120, and document update module 124.

The automated identification of action definitions in operation 1004 may be particularly well-suited for agentic implementation. Embodiments of the system 900 may include context-aware analysis agents that analyze document elements to determine content type, writing style, technical complexity, and structural role within the document 914. Content classification agents may examine element characteristics including formality level, specialized terminology, and organizational structure to inform action definition selection. Adaptive selection agents may evaluate surrounding document context, element relationships, and document-level metadata from the documents 110a-m to choose contextually appropriate action definitions from the action definition library 106. Language model-based identification agents may analyze element content and determine suitable transformations based on content type and complexity, potentially using the same or different language models as the text generation module 120.

With continued reference to FIG. 9, element selection and processing in operation 1002 may present significant opportunities for agent-based implementations. Resource-based selection agents may analyze computational requirements, processing time, memory usage, and system resources to determine which elements in the document 914 should be processed. Position-based selection agents may dynamically track cursor position through the user interface 104 and automatically update element selection as the user 102 navigates through the document 914. Context-based selection agents may analyze document structure, content type, and writing style to automatically choose appropriate elements for processing. Dependency analysis agents may build dependency graphs between document elements and determine optimal processing sequences that satisfy interdependencies while maintaining document coherence.

The system 900's event-based architecture may enable agent implementations for background and asynchronous processing. Background processing agents may continuously monitor document content for processing opportunities and apply action definitions from the action definition library 106 asynchronously without interrupting user workflow. Event-driven processing agents may respond to specific triggers, user actions, and document modifications in real-time through coordination with the user interface 104. Parallel processing coordination agents may manage multiple simultaneous processing operations while maintaining system responsiveness and coordinating with the text generation module 120 to optimize resource utilization.

The system 900's support for complex processing workflows may be enhanced through agent orchestration. Multi-stage processing agents may coordinate sequential application of different action definitions to achieve compound transformations during operation 1006. Workflow orchestration agents may manage chained processing where initial stages generate foundational content and subsequent stages refine outputs, potentially involving multiple iterations of operations 1004 and 1006. Quality assessment agents may evaluate intermediate outputs and determine whether additional processing stages are needed before proceeding to operation 1008 for manifestation.

The cascading revision capabilities disclosed herein may present extensive agentic opportunities. Branch generation agents may automatically create revision trees by sequentially applying action definitions to generate multiple potential outputs for each document element. Stopping criteria agents may implement logic to determine when to halt branch generation based on content convergence, quality metrics, or depth limits. Branch navigation agents may help users explore complex revision trees through the user interface 104 and identify optimal transformation paths for selection in operation 1010.

Embodiments of the system 900 may implement performance optimization features through intelligent agents. Predictive processing agents may pre-generate likely outputs based on user interaction patterns and gesture trajectories, enabling faster response times during operations 1006 and 1008. Cache management agents may implement context-aware caching strategies that adapt to document state and user workflow, storing frequently used action definitions from the action definition library 106 and previously generated outputs. Resource allocation agents may dynamically balance processing loads across distributed systems and optimize performance based on available computational resources, coordinating between local and remote processing capabilities.

The system 900's support for conditional operations may enable sophisticated agent-based quality control. Quality assessment agents may evaluate confidence thresholds, content coherence, and technical accuracy to determine whether outputs should be manifested in operation 1008 or automatically accepted without user approval in operation 1010. Validation agents may perform multi-stage validation combining language model analysis with algorithmic processing to assess output quality before manifestation. Approval workflow agents may implement sophisticated batch approval strategies based on content characteristics and user preferences, potentially automating the approval process in operation 1010 for outputs meeting predetermined criteria.

These agentic implementations may operate independently or in coordination, creating a sophisticated ecosystem of specialized agents that enhance the capabilities of the system 900 while maintaining user control over the document revision process. The agents may communicate through standardized interfaces and protocols, enabling modular deployment where different agents may be activated based on user preferences, document characteristics, or processing requirements. This agent-based architecture may provide scalability and flexibility, allowing the system 900 to adapt to different use cases and computational environments while preserving the core functionality described in method 1000.

The present disclosure provides a computer-implemented method for automated document revision. The method includes receiving user input specifying an action definition, and for each element in a document, identifying the action definition, applying the identified action definition to the element using a language model to generate output corresponding to the element, and manifesting the output corresponding to the element. The method further includes receiving user input approving of an output corresponding to a particular one of the elements in the document, and in response to the user input, revising the particular one of the elements in the document based on the output corresponding to the particular one of the elements in the document.

In various embodiments, the language model comprises a large language model. Applying the identified action definition may include identifying a prompt specified by the action definition, generating a processed prompt based on the prompt specified by the action definition and the element, and providing the processed prompt to the language model to generate language model output.

The method may involve receiving user input specifying an action definition that comprises receiving user input specifying a tokenized prompt including at least one token that is replaced with content from the element during application of the action definition. Alternatively, receiving user input specifying an action definition may comprise receiving user input selecting the action definition from an action definition library containing a plurality of action definitions. In such cases, the action definition library may store a short name corresponding to the action definition, and receiving user input selecting the action definition comprises receiving user selection of the short name.

In other embodiments, receiving user input specifying an action definition comprises receiving user input creating the action definition through a user interface. Applying the identified action definition may comprise applying a plurality of action definitions to the element to generate a plurality of outputs corresponding to the element. The method may also involve multi-stage processing including applying a first action definition to generate intermediate output and applying a second action definition to the intermediate output to generate the output corresponding to the element.

Processing each element in the document may comprise processing only elements that meet predetermined selection criteria. The steps of identifying the action definition, applying the identified action definition, and manifesting the output may be performed automatically in background processing without user intervention.

The present disclosure also provides a system comprising at least one non-transitory computer-readable medium having computer program instructions stored thereon, the computer program instructions being executable to perform the method described above. The system implements the same functionality as the method, including the ability to apply action definitions using language models, manifest outputs for user review, and revise document elements based on approved outputs while maintaining user control over the document revision process.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention may provide input to a language model, such as a large language model (LLM), to generate output. Such a function is inherently rooted in computer technology and cannot be performed mentally or manually. As another example, embodiments of the present invention may be used to automatically generate output using a language model, such as an LLM, and then to automatically update a computer-implemented document based on the output of the language model. As yet another example, embodiments of the present invention may be used to execute arbitrary scripts including conditional statements and loops. All of these functions are inherently rooted in computer technology, are inherently technical in nature, and cannot be performed mentally or manually. Furthermore, embodiments of the present invention constitute improvements to computer technology for using language models, such as LLMs, to generate improved output, and to generate such improved output more efficiently than state-of-the-art technology for the reasons provided herein.

The generative cut and paste features of embodiments of the present invention are necessarily rooted in computer technology, as they leverage computational capabilities to transform and manipulate digital content in ways that would be impossible or impractical to achieve through manual means. Key aspects that demonstrate the generative cut and paste features' inherent reliance on computer technology include:
Integration with Language Models: The generative cut and paste features may utilize large language models (LLMs) to process and generate text. These models, which can contain billions of parameters, require significant computational resources and are fundamentally tied to computer systems.
Real-time Content Processing: The generative cut and paste features perform complex text transformations during copy and paste operations in real-time, a feat that is only achievable through the use of advanced computer processing capabilities.
Dynamic Action Definitions: The generative cut and paste features support various types of action definitions, including tokenized prompts, compound prompts, and scripted prompts. These dynamic, programmable instructions are inherently computational in nature and rely on computer systems for execution and management.
Contextual Awareness: The generative cut and paste features' ability to consider the context of both source and destination documents during content transformation requires sophisticated data analysis and processing that can only be performed by computer systems.
Two-stage Processing: The generative cut and paste features' capability to perform separate generative processing during both copy and paste operations involves complex data handling and transformation that is uniquely suited to computer systems.
User Interface Integration: The seamless integration of AI-driven content manipulation within existing document editing interfaces requires intricate software engineering and is inherently tied to computer-based user interfaces.
Clipboard Management: The generative cut and paste features' ability to store and manage multiple versions of copied content (original and processed) in the clipboard is a function that relies on computer memory and data management systems.
Event-based Processing: The generative cut and paste features' ability to respond to various user inputs and trigger appropriate actions in real-time is rooted in event-driven programming paradigms specific to computer systems.

These features collectively demonstrate that the generative cut and paste features are not merely an automation of manual processes, but rather a novel system that is necessarily rooted in computer technology.

Furthermore, the generative cut and paste features of embodiments of the present invention represent a significant improvement to computer technology in several key aspects:
[symbol] Enhanced Efficiency in Content Manipulation: The generative cut and paste features streamline the process of content transformation by integrating AI-driven processing directly into the familiar copy-paste workflow. This integration allows for complex content manipulations to be performed with minimal user input, significantly reducing the time and effort required compared to traditional methods.
[symbol] Advanced Contextual Processing: The generative cut and paste features' ability to consider the context of both source and destination documents during content transformation represents a leap forward in intelligent content handling. This contextual awareness enables more relevant and coherent transformations, improving the quality of generated content in ways that were not previously possible with conventional copy-paste operations.
[symbol] Flexible Two-Stage Processing: The generative cut and paste features' capability to perform separate generative processing during both copy and paste operations introduces a new level of flexibility in content manipulation. This two-stage approach allows for more sophisticated and nuanced transformations that can adapt to changing contexts between the source and destination documents.
[symbol] Customizable AI Interactions: By supporting user-defined action definitions, ranging from simple prompts to complex scripted operations, the generative cut and paste features provide a level of customization in AI-assisted content manipulation that goes beyond what is typically available in existing technologies. This allows users to tailor the system's behavior to their specific needs and workflows.
[symbol] Improved User Interface for AI Integration: The generative cut and paste features seamlessly integrate advanced AI capabilities into existing document editing interfaces, representing an improvement in how users interact with AI-assisted tools. This integration reduces the learning curve and cognitive load associated with adopting new AI technologies.
[symbol] Enhanced Content Version Management: The generative cut and paste features' ability to maintain both original and processed versions of copied content in the clipboard represents an improvement in content version control within the copy-paste paradigm. This feature provides users with greater flexibility and safety in content manipulation.
[symbol] Real-time Complex Text Transformations: The generative cut and paste features enable real-time processing of complex text transformations during copy and paste operations, leveraging advanced computational capabilities to perform tasks that would be impractical or impossible to achieve manually.
[symbol] Scalable AI Integration: By building upon familiar copy-paste operations, the generative cut and paste features provide a scalable approach to integrating AI capabilities into document editing. This allows for gradual adoption of AI-assisted features, from simple transformations to complex, multi-step operations.

These improvements collectively enhance the capabilities of computer-based document editing systems, enabling more efficient, context-aware, and flexible content manipulation. The generative cut and paste features represent a significant step forward in integrating advanced AI technologies into everyday computing tasks, improving productivity and expanding the possibilities of digital content creation and editing.

The generative cut and paste features of embodiments of the present invention bring about a transformation of subject matter into a different state or thing in several significant ways:
Text Transformation: The generative cut and paste features transform selected text from its original form into a new, processed form through the application of AI-driven generative processing. This transformation may, for example, involve changes in content, style, tone, or structure of the text, effectively converting it from one state to another.
Clipboard Content Transformation: The generative cut and paste features transform the conventional clipboard content into processed clipboard content during the copy operation. This represents a change in the state of the clipboard data, from its original form to an AI-processed form.
Document Content Transformation: When the processed content is pasted into a document, it transforms the destination document's content, potentially altering its meaning, structure, or overall composition. This represents a transformation of the document from one state to another.
Multi-stage Transformation: The generative cut and paste features' two-stage processing capability allows for sequential transformations of content. The first transformation occurs during the copy operation, and a second transformation can occur during the paste operation. This multi-stage process can result in content that is significantly different from its original state.
Context-based Transformation: The generative cut and paste features' ability to consider the context of both source and destination documents during content transformation can result in adaptive changes to the text. This contextual transformation can produce content that is fundamentally different from the original, tailored to fit seamlessly into its new environment.
Non-contiguous Text Transformation: The generative cut and paste features allow for the selection and transformation of multiple non-contiguous blocks of text. This capability can result in the creation of new, coherent content from disparate parts of a document, effectively transforming disconnected text into a unified whole.
Format and Style Transformation: Through the use of custom action definitions, the generative cut and paste features can transform not only the content of the text but also its format and style. This can include changes in tone, formality, or even the conversion of text into different formats (e.g., from prose to bullet points).

These transformations demonstrate that the generative cut and paste features of embodiments of the present invention go beyond mere information transfer or simple text editing. Instead, they enable the creation of new content states and forms, representing a true transformation of subject matter from one state or thing into another.

Embodiments of the system 500 and method 600 transform subject matter into a different state or thing. For example, embodiments of the system 500 and method 600:
[symbol] Text Transformation: The system transforms selected text from its original form into a new, processed form through AI-driven generative processing. This transformation may involve changes in content, style, tone, or structure of the text, effectively converting it from one state to another.
[symbol] Document Content Transformation: When the processed content is pasted into a document, it transforms the destination document's content, potentially altering its meaning, structure, or overall composition. This represents a transformation of the document from one state to another.
[symbol] Multi-stage Transformation: The system's two-stage processing capability allows for sequential transformations of content. The first transformation occurs during the copy operation, and a second transformation can occur during the paste operation. This multi-stage process can result in content that is significantly different from its original state.
[symbol] Context-based Transformation: The system's ability to consider the context of both source and destination documents during content transformation can result in adaptive changes to the text. This contextual transformation can produce content that is fundamentally different from the original, tailored to fit seamlessly into its new environment.

These transformations demonstrate that embodiments of the system 500 and method 600 go beyond mere information transfer or simple text editing, enabling the creation of new content states and forms.

Embodiments of the system 500 and method 600 also solve problems necessarily rooted in computer technology and improves computer technology in several ways, such as:
Enhanced Efficiency in Content Manipulation: The system streamlines the process of content transformation by integrating AI-driven processing directly into the familiar copy-paste workflow. This integration allows for complex content manipulations to be performed with minimal user input, significantly reducing the time and effort required compared to traditional methods.
Advanced Contextual Processing: The system's ability to consider the context of both source and destination documents during content transformation represents a leap forward in intelligent content handling. This contextual awareness enables more relevant and coherent transformations, improving the quality of generated content in ways that were not previously possible with conventional copy-paste operations.
Flexible Two-Stage Processing: The capability to perform separate generative processing during both copy and paste operations introduces a new level of flexibility in content manipulation. This two-stage approach allows for more sophisticated and nuanced transformations that can adapt to changing contexts between the source and destination documents.
Customizable AI Interactions: By supporting user-defined action definitions, ranging from simple prompts to complex scripted operations, the system provides a level of customization in AI-assisted content manipulation that goes beyond what is typically available in existing technologies.
Improved User Interface for AI Integration: The system seamlessly integrates advanced AI capabilities into existing document editing interfaces, representing an improvement in how users interact with AI-assisted tools. This integration reduces the learning curve and cognitive load associated with adopting new AI technologies.
Real-time Complex Text Transformations: The system enables real-time processing of complex text transformations during copy and paste operations, leveraging advanced computational capabilities to perform tasks that would be impractical or impossible to achieve manually.

These improvements collectively enhance the capabilities of computer-based document editing systems, enabling more efficient, context-aware, and flexible content manipulation.

The generative drag operation disclosed herein may include one or more of the following features:
[symbol] Improvement to Computer Technology: The generative drag operation may enhance existing drag-and-drop functionality in computer systems by incorporating real-time, context-aware text transformations. This represents a significant improvement over traditional drag-and-drop operations, which typically only move or copy content without modification.
[symbol] Necessarily Rooted in Computer Technology: The operation may leverage advanced computational capabilities, such as real-time processing of complex text transformations and integration with large language models, which are inherently tied to computer technology. These features cannot be performed manually or mentally, making the generative drag feature necessarily rooted in computer technology.
[symbol] Transformation of Subject Matter: The generative drag operation transforms the selected text from its original form into a new, processed form, such as by using AI-driven generative processing. This transformation may involve changes in content, style, tone, or structure of the text, effectively converting it from one state to another.
[symbol] Real-time Processing and Feedback: The system's ability to perform complex text transformations in real-time during the drag operation and provide immediate visual feedback through previews demonstrates a level of processing speed and interactivity that is only achievable through advanced computer technology.
[symbol] Context-aware Adaptations: The generative drag operation's ability to consider the context of both the current drag location and the final destination for selecting and applying appropriate transformations represents a sophisticated level of analysis and decision-making that goes beyond well-understood, routine, and conventional computer functions.
[symbol] Integration of AI Capabilities: By seamlessly incorporating generative AI capabilities into familiar user interface paradigms, the generative drag operation represents a novel approach to human-computer interaction in document editing workflows.
[symbol] Dynamic Multi-stage Processing: The generative drag operation's ability to perform separate generative processing during both the drag operation and at the final destination introduces a new level of flexibility in content manipulation that is uniquely suited to computer systems.

These features collectively demonstrate that the generative drag operation is not merely an abstract idea implemented on a computer, but a technological innovation that leverages advanced computational capabilities to provide a novel and useful tool for document editing. The operation's ability to dynamically transform content based on context, provide real-time feedback, and seamlessly integrate AI-driven processes into familiar user interactions represents a significant advancement in the field of computer-assisted document editing.

Embodiments of the generative merge feature provide specific technical improvements to computer-based mail merge systems. For example, embodiments of the generative merge feature may implement a novel technical architecture that enables sophisticated content generation during the merge process itself, rather than simply inserting static data into predefined fields. This may be achieved through action definitions embedded within merge templates that can trigger complex language model processing at precisely defined points during document generation.

The technical implementation of embodiments of the generative merge feature support distributed processing, in which merge template execution can occur across multiple computers—with template parsing and basic field substitution potentially occurring on a local machine while computationally intensive language model operations are performed on dedicated processing servers. This architecture enables efficient handling of complex merge operations across large document sets.

The system may improve traditional merge field substitution through, for example, one or more of the following technical mechanisms:
[symbol] Converting static merge field data into dynamically generated content through AI processing
[symbol] Enabling context-aware content generation based on multiple merge field values
[symbol] Supporting compound transformations through multiple action definitions within a single template
[symbol] Facilitating sophisticated template-driven content generation while maintaining precise structural control

These capabilities extend far beyond conventional mail merge systems by enabling dynamic content generation at arbitrary points within merge templates while preserving the efficiency and automation benefits of traditional merge processing. The result is a technically sophisticated system that maintains precise control over document structure while enabling powerful generative capabilities during the merge process itself.

Embodiments of the generative merge feature are fundamentally tied to and necessarily rooted in computer technology through their core technical architecture and processing capabilities. The system's ability to dynamically generate content during merge operations may use sophisticated computational resources and processing capabilities that can only be implemented through computer systems.

For example, the technical implementation of embodiments of the generative merge feature may use distributed computer processing architectures, in which merge template execution occurs across multiple computing devices. For example, while template parsing may occur on local machines, the system's language model operations may use dedicated processing servers with significant computational capacity. This distributed architecture may be valuable for handling the complex processing demands of generating dynamic content during merge operations.

Embodiments of the merge template processing system may implement technical mechanisms that can only exist in computer environments, such as any one or more of the following:
Template-driven execution of language model operations
Real-time content generation based on merge field data
Context-aware processing across multiple document instances
Coordinated processing across distributed computing resources

These capabilities extend far beyond manual document creation or traditional mail merge operations, involving sophisticated computational resources to execute complex language model operations while maintaining document structure and formatting. The system's ability to generate contextually appropriate content during the merge process itself is fundamentally dependent on computer implementation and processing capabilities.1

Furthermore, embodiments of the generative merge feature transform subject matter into different states through any of a variety of technical mechanisms during the merge process. The system transforms basic merge field data into generated content through a process that alters both the form and substance of the input data.

For example, at a first transformation stage, the system may convert static merge field values into dynamic inputs for content generation. These inputs may be processed using action definitions embedded in merge templates, transforming simple data points into contextual parameters that guide content generation. For example, customer demographic data might be transformed into tailored messaging parameters.

The second transformation may occur through language model processing, where these contextual parameters are transformed into newly generated content. This process converts abstract parameters into concrete text that is contextually appropriate for the specific document instance. The system may generate entirely new content that goes beyond the original merge field data, while maintaining document structure and coherence.

A third transformation may take place when multiple action definitions interact within a single template, enabling compound transformations where generated content from one section influences content generation in subsequent sections. This may create sophisticated content relationships that transform simple input data into complex, interconnected document elements.

Through these transformation stages, the system may convert basic merge data into dynamically generated content that is fundamentally different in both form and substance from the input data. The resulting document instances contain newly generated content that could not have been derived through simple field substitution, representing a true transformation of the source material into a different state.

Furthermore, embodiments of the generative merge feature solve specific technical problems in computer-based mail merge systems through concrete technical solutions. Traditional mail merge systems face significant technical limitations in their ability to generate dynamic, contextually appropriate content during the merge process, being restricted to simple field substitution that cannot adapt to different document contexts.

In contrast, embodiments of the generative merge feature solve this technical problem using a processing architecture that enables dynamic content generation during merge operations. By implementing action definitions within merge templates, the system can trigger language model processing at precisely defined points to generate contextually appropriate content based on merge field data. This technical solution enables the generation of sophisticated content while maintaining document structure and automation benefits.

The system may address scalability challenges through distributed processing capabilities where computationally intensive operations can be performed on dedicated servers while template parsing occurs locally. This architectural solution enables efficient processing of complex merge operations across large document sets while maintaining system performance.

The technical implementation solves coherence problems in generated content through multi-stage processing that enables any one or more of the following:
[symbol] Dynamic content adaptation based on multiple merge field values
[symbol] Context-aware generation that maintains document consistency
[symbol] Compound transformations through multiple coordinated action definitions
[symbol] Precise control over document structure during content generation

These solutions represent concrete technical improvements that transform the capabilities of computer-based merge systems. By enabling sophisticated content generation during the merge process itself, the system solves fundamental technical limitations of traditional merge operations while maintaining processing efficiency and document control.

The ability of embodiments of the present invention to automatically generate text and automatically revise documents represents a technological advancement that is necessarily rooted in computer technology and provides specific improvements to computer-based document editing systems. The system's ability to automatically generate text using large language models, present that text for user review, and implement approved revisions through a graphical user interface requires significant computational resources and processing capabilities that can only be implemented through computer systems.

The implementation provides concrete technical improvements through its processing architecture that enables dynamic content generation during document operations. By implementing action definitions that trigger language model processing at precisely defined points, the system can generate contextually appropriate content while maintaining document structure and automation benefits. This technical solution enables the generation of sophisticated content while preserving document organization and formatting.

Embodiments of the system address technical challenges through distributed processing capabilities where computationally intensive operations can be performed on dedicated servers while template parsing occurs locally. This architectural approach enables efficient processing of complex operations across large document sets while maintaining system performance. The technical implementation solves coherence problems in generated content through multi-stage processing that enables dynamic content adaptation, context-aware generation that maintains document consistency, and precise control over document structure during content generation.

Furthermore, embodiments of the invention transform subject matter into different states through technical mechanisms during processing. For example, such embodiments may transform basic input data into generated content through multiple transformation stages—converting static content into dynamic inputs for content generation, processing these inputs through language models to generate new content, and enabling compound transformations where generated content influences subsequent generation steps. Through these transformation stages, the system converts basic input data into dynamically generated content that is fundamentally different in both form and substance.

The user of graphical user interface implementations for reviewing and approving transformations represent concrete technical improvements that go beyond merely implementing abstract ideas on generic computer components. For example, embodiments of the present invention may provide real-time preview capabilities, enable comparison of multiple potential transformations, and maintain precise control over document updates through sophisticated user interaction mechanisms. This integration of AI capabilities into existing document editing workflows represents a significant technological advancement in computer-based content generation and revision.

These solutions represent concrete technical improvements that transform the capabilities of computer-based document systems. By enabling sophisticated content generation and revision through an automated yet user-controlled process, the system solves fundamental technical limitations of traditional document editing operations while maintaining processing efficiency and document control.

Branching features of embodiments of the present invention represent technological advancements that are necessarily rooted in computer technology and provide specific improvements to computer-based document editing systems. For example, the system's ability to generate and maintain complex multi-layer branches and trees of generated text, while enabling interactive navigation and selection of nodes, requires sophisticated computational resources and processing capabilities that can only be implemented through computer systems.

The implementation provides concrete technical improvements through its ability to process and maintain complex hierarchical relationships between generated outputs. The system can generate entire trees of content through successive transformations, with each node potentially building upon and refining content from previous nodes. This enables compound transformations where the context and content from earlier generations inform and enhance later content generation steps, requiring sophisticated computational processing to maintain these relationships and dependencies.

The system's technical architecture supports both explicit and implicit references between nodes in sequential transformations. Explicit references may include direct references to specific prior outputs, while implicit references encompass broader contextual references. This capability enables sophisticated multi-stage content generation where each stage can build upon and refine content created in earlier stages, representing a significant advancement in computer-based content generation.

The invention transforms information through multiple technical stages during branch processing. When applying an accepted node that exists multiple layers deep within a branch, the system processes the chain of transformations sequentially, with each node building upon previous transformations. This sequential processing enables compound transformations that would be impossible to implement manually, demonstrating the invention's fundamental reliance on computer technology.

The system's graphical user interface implementations for navigating and selecting nodes from complex output trees represent concrete technical improvements. These interfaces enable users to traverse complex branch structures, preview potential revisions, and select nodes at any depth while maintaining document coherence. The implementation supports both automated and interactive workflows through context-aware preview generation, real-time content manifestation, and flexible node selection mechanisms.

The branching features provide specific technical benefits through state-based revision management, where the system maintains both original and modified content while providing clear representation of current document state through selective rendering. This enables efficient tracking and management of multiple potential revisions without requiring direct modification of original content, representing a significant improvement in how computer systems handle document revisions.

These solutions represent concrete technical improvements that transform the capabilities of computer-based document systems. By enabling sophisticated branch generation, navigation, and selection while maintaining precise control over document structure and content relationships, the system solves fundamental technical limitations of traditional document editing operations while maintaining processing efficiency and document coherence.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A computer-implemented method comprising:
(A) receiving user input specifying an action definition;
(B) for each element in a document:
(B)(1) identifying the action definition;
(B)(2) applying the identified action definition to the element using a language model to generate output corresponding to the element;
(B)(3) manifesting the output corresponding to the element;
(C) receiving user input approving of an output corresponding to a particular one of the elements in the document; and
(D) in response to the user input, revising the particular one of the elements in the document based on the output corresponding to the particular one of the elements in the document.

2. The method of claim 1, wherein the language model comprises a large language model.

3. The method of claim 1, wherein applying the identified action definition comprises:
identifying a prompt specified by the action definition;
generating a processed prompt based on the prompt specified by the action definition and the element; and
providing the processed prompt to the language model to generate language model output.

4. The method of claim 2, wherein the language model comprises a large language model.

5. The method of claim 1, wherein receiving user input specifying an action definition comprises receiving user input specifying a tokenized prompt including at least one token that is replaced with content from the element during application of the action definition.

6. The method of claim 1, wherein receiving user input specifying an action definition comprises receiving user input selecting the action definition from an action definition library containing a plurality of action definitions.

7. The method of claim 6, wherein the action definition library stores a short name corresponding to the action definition, and wherein receiving user input selecting the action definition comprises receiving user selection of the short name.

8. The method of claim 1, wherein receiving user input specifying an action definition comprises receiving user input creating the action definition through a user interface.

9. The method of claim 1, wherein applying the identified action definition comprises applying a plurality of action definitions to the element to generate a plurality of outputs corresponding to the element.

10. The method of claim 1, wherein applying the identified action definition comprises multi-stage processing including applying a first action definition to generate intermediate output and applying a second action definition to the intermediate output to generate the output corresponding to the element.

11. The method of claim 1, wherein processing each element in the document comprises processing only elements that meet predetermined selection criteria.

12. The method of claim 1, wherein (B)(1), (B)(2), and (B)(3) are performed automatically in background processing without user intervention.

13. A system comprising at least one non-transitory computer-readable medium having computer program instructions stored thereon, the computer program instructions being executable to perform a method, the method comprising:
(A) receiving user input specifying an action definition;
(B) for each element in a document:
(B)(1) identifying the action definition;
(B)(2) applying the identified action definition to the element using a language model to generate output corresponding to the element;
(B)(3) manifesting the output corresponding to the element;
(C) receiving user input approving of an output corresponding to a particular one of the elements in the document; and
(D) in response to the user input, revising the particular one of the elements in the document based on the output corresponding to the particular one of the elements in the document.

14. The system of claim 13, wherein the computer program instructions being executable to perform applying the identified action definition comprises computer program instructions being executable to perform:
identifying a prompt specified by the action definition,
generating a processed prompt based on the prompt specified by the action definition and the element, and
providing the processed prompt to the language model to generate language model output.

15. The system of claim 13, wherein the computer program instructions being executable to perform receiving user input specifying an action definition comprises computer program instructions being executable to perform receiving user input specifying a tokenized prompt including at least one token that is replaced with content from the element during application of the action definition.

16. The system of claim 13, wherein the computer program instructions being executable to perform receiving user input specifying an action definition comprises computer program instructions being executable to perform receiving user input selecting the action definition from an action definition library containing a plurality of action definitions.

17. The system of claim 16, wherein the action definition library stores a short name corresponding to the action definition, and wherein the computer program instructions being executable to perform receiving user input selecting the action definition comprises computer program instructions being executable to perform receiving user selection of the short name.

18. The system of claim 13, wherein the computer program instructions being executable to perform applying the identified action definition comprises computer program instructions being executable to perform applying a plurality of action definitions to the element to generate a plurality of outputs corresponding to the element.

19. The system of claim 13, wherein the computer program instructions being executable to perform applying the identified action definition comprises computer program instructions being executable to perform multi-stage processing including applying a first action definition to generate intermediate output and applying a second action definition to the intermediate output to generate the output corresponding to the element.

20. The system of claim 13, wherein the computer program instructions being executable to perform (B)(1), (B)(2), and (B)(3) comprises computer program instructions being executable to perform (B)(1), (B)(2), and (B)(3) automatically in background processing without user intervention.
